(19) United States
(12) Patent Application Publication
(10) Pub. No.: US 2023/0180148 A1
(43) Pub. Date: Jun. 8, 2023

(54) METHOD AND APPARATUS FOR POWER HEADROOM REPORTING FOR MULTI-SUBSCRIBER IDENTITY MODULE (SIM) IN A WIRELESS COMMUNICATION SYSTEM

(71) Applicant: ASUSTek Computer Inc., Taipei City (TW)

(72) Inventors: Yi-Hsuan Kung, Taipei City (TW); Yu-Hsuan Guo, Taipei City (TW)

(21) Appl. No.: 17/994,441

(22) Filed: Nov. 28, 2022

Related U.S. Application Data
(60) Provisional application No. 63/285,553, filed on Dec. 3, 2021.
(60) Provisional application No. 63/285,557, filed on Dec. 3, 2021.

(51) Int. Cl. H04W 52/36; H04W 76/20

(52) U.S. Cl. CPC H04W 52/365; H04W 76/20

(57) ABSTRACT

In an example, a User Equipment (UE), with a first Universal Subscriber Identity Module (USIM) and a second USIM, enters Radio Resource Control (RRC) connected state in a first network associated with the first USIM. The UE triggers a Power Headroom Reporting (PHR) to the first network in response to (i) a RRC connection establishment procedure with a second network, (ii) a RRC connection resume procedure with the second network, (iii) a RRC connection release procedure with the second network, (iv) deactivation and/or release of a SCell and/or a SCG, (v) a pathloss, associated with a Serving Cell of the second network, changing by over a first threshold since a previous PHR transmission, (vi) activation of a first SCell of the second network and/or a SCG of the second network, (vii) a power backoff, associated with a Serving Cell of the second network, changing by over a second threshold since the previous PHR transmission, and/or (viii) switching of an activated BWP from a dormant BWP to a non-dormant DL BWP of a second SCell of the second network. The second network is associated with the second USIM.

### CROSS-REFERENCE TO RELATED APPLICATIONS

The present Application claims the benefit of U.S. Provisional Patent Application Ser. No. 63/285,553 filed on Dec. 3, 2021, the entire disclosure of which is incorporated herein in its entirety by reference. The present Application also claims the benefit of U.S. Provisional Patent Application Ser. No. 63/285,557 filed on Dec. 3, 2021, the entire disclosure of which is incorporated herein in its entirety by reference.

### FIELD

This disclosure generally relates to wireless communication networks, and more particularly, to a method and apparatus for power headroom reporting for multi-Subscriber Identity Module (SIM) in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

In accordance with the present disclosure, one or more devices and/or methods are provided. In an example from the perspective of a User Equipment (UE) with a first Universal Subscriber Identity Module (USIM) and a second USIM, the UE enters Radio Resource Control (RRC) connected state in a first network associated with the first USIM. The UE triggers a Power Headroom Reporting (PHR) to the first network in response to (i) a RRC connection establishment procedure with a second network, (ii) a RRC connection resume procedure with the second network, (iii) a RRC connection release procedure with the second network, (iv) deactivation and/or release of a SCell of the first network and/or a SCG of the first network, (v) a pathloss, associated with a first activated Serving Cell of the second network, changing by over a first threshold since a previous PHR transmission, (vi) activation of a first SCell of the second network and/or a SCG of the second network, (vii) a power backoff, associated with a second activated Serving Cell of the second network, changing by over a second threshold since the previous PHR transmission, and/or (viii) switching of an activated BWP from a dormant BWP to a non-dormant DL BWP of a second SCell of the second network. The second network is associated with the second USIM.

In accordance with the present disclosure, one or more devices and/or methods are provided. In an example from the perspective of a UE with a first USIM and a second USIM, the UE enters RRC connected state in a first network associated with the first USIM. The UE identifies one or more events comprising (i) performance of a RRC connection establishment procedure with a second network, (ii) performance of a RRC connection resume procedure with the second network, (iii) performance of a RRC connection release procedure with the second network, (iv) deactivation and/or release of a SCell of the first network and/or a SCG of the first network, (v) a pathloss, associated with a first activated Serving Cell of the second network, changing by over a first threshold since a previous PHR transmission, (vi) activation of a first SCell of the second network and/or a SCG of the second network, (vii) a power backoff, associated with a second activated Serving Cell of the second network, changing by over a second threshold since the previous PHR transmission, and/or (viii) switching of an activated BWP from a dormant BWP to a non-dormant DL BWP of a second SCell of the second network. The second network is associated with the second USIM. In response to the one or more events, the UE one of (i) triggers a PHR to the first network based on the deactivation and/or the release (of the SCell of the first network and/or the SCG of the first network) being associated with the UE entering the RRC connected state in the second network, or (ii) does not trigger the PHR to the first network based on the deactivation and/or the release (of the SCell of the first network and/or the SCG of the first network) not being associated with the UE entering the RRC connected state in the second network.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram illustrating an exemplary scenario associated with successful Radio Resource Control (RRC) connection establishment according to one exemplary embodiment.

FIG. 6 is a diagram illustrating an exemplary scenario associated with successful RRC connection release according to one exemplary embodiment.

FIG. 7 is a diagram illustrating an exemplary scenario associated with successful RRC connection resume according to one exemplary embodiment.

FIG. 8 is a diagram illustrating an exemplary scenario associated with successful RRC connection resume fallback to RRC connection establishment according to one exemplary embodiment.

FIG. 9 illustrates a multiple entry Power Headroom Reporting (PHR) Medium Access Control (MAC) Control Element (CE) according to one exemplary embodiment.

FIG. 10 illustrates a multiple entry PHR MAC CE according to one exemplary embodiment.

FIG. 11 is a diagram illustrating an exemplary scenario associated with a UE and a first network according to one exemplary embodiment.

FIG. 12 is a diagram illustrating an exemplary scenario associated with a UE and a second network according to one exemplary embodiment.

FIG. 13 is a diagram illustrating an exemplary scenario associated with a UE, a first network and a second network according to one exemplary embodiment.

FIG. 14 is a diagram illustrating an exemplary scenario associated with a UE, a first network and a second network according to one exemplary embodiment.

FIG. 15 is a diagram illustrating an exemplary scenario associated with a UE, a first network and a second network according to one exemplary embodiment.

FIG. 16 is a diagram illustrating an exemplary scenario associated with a UE, a first network and a second network according to one exemplary embodiment.

FIG. 17 is a diagram illustrating a MAC CE for reporting power information according to one exemplary embodiment.

FIG. 18 is a diagram illustrating a MAC CE for reporting power information according to one exemplary embodiment.

FIG. 19 is a diagram illustrating a MAC CE for reporting power information according to one exemplary embodiment.

FIG. 20 is a flow chart according to one exemplary embodiment.

FIG. 21 is a flow chart according to one exemplary embodiment.

FIG. 22 is a flow chart according to one exemplary embodiment.

FIG. 23 is a flow chart according to one exemplary embodiment.

FIG. 24 is a flow chart according to one exemplary embodiment.

FIG. 25 is a flow chart according to one exemplary embodiment.

FIG. 26 is a flow chart according to one exemplary embodiment.

FIG. 27 is a flow chart according to one exemplary embodiment.

FIG. 28 is a flow chart according to one exemplary embodiment.

FIG. 29 is a flow chart according to one exemplary embodiment.

FIG. 30 is a flow chart according to one exemplary embodiment.

FIG. 31 is a flow chart according to one exemplary embodiment.

FIG. 32 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3^{rd} Generation Partnership Project (3GPP) LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio) wireless access for 5G, or some other modulation techniques.

In particular, the exemplary wireless communication systems devices described below may be designed to support one or more standards such as the standard offered by a consortium named “3rd Generation Partnership Project” referred to herein as 3GPP, including: RP-212716 New WID on Dual Tx/Rx MUSIM; 3GPP 38.300 v16.7.0; 3GPP 38.331 v16.6.0; Views on Rel-18 proposals on MUSIM, RP-212288, Huawei, HiSilicon; 3GPP 38.321 v16.6.0. The standards and documents listed above are hereby expressly incorporated by reference in their entirety.

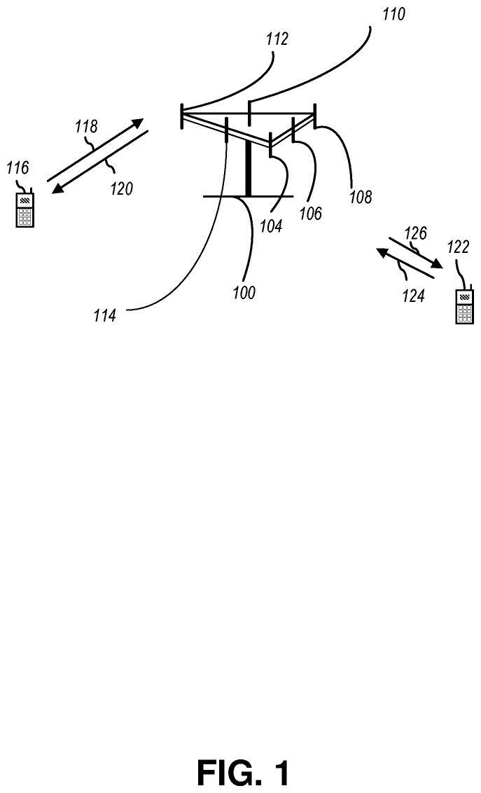

FIG. 1 presents a multiple access wireless communication system in accordance with one or more embodiments of the disclosure. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to AT 122 over forward link 126 and receive information from AT 122 over reverse link 124. In a frequency-division duplexing (FDD) system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access network. In the embodiment, antenna groups each may be designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage may normally cause less interference to access terminals in neighboring cells than an access network transmitting through a single antenna to its access terminals.

An access network (AN) may be a fixed station or base station used for communicating with the terminals and may also be referred to as an access point, a Node B, a base station, an enhanced base station, an eNodeB (eNB), a Next Generation NodeB (gNB), or some other terminology. An access terminal (AT) may also be called user equipment (UE), a wireless communication device, terminal, access terminal or some other terminology.

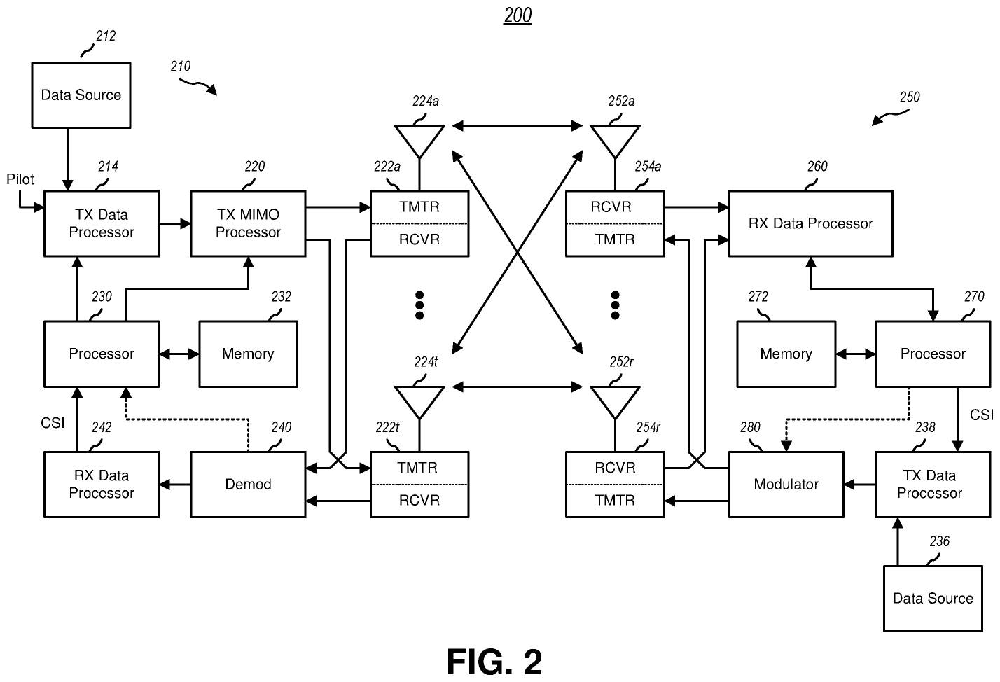

FIG. 2 presents an embodiment of a transmitter system 210 (also known as the access network) and a receiver system 250 (also known as access terminal (AT) or user equipment (UE)) in a multiple-input and multiple-output (MIMO) system 200. At the transmitter system 210, traffic data for a number of data streams may be provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency-division multiplexing (OFDM) techniques. The pilot data may typically be a known data pattern that is processed in a known manner and may be used at the receiver system to estimate the channel response. The multiplexed pilot and coded data for each data stream may then be modulated (i.e., symbol mapped) based on a particular modulation scheme (e.g., binary phase shift keying (BPSK), quadrature phase shift keying (QPSK), M-ary phase shift keying (M-PSK), or M-ary quadrature amplitude modulation (M-QAM)) selected for that data stream to provide modulation symbols. The data rate, coding, and/or modulation for each data stream may be determined by instructions performed by processor 230.

The modulation symbols for data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 may apply beamforming weights to the symbols of the data streams and to the antenna from which the symbol is being transmitted.

Each transmitter 222 receives and processes a respective symbol stream to provide one or more analog signals, and further conditions (e.g., amplifies, filters, and/or upconverts) the analog signals to provide a modulated signal suitable for transmission over the MIMO channel. N_{T} modulated signals from transmitters 222a through 222t may then be transmitted from N_{T} antennas 224a through 224t, respectively.

At receiver system 250, the transmitted modulated signals are received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and/or further process the samples to provide a corresponding “received” symbol stream.

An RX data processor 260 then receives and/or processes the N_{R} received symbol streams from N_{R} receivers 254 based on a particular receiver processing technique to provide N_{T} “detected” symbol streams. The RX data processor 260 may then demodulate, deinterleave, and/or decode each detected symbol stream to recover the traffic data for the data stream. The processing by RX data processor 260 may be complementary to that performed by TX MIMO processor 220 and TX data processor 214 at transmitter system 210.

A processor 270 may periodically determine which pre-coding matrix to use (discussed below). Processor 270 formulates a reverse link message comprising a matrix index portion and a rank value portion.

The reverse link message may comprise various types of information regarding the communication link and/or the received data stream. The reverse link message may then be processed by a TX data processor 238, which may also receive traffic data for a number of data streams from a data source 236, modulated by a modulator 280, conditioned by transmitters 254a through 254r, and/or transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 may then determine which pre-coding matrix to use for determining the beamforming weights and may then process the extracted message.

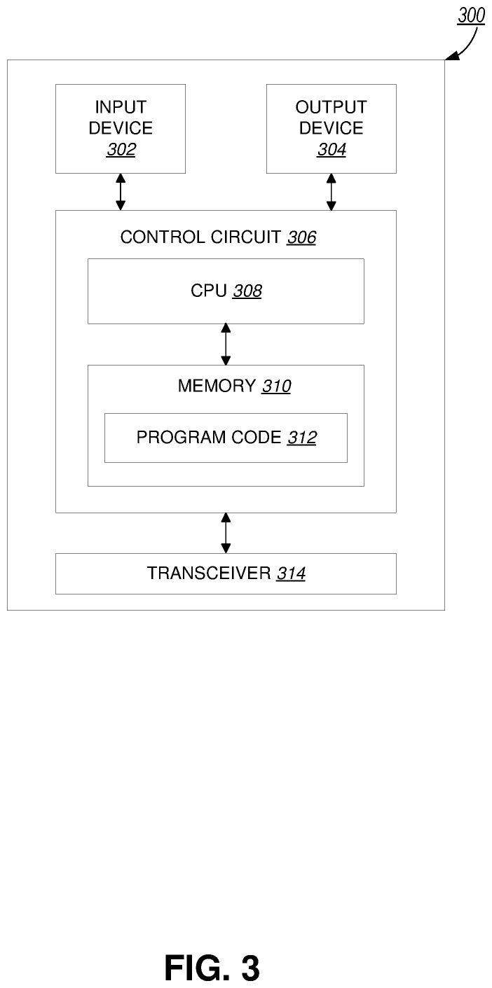

FIG. 3 presents an alternative simplified functional block diagram of a communication device according to one embodiment of the disclosed subject matter. As shown in FIG. 3, the communication device 300 in a wireless communication system can be utilized for realizing the UEs (or ATs) 116 and 122 in FIG. 1 or the base station (or AN) 100 in FIG. 1, and the wireless communications system may be the LTE system or the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

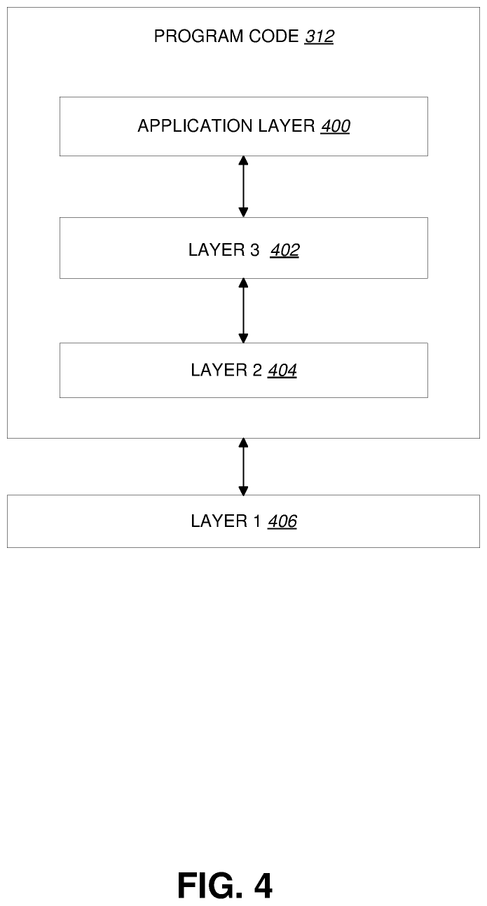

FIG. 4 is a simplified block diagram of the program code 312 shown in FIG. 3 in accordance with one embodiment of the disclosed subject matter. In this embodiment, the program code 312 includes an application layer 400, a Layer 3 portion 402, and a Layer 2 portion 404, and is coupled to a Layer 1 portion 406. The Layer 3 portion 402 may perform radio resource control. The Layer 2 portion 404 may perform link control. The Layer 1 portion 406 may perform and/or implement physical connections.

In RP-212716, New Work Item Description (WID) on Dual Transmitter/Receiver (Tx/Rx) Multiple Subscriber Identity Module (SIM) (MUSIM), one or more MUSIM enhancements are discussed. One or more parts of RP-212716 are quoted below:

### 3 Justification

MUSIM UE's hardware capabilities are shared by the SIMs, and to use the hardware efficiently and economically, the related capabilities need to be dynamically split between the two SIMs. This can lead to a temporary hardware conflict for the UE, which may require UE to release some resources (e.g. SCell/SCG) from one SIM. For example, when the UE's SIM A is in RRC connected state in NW A while the UE's SIM B is in RRC Idle or RRC Inactive in NW B, the two TX chains will be occupied by the SIM A for the communication in NW A. Once the UE's SIM B enters into RRC connected state, one of the TX chain needs to be switched to SIM B. In this case, if the NW A is not aware of the reduced UE's capability change in TX chain, there may be data loss due to demodulation failure and wasting radio resources in NW A. To avoid this, assistance from UE to network A on these temporary UE (capability) restrictions can be beneficial.

### 4 Objective

4.1 Objective of SI or Core part WI or Testing part WI
Enhancements for MUSIM procedures to operate in RRC_CONNECTED state simultaneously in NW A and NW B. [RAN2, RAN3, RAN4].
Specify mechanism to indicate preference on temporary UE capability restriction (e.g. capability update, release of cells, (de)activation of configured resources) with NW A when UE prefers to start/stop connecting to NW B for MUSIM purpose
RAT Concurrency: Network A is NR SA (with CA) or NR DC. Network B can either be LTE or NR.
Applicable UE architecture: Dual-RX/Dual-TX UE

3GPP 38.300 v16.7.0 discusses different protocol states of a UE. One or more parts of 3GPP 38.300 v16.7.0 are quoted below:

### 7.2 Protocol States

RRC supports the following states which can be characterised as follows:
RRC_IDLE:
   PLMN selection;
   Broadcast of system information;
   Cell re-selection mobility;
   Paging for mobile terminated data is initiated by 5GC;
   DRX for CN paging configured by NAS.
RRC_INACTIVE:
   PLMN selection;
   Broadcast of system information;
   Cell re-selection mobility;
   Paging is initiated by NG-RAN (RAN paging);
   RAN-based notification area (RNA) is managed by NG-RAN;
   DRX for RAN paging configured by NG-RAN;
   5GC—NG-RAN connection (both C/U-planes) is established for UE;
   The UE Inactive AS context is stored in NG-RAN and the UE;
   NG-RAN knows the RNA which the UE belongs to.
RRC_CONNECTED:
   5GC—NG-RAN connection (both C/U-planes) is established for UE;
   The UE AS context is stored in NG-RAN and the UE;
   NG-RAN knows the cell which the UE belongs to;
   Transfer of unicast data to/from the UE;
   Network controlled mobility including measurements.

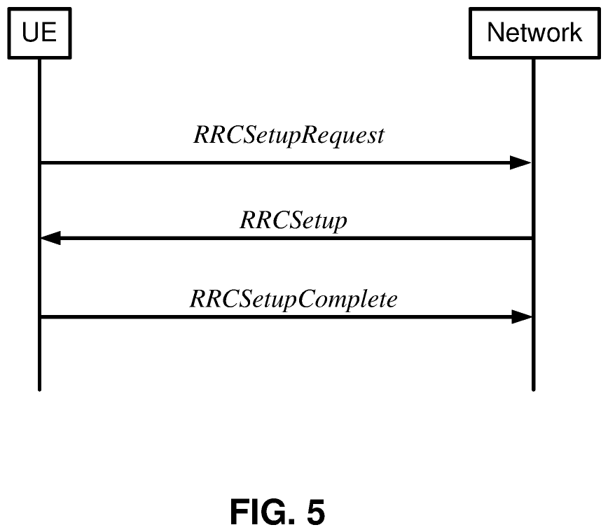

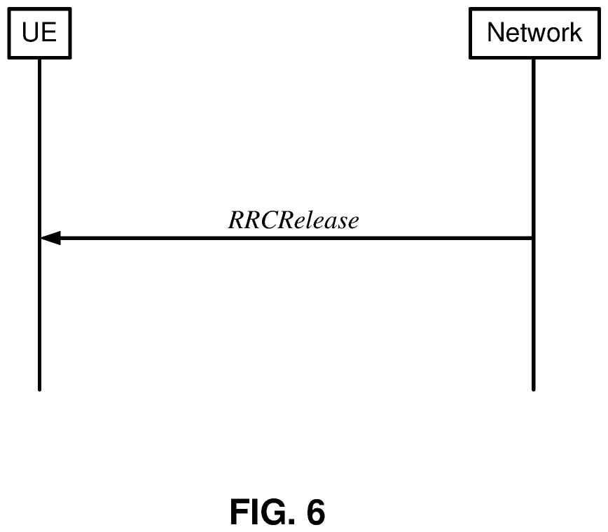

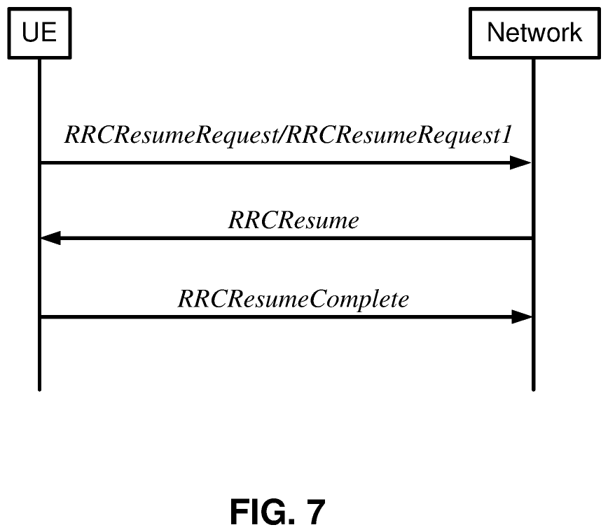

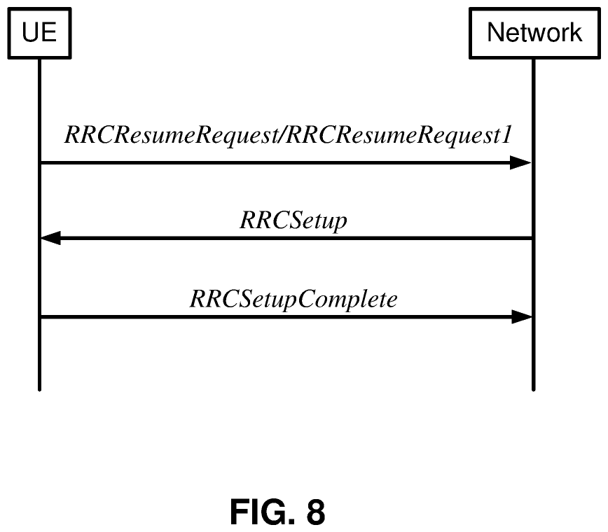

3GPP 38.331 v16.6.0 discusses RRC connection establishment and RRC connection resume. Notably, FIG. 5.3.3.1-1 of Section 5.3.3.1 of 3GPP 38.331 v16.6.0, entitled “RRC connection establishment, successful”, is reproduced herein as FIG. 5. FIG. 5.3.8.1-1 of Section 5.3.8.1 of 3GPP 38.331 v16.6.0, entitled “RRC connection release, successful”, is reproduced herein as FIG. 6. FIG. 5.3.13.1-1 of Section 5.3.13.1 of 3GPP 38.331 v16.6.0, entitled “RRC connection resume, successful”, is reproduced herein as FIG. 7. FIG. 5.3.13.1-2 of Section 5.3.13.1 of 3GPP 38.331 v16.6.0, entitled “RRC connection resume fallback to RRC connection establishment, successful”, is reproduced herein as FIG. 8. One or more parts of 3GPP 38.331 v16.6.0 are quoted below:

5.3.3 RRC connection establishment

### 5.3.3.1 General

### FIG. 5.3.3.1-1: RRC Connection Establishment, Successful

The purpose of this procedure is to establish an RRC connection. RRC connection establishment involves SRB1 establishment. The procedure is also used to transfer the initial NAS dedicated information/message from the UE to the network.
The network applies the procedure e.g. as follows:
When establishing an RRC connection;
When UE is resuming or re-establishing an RRC connection, and the network is not able to retrieve or verify the UE context. In this case, UE receives RRCSetup and responds with RRCSetupComplete.

[ . . . ]

### 5.3.3.2 Initiation

The UE initiates the procedure when upper layers request establishment of an RRC connection while the UE is in RRC_IDLE and it has acquired essential system information, or for sidelink communication as specified in sub-clause 5.3.3.1a.
The UE shall ensure having valid and up to date essential system information as specified in clause 5.2.2.2 before initiating this procedure.
Upon initiation of the procedure, the UE shall:
1> if the upper layers provide an Access Category and one or more Access Identities upon requesting establishment of an RRC connection:
   2> perform the unified access control procedure as specified in 5.3.14 using the Access Category and Access Identities provided by upper layers;
      3> if the access attempt is barred, the procedure ends;
1> apply the default L1 parameter values as specified in corresponding physical layer specifications except for the parameters for which values are provided in SIB1;
1> apply the default MAC Cell Group configuration as specified in 9.2.2;
1> apply the CCCH configuration as specified in 9.1.1.2;
1> apply the timeAlignmentTimerCommon included in SIB1;
1> start timer T300;
1> initiate transmission of the RRCSetupRequest message in accordance with 5.3.3.3;

### 5.3.3.3 Actions Related to Transmission of RRCSetupRequest Message

The UE shall set the contents of RRCSetupRequest message as follows:
1> set the ue-Identity as follows:
   2> if upper layers provide a 5G-S-TMSI:
      3> set the ue-Identity to ng-5G-S-TMSI-Part1;
   2> else:
      3> draw a 39-bit random value in the range 0..2³⁹-1 and set the ue-Identity to this value;
NOTE 1: Upper layers provide the 5G-S-TMSI if the UE is registered in the TA of the current cell.
1> if the establishment of the RRC connection is the result of release with redirect with mpsPrioritylndication (either in NR or E-UTRAN):
   2> set the establishmentCause to mps-PriorityAccess;
1> else:
   2> set the establishmentCause in accordance with the information received from upper layers;
      The UE shall submit the RRCSetupRequest message to lower layers for transmission.
      The UE shall continue cell re-selection related measurements as well as cell re-selection evaluation. If the conditions for cell re-selection are fulfilled, the UE shall perform cell re-selection as specified in 5.3.3.6.

### 5.3.3.4 Reception of the RRCSetup by the UE

The UE shall perform the following actions upon reception of the RRCSetup:
1> if the RRCSetup is received in response to an RRCReestablishmentRequest; or
1> if the RRCSetup is received in response to an RRCResumeRequest or RRCResumeRequest1:
   2> discard any stored UE Inactive AS context and suspendConfig;
   2> discard any current AS security context including the K_{RRCenc} key, the K_{RRCint} key, the K_{UPint} key and the K_{UPenc} key;
   2> release radio resources for all established RBs except SRB0, including release of the RLC entities, of the associated PDCP entities and of SDAP;
   2> release the RRC configuration except for the default L1 parameter values, default MAC Cell Group configuration and CCCH configuration;
   2> indicate to upper layers fallback of the RRC connection;
   2> stop timer T380, if running;
1> perform the cell group configuration procedure in accordance with the received masterCellGroup and as specified in 5.3.5.5;
1> perform the radio bearer configuration procedure in accordance with the received radioBearerConfig and as specified in 5.3.5.6;
1> if stored, discard the cell reselection priority information provided by the cellReselectionPriorities or inherited from another RAT;
1> stop timer T300, T301 or T319 if running;
1> if T390 is running
   2> stop timer T390 for all access categories;
   2> perform the actions as specified in 5.3.14.4;
1> if T302 is running
   2> stop timer T302;
   2> perform the actions as specified in 5.3.14.4;
1> stop timer T320, if running;
1> if the RRCSetup is received in response to an RRCResumeRequest, RRCResumeRequest1 or RRCSetupRequest:
   2> if T331 is running
      3> stop timer T331;
      3> perform the actions as specified in 5.7.8.3;
   2> enter RRC_CONNECTED;
   2> stop the cell re-selection procedure;
1> consider the current cell to be the PCell;
[ . . . ]
1> set the content of RRCSetupComplete message as follows:
   2> if upper layers provide a 5G-S-TMSI:
      3> if the RRCSetup is received in response to an RRCSetupRequest:
         4> set the ng-5G-S-TMSI-Value to ng-5G-S-TMSI-Part2;
      3> else:
         4> set the ng-5G-S-TMSI-Value to ng-5G-S-TMSI;
   2> if upper layers selected an SNPN or a PLMN and in case of PLMN UE is either allowed or instructed to access the PLMN via a cell for which at least one CAG ID is broadcast:
      3> set the selectedPLMN-Identity from the npn-IdentityInfoList;
   2> else:
      3> set the selectedPLMN-Identity to the PLMN selected by upper layers from the plmn-IdentityInfoList;
   2> if upper layers provide the ‘Registered AMF’:
      3> include and set the registeredAMF as follows:
         4> if the PLMN identity of the ‘Registered AMF’ is different from the PLMN selected by the upper layers:
         5> include the plmnIdentity in the registeredAMF and set it to the value of the PLMN identity in the ‘Registered AMF’ received from upper layers;
         4> set the amf-Identifier to the value received from upper layers;
      3> include and set the guami-Type to the value provided by the upper layers;
   2> if upper layers provide one or more S-NSSAI (see TS 23.003 [21]):
      3> include the s-NSSAI-List and set the content to the values provided by the upper layers;
   2> set the dedicatedNAS-Message to include the information received from upper layers;
   [ . . . ]
1> submit the RRCSetupComplete message to lower layers for transmission, upon which the procedure ends.
   5.3.8 RRC connection release

### 5.3.8.1 General

### FIG. 5.3.8.1-1: RRC Connection Release, Successful

The purpose of this procedure is:
to release the RRC connection, which includes the release of the established radio bearers, BH RLC channels as well as all radio resources; or
to suspend the RRC connection only if SRB2 and at least one DRB or, for IAB, SRB2, are setup, which includes the suspension of the established radio bearers.

### 5.3.8.2 Initiation

The network initiates the RRC connection release procedure to transit a UE in RRC_CONNECTED to RRC_IDLE; or to transit a UE in RRC_CONNECTED to RRC_INACTIVE only if SRB2 and at least one DRB or, for IAB, SRB2, is setup in RRC_CONNECTED; or to transit a UE in RRC_INACTIVE back to RRC_INACTIVE when the UE tries to resume; or to transit a UE in RRC_INACTIVE to RRC_IDLE when the UE tries to resume. The procedure can also be used to release and redirect a UE to another frequency.

### 5.3.8.3 Reception of the RRCRelease by the UE

The UE shall:
1> delay the following actions defined in this sub-clause 60 ms from the moment the RRCRelease message was received or optionally when lower layers indicate that the receipt of the RRCRelease message has been successfully acknowledged, whichever is earlier;
1> stop timer T380, if running;
1> stop timer T320, if running;
1> if timer T316 is running;
   2> stop timer T316;
   2> clear the information included in VarRLF-Report, if any;
1> stop timer T350, if running;
1> if the AS security is not activated:
   2> ignore any field included in RRCRelease message except waitTime;
   2> perform the actions upon going to RRC_IDLE as specified in 5.3.11 with the release cause ‘other’ upon which the procedure ends;
[ . . . ]
1> if the RRCRelease includes suspendConfig:
   2> apply the received suspendConfig;
   2> remove all the entries within VarConditionalReconfig, if any;
   2> for each measId, if the associated reportConfig has a reportType set to condTriggerConfig:
      3> for the associated reportConfigId:
         4> remove the entry with the matching reportConfigId from the reportConfigList within the VarMeasConfig;
      3> if the associated measObjectId is only associated to a reportConfig with reportType set to condTriggerConfig:
         4> remove the entry with the matching measObjectId from the measObjectList within the VarMeasConfig;
      3> remove the entry with the matching measId from the measIdList within the VarMeasConfig;
   2> reset MAC and release the default MAC Cell Group configuration, if any;
   2> re-establish RLC entities for SRB1;
   2> if the RRCRelease message with suspendConfig was received in response to an RRCResumeRequest or an RRCResumeRequest1:
      3> stop the timer T319 if running;
      3> in the stored UE Inactive AS context:
         4> replace the K_{gNB} and K_{RRCint} keys with the current K_{gNB} and K_{RRCint} keys;
         4> replace the C-RNTI with the C-RNTI used in the cell (see TS 38.321 [3]) the UE has received the RRCRelease message;
         4> replace the cellIdentity with the cellIdentity of the cell the UE has received the RRCRelease message;
         4> replace the physical cell identity with the physical cell identity of the cell the UE has received the RRCRelease message;
   2> else:
      3> store in the UE Inactive AS Context the current K_{gNB} and K_{RRCint} keys, the ROHC state, the stored QoS flow to DRB mapping rules, the C-RNTI used in the source PCell, the cellIdentity and the physical cell identity of the source PCell, the spCellConfigCommon within ReconfigurationWithSync of the NR PSCell (if configured) and all other parameters configured except for:
         parameters within ReconfigurationWithSync of the PCell;
         parameters within ReconfigurationWithSync of the NR PSCell, if configured;
         parameters within MobilityControlInfoSCG of the E-UTRA PSCell, if configured;
         servingCellConfigCommonSIB;
NOTE 2: NR sidelink communication related configurations and logged measurement configuration are not stored as UE Inactive AS Context, when UE enters RRC_INACTIVE.
   2> suspend all SRB(s) and DRB(s), except SRB0;
   2> indicate PDCP suspend to lower layers of all DRBs;
   2> if the t380 is included:
      3> start timer T380, with the timer value set to t380;
   2> if the RRCRelease message is including the waitTime:
      3> start timer T302 with the value set to the waitTime;
      3> inform upper layers that access barring is applicable for all access categories except categories ‘0’ and ‘2’;
   2> if T390 is running
      3> stop timer T390 for all access categories;
      3> perform the actions as specified in 5.3.14.4;
   2> indicate the suspension of the RRC connection to upper layers;
   2> enter RRC_INACTIVE and perform cell selection as specified in TS 38.304 [20];
1> else
   2> perform the actions upon going to RRC_IDLE as specified in 5.3.11, with the release cause ‘other’.

### 5.3.8.5 UE Actions Upon the Expiry of DataInactivityTimer

Upon receiving the expiry of DataInactivityTimer from lower layers while in RRC_CONNECTED, the UE shall:
1> perform the actions upon going to RRC_IDLE as specified in 5.3.11, with release cause ‘RRC connection failure’.

### 5.3.13 RRC Connection Resume

### 5.3.13.1 General

### FIG. 5.3.13.1-1: RRC Connection Resume, Successful

### FIG. 5.3.13.1-2: RRC Connection Resume Fallback to RRC Connection Establishment, Successful

The purpose of this procedure is to resume a suspended RRC connection, including resuming SRB(s) and DRB(s) or perform an RNA update.

### 5.3.13.2 Initiation

The UE initiates the procedure when upper layers or AS (when responding to RAN paging, upon triggering RNA updates while the UE is in RRC_INACTIVE, or for NR sidelink communication/V2X sidelink communication as specified in sub-clause 5.3.13.1a) requests the resume of a suspended RRC connection.
The UE shall ensure having valid and up to date essential system information as specified in clause 5.2.2.2 before initiating this procedure.
Upon initiation of the procedure, the UE shall:
1> if the resumption of the RRC connection is triggered by response to NG-RAN paging:
   2> select ‘0’ as the Access Category;
   2> perform the unified access control procedure as specified in 5.3.14 using the selected Access Category and one or more Access Identities provided by upper layers;
      3> if the access attempt is barred, the procedure ends;
1> else if the resumption of the RRC connection is triggered by upper layers:
   2> if the upper layers provide an Access Category and one or more Access Identities:
      3> perform the unified access control procedure as specified in 5.3.14 using the Access Category and Access Identities provided by upper layers;
         4> if the access attempt is barred, the procedure ends;
   2> if the resumption occurs after release with redirect with mpsPrioritylndication:
      3> set the resumeCause to mps-PriorityAccess;
   2> else:
      3> set the resumeCause in accordance with the information received from upper layers;
1> else if the resumption of the RRC connection is triggered due to an RNA update as specified in 5.3.13.8:
   2> if an emergency service is ongoing:
   NOTE: How the RRC layer in the UE is aware of an ongoing emergency service is up to UE implementation.
      3> select ‘2’ as the Access Category;
      3> set the resume Cause to emergency;
   2> else:
      3> select ‘8’ as the Access Category;
   2> perform the unified access control procedure as specified in 5.3.14 using the selected Access Category and one or more Access Identities to be applied as specified in TS 24.501 [23];
      3> if the access attempt is barred:
         4> set the variable pendingRNA-Update to true;
         4> the procedure ends;
1> if the UE is in NE-DC or NR-DC:
   2> if the UE does not support maintaining SCG configuration upon connection resumption:
      3> release the MR-DC related configurations (i.e., as specified in 5.3.5.10) from the UE Inactive AS context, if stored;
1> if the UE does not support maintaining the MCG SCell configurations upon connection resumption:
   2> release the MCG SCell(s) from the UE Inactive AS context, if stored;
1> apply the default L1 parameter values as specified in corresponding physical layer specifications, except for the parameters for which values are provided in SIB1;
1> apply the default SRB1 configuration as specified in 9.2.1;
1> apply the default MAC Cell Group configuration as specified in 9.2.2;
1> release delayBudgetReportingConfig from the UE Inactive AS context, if stored;
1> stop timer T342, if running;
1> release overheatingAssistanceConfig from the UE Inactive AS context, if stored;
1> stop timer T345, if running;
1> release idc-AssistanceConfig from the UE Inactive AS context, if stored;
1> release drx-PreferenceConfig for all configured cell groups from the UE Inactive AS context, if stored;
1> stop all instances of timer T346a, if running;
1> release maxBW-PreferenceConfig for all configured cell groups from the UE Inactive AS context, if stored;
1> stop all instances of timer T346b, if running;
1> release maxCC-PreferenceConfig for all configured cell groups from the UE Inactive AS context, if stored;
1> stop all instances of timer T346c, if running;
1> release maxMIMO-LayerPreferenceConfig for all configured cell groups from the UE Inactive AS context, if stored;
1> stop all instances of timer T346d, if running;
1> release minSchedulingOffsetPreferenceConfig for all configured cell groups from the UE Inactive AS context, if stored;
1> stop all instances of timer T346e, if running;
1> release releasePreferenceConfig from the UE Inactive AS context, if stored;
1> release wlanNameList from the UE Inactive AS context, if stored;
1> release btNameList from the UE Inactive AS context, if stored;
1> release sensorNameList from the UE Inactive AS context, if stored;
1> release obtainCommonLocation from the UE Inactive AS context, if stored;
1> stop timer T346f, if running;
1> release referenceTimePreferenceReporting from the UE Inactive AS context, if stored;
1> release sl-A ssistanceConfigNR from the UE Inactive AS context, if stored;
1> apply the CCCH configuration as specified in 9.1.1.2;
1> apply the timeAlignmentTimerCommon included in SIB1;
1> start timer T319;
1> set the variable pendingRNA-Update to false;
1> initiate transmission of the RRCResumeRequest message or RRCResumeRequest1 in accordance with 5.3.13.3.

### 5.3.13.3 Actions Related to Transmission of RRCResumeRequest or RRCResumeRequest1 Message

The UE shall set the contents of RRCResumeRequest or RRCResumeRequest1 message as follows:
1> if field useFullResumeID is signalled in SIB1:
   2> select RRCResumeRequest1 as the message to use;
   2> set the resumeIdentity to the stored fullI-RNTI value;
1> else:
   2> select RRCResumeRequest as the message to use;
   2> set the resumeIdentity to the stored shortI-RNTI value;
1> restore the RRC configuration, RoHC state, the stored QoS flow to DRB mapping rules and the K_{gNB} and K_{RRCint} keys from the stored UE Inactive AS context except for the following:
   masterCellGroup;
   mrdc-SecondaryCellGroup, if stored; and
   pdcp-Config;
1> set the resumeMAC-I to the 16 least significant bits of the MAC-I calculated:
   2> over the ASN.1 encoded as per clause 8 (i.e., a multiple of 8 bits) VarResumeMAC-Input;
   2> with the K_{RRCint} key in the UE Inactive AS Context and the previously configured integrity protection algorithm; and
   2> with all input bits for COUNT, BEARER and DIRECTION set to binary ones;
1> derive the K_{gNB} key based on the current K_{gNB} key or the NH, using the stored nextHopChainingCount value, as specified in TS 33.501 [11];
1> derive the K_{RRCenc} key, the K_{RRCint} key, the K_{UPint} key and the K_{UPenc} key;
1> configure lower layers to apply integrity protection for all radio bearers except SRB0 using the configured algorithm and the K_{RRCint} key and K_{UPint} key derived in this subclause immediately, i.e., integrity protection shall be applied to all subsequent messages received and sent by the UE;
NOTE 1: Only DRBs with previously configured UP integrity protection shall resume integrity protection.
1> configure lower layers to apply ciphering for all radio bearers except SRB0 and to apply the configured ciphering algorithm, the K_{RRCenc} key and the K_{UPenc} key derived in this subclause, i.e. the ciphering configuration shall be applied to all subsequent messages received and sent by the UE;
1> re-establish PDCP entities for SRB1;
1> resume SRB1;
1> submit the selected message RRCResumeRequest or RRCResumeRequest1 for transmission to lower layers.
NOTE 2: Only DRBs with previously configured UP ciphering shall resume ciphering.
   If lower layers indicate an integrity check failure while T319 is running, perform actions specified in 5.3.13.5.
   The UE shall continue cell re-selection related measurements as well as cell re-selection evaluation. If the conditions for cell re-selection are fulfilled, the UE shall perform cell re-selection as specified in 5.3.13.6.

### 5.3.13.4 Reception of the RRCResume by the UE

The UE shall:
1> stop timer T319;
1> stop timer T380, if running;
1> if T331 is running
   2> stop timer T331;
   2> perform the actions as specified in 5.7.8.3;
1> if the RRCResume includes the fullConfig:
   2> perform the full configuration procedure as specified in 5.3.5.11;
1> else:
   2> if the RRCResume does not include the restoreMCG-SCells:
      3> release the MCG SCell(s) from the UE Inactive AS context, if stored;
   2> if the RRCResume does not include the restoreSCG:
      3> release the MR-DC related configurations (i.e., as specified in 5.3.5.10) from the UE Inactive AS context, if stored;
   2> restore the masterCellGroup, mrdc-SecondaryCellGroup, if stored, and pdcp-Config from the UE Inactive AS context;
   2> configure lower layers to consider the restored MCG and SCG SCell(s) (if any) to be in deactivated state;
1> discard the UE Inactive AS context;
1> release the suspendConfig except the ran-NotificationAreaInfo;
1> if the RRCResume includes the masterCellGroup:
   2> perform the cell group configuration for the received masterCellGroup according to 5.3.5.5;
1> if the RRCResume includes the mrdc-SecondaryCellGroup:
   2> if the received mrdc-SecondaryCellGroup is set to nr-SCG:
      3> perform the RRC reconfiguration according to 5.3.5.3 for the RRCReconfiguration message included in nr-SCG;
   2> if the received mrdc-SecondaryCellGroup is set to eutra-SCG:
      3> perform the RRC connection reconfiguration as specified in TS 36.331 [10], clause 5.3.5.3 for the RRCConnectionReconfiguration message included in eutra-SCG;
1> if the RRCResume includes the radioBearerConfig:
   2> perform the radio bearer configuration according to 5.3.5.6;
1> if the RRCResume message includes the sk-Counter:
   2> perform security key update procedure as specified in 5.3.5.7;
1> if the RRCResume message includes the radioBearerConfig2:
   2> perform the radio bearer configuration according to 5.3.5.6;
1> if the RRCResume message includes the needForGapsConfigNR:
   2> if needForGapsConfigNR is set to setup:
      3> consider itself to be configured to provide the measurement gap requirement information of NR target bands;
   2> else:
      3> consider itself not to be configured to provide the measurement gap requirement information of NR target bands;
1> resume SRB2, SRB3 (if configured), and all DRBs;
1> if stored, discard the cell reselection priority information provided by the cellReselectionPriorities or inherited from another RAT;
1> stop timer T320, if running;
1> if the RRCResume message includes the measConfig:
   2> perform the measurement configuration procedure as specified in 5.5.2;
1> resume measurements if suspended;
1> if T390 is running
   2> stop timer T390 for all access categories;
   2> perform the actions as specified in 5.3.14.4;
1> if T302 is running
   2> stop timer T302;
   2> perform the actions as specified in 5.3.14.4;
1> enter RRC_CONNECTED;
1> indicate to upper layers that the suspended RRC connection has been resumed;
1> stop the cell re-selection procedure;
1> consider the current cell to be the PCell;
1> set the content of the of RRCResumeComplete message as follows:
   2> if the upper layer provides NAS PDU, set the dedicatedNAS-Message to include the information received from upper layers;
   2> if upper layers provides a PLMN and UE is either allowed or instructed to access the PLMN via a cell for which at least one CAG ID is broadcast:
      3> set the selectedPLMN-Identity from the npn-IdentityInfoList;
   2> else:
      3> set the selectedPLMN-Identity to the PLMN selected by upper layers from the plmn-IdentityinfoList;
   2> if the masterCellGroup contains the reportUplinkTxDirectCurrent:
      3> include the uplinkTxDirectCurrentList for each MCG serving cell with UL;
      3> include uplinkDirectCurrentBWP-SUL for each MCG serving cell configured with SUL carrier, if any, within the uplinkTxDirectCurrentList;
   2> if the masterCellGroup contains the reportUplinkTxDirectCurrentTwoCarrier:
      3> include in the uplinkTxDirectCurrentTwoCarrierList the list of uplink Tx DC locations for the configured uplink carrier aggregation in the MCG;
   [ . . . ]
1> submit the RRCResumeComplete message to lower layers for transmission;
1> the procedure ends.

### 5.3.13.7 Reception of the RRCSetup by the UE

The UE shall:
1> perform the RRC connection setup procedure as specified in 5.3.3.4.

### 5.3.13.8 RNA Update

In RRC_INACTIVE state, the UE shall:
1> if T380 expires; or
1> if RNA Update is triggered at reception of SIB1, as specified in 5.2.2.4.2:
   2> initiate RRC connection resume procedure in 5.3.13.2 with resume Cause set to ma-Update;
1> if barring is alleviated for Access Category ‘8’ or Access Category ‘2’, as specified in 5.3.14.4:
   2> if upper layers do not request RRC the resumption of an RRC connection, and
   2> if the variable pendingRNA-Update is set to true:
      3> initiate RRC connection resume procedure in 5.3.13.2 with resume Cause value set to ma-Update.

3GPP 38.331 v16.6.0 discusses RRC reconfiguration. One or more parts of 3GPP 38.331 v16.6.0 are quoted below:
RRCReconfiguration
   The RRCReconfiguration message is the command to modify an RRC connection. It may convey information for measurement configuration, mobility control, radio resource configuration (including RBs, MAC main configuration and physical channel configuration) and AS security configuration.
Signalling radio bearer: SRB1 or SRB3
RLC-SAP: AM
Logical channel: DCCH
Direction: Network to UE

RRCReconfiguration message

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration- |

IEs,

| | |
|---|---|
| criticalExtensionsFuture | SEQUENCE { } |

}
}

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING (CONTAINING |
| CellGroupConfig) | OPTIONAL, -- Cond SCG |
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530- |
| IEs | OPTIONAL |

}

| | |
|---|---|
| RRCReconfiguration-v1530-IEs ::= | SEQUENCE { |
| masterCellGroup | OCTET STRING (CONTAINING |
| CellGroupConfig) | OPTIONAL, -- Need M |
| fullConfig | ENUMERATED {true} |

OPTIONAL, -- Cond FullConfig

| | |
|---|---|
| dedicatedNAS-MessageList | SEQUENCE (SIZE(1..maxDRB)) |
| OF DedicatedNAS-Message | OPTIONAL, -- Cond nonHO |
| masterKeyUpdate | MasterKeyUpdate |

OPTIONAL, -- Cond MasterKeyChange

| | |
|---|---|
| dedicatedSIB1-Delivery | OCTET STRING (CONTAINING |
| SIB1) | OPTIONAL, -- Need N |
| dedicatedSystemInformationDelivery | OCTET STRING (CONTAINING |
| SystemInformation) | OPTIONAL, -- Need N |
| otherConfig | OtherConfig |

OPTIONAL, -- Need M

| | |
|---|---|
| nonCriticalExtension | RRCReconfiguration-v1540- |
| IEs | OPTIONAL |

}

| | |
|---|---|
| RRCReconfiguration-v1540-IEs ::= | SEQUENCE { |
| otherConfig-v1540 | OtherConfig-v1540 |

OPTIONAL, -- Need M

| | |
|---|---|
| nonCriticalExtension | RRCReconfiguration-v1560- |
| IEs | OPTIONAL |

}

| | |
|---|---|
| RRCReconfiguration-v1560-IEs ::= | SEQUENCE { |
| mrdc-SecondaryCellGroupConfig | SetupRelease { MRDC- |
| SecondaryCellGroupConfig } | OPTIONAL, -- Need |

M

| | |
|---|---|
| radioBearerConfig2 | OCTET STRING (CONTAINING |
| RadioBearerConfig) | OPTIONAL, -- Need M |
| sk-Counter | SK-Counter |

OPTIONAL, -- Need N

| | |
|---|---|
| nonCriticalExtension | RRCReconfiguration-v1610- |
| IEs | OPTIONAL |

}

| | |
|---|---|
| MRDC-SecondaryCellGroupConfig ::= | SEQUENCE { |
| mrdc-ReleaseAndAdd | ENUMERATED {true} |

OPTIONAL, -- Need N

| | |
|---|---|
| mrdc-SecondaryCellGroup | CHOICE { |
| nr-SCG | OCTET STRING |

(CONTAINING RRCReconfiguration),

| | |
|---|---|
| eutra-SCG | OCTET STRING |

}
}

| | |
|---|---|
| MasterKeyUpdate ::= | SEQUENCE { |
| keySetChangeIndicator | BOOLEAN, |
| nextHopChainingCount | NextHopChainingCount, |
| nas-Container | OCTET STRING |

OPTIONAL, -- Cond securityNASC
...
}

RRCReconfiguration-IEs field descriptions

fullConfig
Indicates that the full configuration option is applicable for the RRCReconfiguration message
for intra-system intra-RAT HO. For inter-RAT HO from E-UTRA to NR, fullConfig indicates
whether or not delta signalling of SDAP/PDCP from source RAT is applicable. This field is
absent if any DAPS bearer is configured or when the RRCReconfiguration message is
transmitted on SRB3, and in an RRCReconfiguration message for SCG contained in another
RRCReconfiguration message (or RRCConnectionReconfiguration message, see TS 36.331
[10]) transmitted on SRB1.
masterCellGroup
Configuration of master cell group.
mrdc-ReleaseAndAdd
This field indicates that the current SCG configuration is released and a new SCG is added at
the same time.
mrdc-SecondaryCellGroup
Includes an RRC message for SCG configuration in NR-DC or NE-DC.
For NR-DC (nr-SCG), mrdc-SecondaryCellGroup contains the RRCReconfiguration message
as generated (entirely) by SN gNB. In this version of the specification, the RRC message can
only include fields secondaryCellGroup, otherConfig, conditionalReconfiguration and
measConfig.
For NE-DC (eutra-SCG), mrdc-SecondaryCellGroup includes the E-UTRA
RRCConnectionReconfiguration message as specified in TS 36.331 [10]. In this version of
the specification, the E-UTRA RRC message can only include the field scg-Configuration.
needForGapsConfigNR
Configuration for the UE to report measurement gap requirement information of NR target
bands in the RRCReconfigurationComplete and RRCResumeComplete message.
nextHopChainingCount
Parameter NCC: See TS 33.501 [11]
otherConfig
Contains configuration related to other configurations. When configured for the SCG, only
fields drx-PreferenceConfig, maxBW-PreferenceConfig, maxCC-PreferenceConfig,
maxMIMO-LayerPreferenceConfig, minSchedulingOffsetPreferenceConfig, btNameList,
wlanNameList, sensorNameList and obtainCommonLocation can be included.
radioBearerConfig
Configuration of Radio Bearers (DRBs, SRBs) including SDAP/PDCP. In EN-DC this field
may only be present if the RRCReconfiguration is transmitted over SRB3.
radioBearerConfig2
Configuration of Radio Bearers (DRBs, SRBs) including SDAP/PDCP. This field can only be
used if the UE supports NR-DC or NE-DC.
secondaryCellGroup
Configuration of secondary cell group ((NG)EN-DC or NR-DC).
sk-Counter
A counter used upon initial configuration of S-K_{gNB} or S-K_{eNB}, as well as upon refresh of S-
K_{gNB} or S-K_{eNB}. This field is always included either upon initial configuration of an NR SCG or
upon configuration of the first RB with keyToUse set to secondary, whichever happens first.
This field is absent if there is neither any NR SCG nor any RB with keyToUse set to
secondary.
targetCellSMTC-SCG
The SSB periodicity/offset/duration configuration of target cell for NR PSCell addition and SN
change. When UE receives this field, UE applies the configuration based on the timing
reference of NR PCell for PSCell addition and PSCell change for the case of no
reconfiguration with sync of MCG, and UE applies the configuration based on the timing
reference of target NR PCell for the case of reconfiguration with sync of MCG. If both this field
and the smtc in secondaryCellGroup −> SpCellConfig −> reconfigurationWithSync are absent,
the UE uses the SMTC in the measObjectNR having the same SSB frequency and subcarrier
spacing, as configured before the reception of the RRC message.

RP-212288 (Views on Rel-18 proposals on MUSIM) discusses UE capability coordination for a MUSIM UE. One or more parts of RP-212288 are quoted below:

### UE Capability Coordination/Update

In the email discussion, it is mentioned that the UE can only report dual Rx/single Tx capability to one network or even report the single Rx/single Tx capability to both networks. However this is only one possible UE implementation, and not an economical implementation. Therefore for further enhancement of MUSIM in Rel-18, it should not be always assumed that Rx&Tx capabilities are statically split between the two networks.

Proposal 2: It should not be assumed that Rx&Tx capabilities of MUSIM UEs are always statically split between the two networks.
In case the UE capabilities are allowed to be adjusted between two networks, there are still some challenges if we only depend on the UE implementation. Some companies also mentioned that the UE can send reduced CSI to the network, however this has negative impact for network implementation, and different network vendors have different policies to cope with the reduced CSI. Unavoidably, there may be data loss due to demodulation failure and thus wasting resources in some networks as the network is not aware of the reduced UE capabilities. Moreover, as mentioned by other companies, such implementation is not in compliant with RAN4 requirements.
Observation 1: In case the UE capabilities are adjusted between two networks without proper coordination between the UE and the networks, data loss and resource waste happen as the networks are not aware of the reduced UE capabilities
In order to avoid data loss and system resource waste, it is necessary to have a mechanism of supporting UE capabilities synchronization between UE and network. During NR R15 stage, the temporary capability restriction was discussed. Nevertheless, only the UE assistance information (UAI) mechanism was introduced for reduction of number of CCs, Bandwidth and MIMO layers. On the other hand, since there is no requirement on the network side after receiving the UAI message, and it is up to the network whether and when to reconfigure UE according to the UAI, the UE cannot adjust its capabilities in time. Therefore the UAI mechanism is not suitable for the UE capabilities coordination or update. A new mechanism should be introduced for supporting more extensive and timely UE capabilities coordination or update in Rel-18.
Observation 2: The current UAI mechanism is not suitable for the UE capabilities coordination or update.
When the UE temporarily tunes away partial Tx or Rx capabilities to network B and still keeps connection in network A, some RF and baseband capabilities are impacted. The relevant RF capabilities most frequently include the maximum number of MIMO layers, band combination for CA/DC, SRS capabilities, SUL capabilities, and Multi-TRPs capabilities.
Observation 3: When the UE temporarily tunes away partial Tx or Rx capabilities to other network, the following RF capabilities are most frequently affected:
maximum number of MIMO layers
band combination for CA/DC
SRS capabilities
SUL capabilities
Multi-TRPs capabilities
   Proposal 3: To specify UE capability coordination/update mechanism with NW A in Rel-18 when the UE tunes away partial TX or RX chains to NW B.

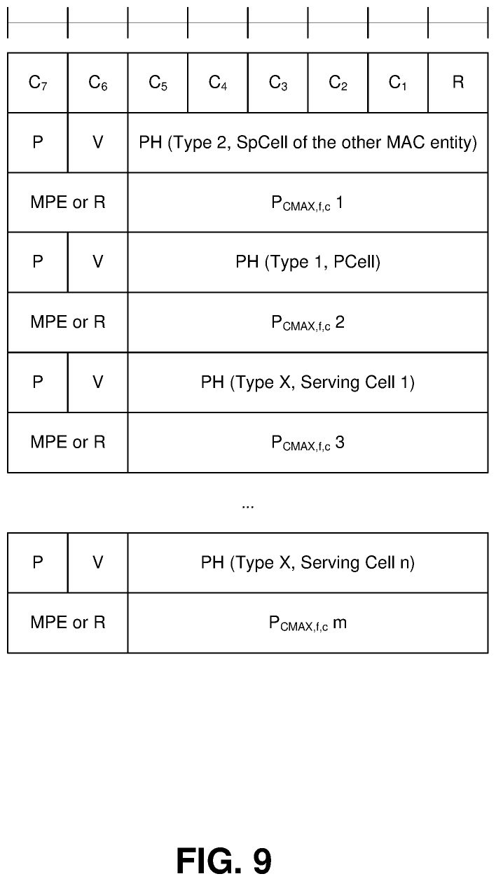

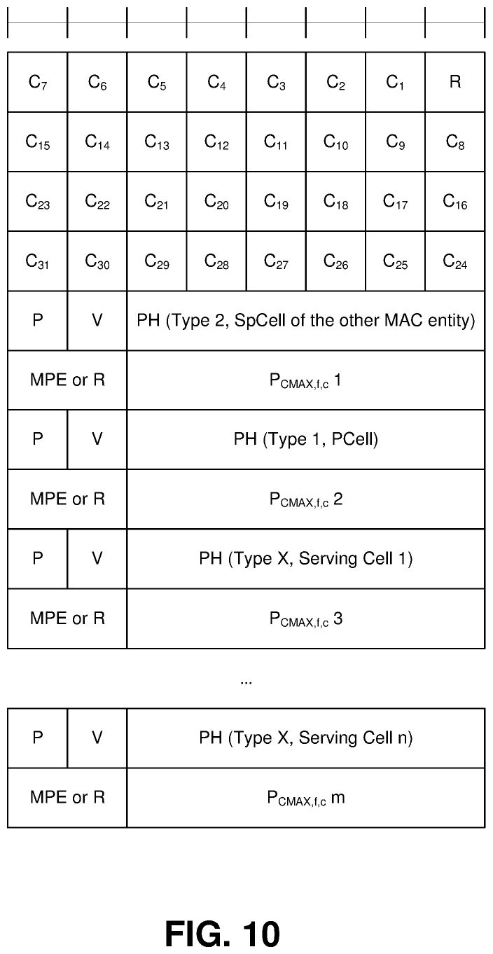

3GPP 38.321 v16.6.0 discusses power headroom reporting (PHR). Notably, FIG. 6.1.3.9-1 of Section 6.1.3.9 of 3GPP 38.321 v16.6.0, entitled “Multiple Entry PHR MAC CE with the highest ServCellIndex of Serving Cell with configured uplink is less than 8”, is reproduced herein as FIG. 9. FIG. 6.1.3.9-2 of Section 6.1.3.9 of 3GPP 38.321 v16.6.0, entitled “Multiple Entry PHR MAC CE with the highest ServCellIndex of Serving Cell with configured uplink is equal to or higher than 8”, is reproduced herein as FIG. 10. One or more parts of 3GPP 38.321 v16.6.0 are quoted below:

### 5.4.6 Power Headroom Reporting

The Power Headroom reporting procedure is used to provide the serving gNB with the following information:
Type 1 power headroom: the difference between the nominal UE maximum transmit power and the estimated power for UL-SCH transmission per activated Serving Cell;
Type 2 power headroom: the difference between the nominal UE maximum transmit power and the estimated power for UL-SCH and PUCCH transmission on SpCell of the other MAC entity (i.e. S-UTRA MAC entity in EN-DC, NE-DC, and NGEN-DC cases);
Type 3 power headroom: the difference between the nominal UE maximum transmit power and the estimated power for SRS transmission per activated Serving Cell;
MPE P-MPR: the power backoff to meet the MPE FR2 requirements for a Serving Cell operating on FR2.
   [ . . . ]
   A Power Headroom Report (PHR) shall be triggered if any of the following events occur:
phr-ProhibitTimer expires or has expired and the path loss has changed more than phr-Tx-PowerFactorChange dB for at least one activated Serving Cell of any MAC entity of which the active DL BWP is not dormant BWP which is used as a pathloss reference since the last transmission of a PHR in this MAC entity when the MAC entity has UL resources for new transmission;
NOTE 1: The path loss variation for one cell assessed above is between the pathloss measured at present time on the current pathloss reference and the pathloss measured at the transmission time of the last transmission of PHR on the pathloss reference in use at that time, irrespective of whether the pathloss reference has changed in between. The current pathloss reference for this purpose does not include any pathloss reference configured using pathlossReferenceRS-Pos in TS 38.331 [5].
phr-PeriodicTimer expires;
upon configuration or reconfiguration of the power headroom reporting functionality by upper layers, which is not used to disable the function;
activation of an SCell of any MAC entity with configured uplink of which firstActiveDownlinkBWP-Id is not set to dormant BWP;
addition of the PSCell (i.e. PSCell is newly added or changed);
phr-ProhibitTimer expires or has expired, when the MAC entity has UL resources for new transmission, and the following is true for any of the activated Serving Cells of any MAC entity with configured uplink
there are UL resources allocated for transmission or there is a PUCCH transmission on this cell, and the required power backoff due to power management (as allowed by P-MPR_{c} as specified in TS 38.101-1 [14], TS 38.101-2 [15], and TS 38.101-3 [16]) for this cell has changed more than phr-Tx-PowerFactorChange dB since the last transmission of a PHR when the MAC entity had UL resources allocated for transmission or PUCCH transmission on this cell.
Upon switching of activated BWP from dormant BWP to non-dormant DL BWP of an SCell of any MAC entity with configured uplink;
if mpe-Reporting-FR2 is configured, and mpe-ProhibitTimer is not running
   the measured P-MPR applied to meet FR2 MPE requirements as specified in TS 38.101-2 [15] is equal to or larger than mpe-Threshold for at least one activated FR2 Serving Cell since the last transmission of a PHR in this MAC entity; or
      the measured P-MPR applied to meet FR2 MPE requirements as specified in TS 38.101-2 [15] has changed more than phr-Tx-PowerFactorChange dB for at least one activated FR2 Serving Cell since the last transmission of a PHR due to the measured P-MPR applied to meet MPE requirements being equal to or larger than mpe-Threshold in this MAC entity.
      in which case the PHR is referred below to as ‘MPE P-MPR report’.

NOTE 2: The MAC entity should avoid triggering a PHR when the required power backoff due to power management decreases only temporarily (e.g. for up to a few tens of milliseconds) and it should avoid reflecting such temporary decrease in the values of P_{CMAX,f,c}/PH when a PHR is triggered by other triggering conditions.
NOTE 3: If a HARQ process is configured with cg-RetransmissionTimer and if the PHR is already included in a MAC PDU for transmission on configured grant by this HARQ process, but not yet transmitted by lower layers, it is up to UE implementation how to handle the PHR content.
   If the MAC entity has UL resources allocated for a new transmission the MAC entity shall:
1> if it is the first UL resource allocated for a new transmission since the last MAC reset:
   2> start phr-Periodic Timer.
1> if the Power Headroom reporting procedure determines that at least one PHR has been triggered and not cancelled; and
1> if the allocated UL resources can accommodate the MAC CE for PHR which the MAC entity is configured to transmit, plus its subheader, as a result of LCP as defined in clause 5.4.3.1:
   2> if multiplePHR with value true is configured:
      3> for each activated Serving Cell with configured uplink associated with any MAC entity of which the active DL BWP is not dormant BWP; and
      3> for each activated Serving Cell with configured uplink associated with E-UTRA MAC entity:
         4> obtain the value of the Type 1 or Type 3 power headroom for the corresponding uplink carrier as specified in clause 7.7 of TS 38.213 [6] for NR Serving Cell and clause 5.1.1.2 of TS 36.213 [17] for E-UTRA Serving Cell;
         4> if this MAC entity has UL resources allocated for transmission on this Serving Cell; or
         4> if the other MAC entity, if configured, has UL resources allocated for transmission on this Serving Cell and phr-ModeOtherCG is set to real by upper layers:
         5> obtain the value for the corresponding P_{CMAX,f,c} field from the physical layer.
         5> if mpe-Reporting-FR2 is configured and this Serving Cell operates on FR2 and this Serving Cell is associated to this MAC entity:
         6> obtain the value for the corresponding MPE field from the physical layer.
      3> if phr-Type2OtherCell with value true is configured:
         4> if the other MAC entity is E-UTRA MAC entity:
         5> obtain the value of the Type 2 power headroom for the SpCell of the other MAC entity (i.e. E-UTRA MAC entity);
         5> if phr-ModeOtherCG is set to real by upper layers:
         6> obtain the value for the corresponding P_{CMAX,f,c} field for the SpCell of the other MAC entity (i.e. E-UTRA MAC entity) from the physical layer.
      3> instruct the Multiplexing and Assembly procedure to generate and transmit the Multiple Entry PHR MAC CE as defined in clause 6.1.3.9 based on the values reported by the physical layer.
   2> else (i.e. Single Entry PHR format is used):
      3> obtain the value of the Type 1 power headroom from the physical layer for the corresponding uplink carrier of the PCell;
      3> obtain the value for the corresponding P_{CMAX,f,c} field from the physical layer;
      3> if mpe-Reporting-FR2 is configured and this Serving Cell operates on FR2:
         4> obtain the value for the corresponding MPE field from the physical layer.
      3> instruct the Multiplexing and Assembly procedure to generate and transmit the Single Entry PHR MAC CE as defined in clause 6.1.3.8 based on the values reported by the physical layer.
   2> if this PHR report is an MPE P-MPR report:
      3> start or restart the mpe-ProhibitTimer;
      3> cancel triggered MPE P-MPR reporting for Serving Cells included in the PHR MAC CE.
   2> start or restart phr-PeriodicTimer;
   2> start or restart phr-ProhibitTimer;
   2> cancel all triggered PHR(s).

### 6.1.3.9 Multiple Entry PHR MAC CE

The Multiple Entry PHR MAC CE is identified by a MAC subheader with LCID as specified in Table 6.2.1-2.
It has a variable size, and includes the bitmap, a Type 2 PH field and an octet containing the associated P_{CMAX,f,c} field (if reported) for SpCell of the other MAC entity, a Type 1 PH field and an octet containing the associated P_{CMAX,f,c} field (if reported) for the PCell. It further includes, in ascending order based on the ServCellIndex, one or multiple of Type X PH fields and octets containing the associated P_{CMAX,f,c} fields (if reported) for Serving Cells other than PCell indicated in the bitmap. X is either 1 or 3 according to TS 38.213 [6] and TS 36.213 [17].
The presence of Type 2 PH field for SpCell of the other MAC entity is configured by phr-Type2OtherCell with value true.
A single octet bitmap is used for indicating the presence of PH per Serving Cell when the highest ServCellIndex of Serving Cell with configured uplink is less than 8, otherwise four octets are used.
The MAC entity determines whether PH value for an activated Serving Cell is based on real transmission or a reference format by considering the configured grant(s) and downlink control information which has been received until and including the PDCCH occasion in which the first UL grant for a new transmission that can accommodate the MAC CE for PHR as a result of LCP as defined in clause 5.4.3.1 is received since a PHR has been triggered if the PHR MAC CE is reported on an uplink grant received on the PDCCH or until the first uplink symbol of PUSCH transmission minus PUSCH preparation time as defined in clause 7.7 of TS 38.213 [6] if the PHR MAC CE is reported on a configured grant.
For a band combination in which the UE does not support dynamic power sharing, the UE may omit the octets containing Power Headroom field and P_{CMAX,f,c} field for Serving Cells in the other MAC entity except for the PCell in the other MAC entity and the reported values of Power Headroom and P_{CMAX,f,c} for the PCell are up to UE implementation.
The PHR MAC CEs are defined as follows:
Cᵢ: This field indicates the presence of a PH field for the Serving Cell with ServCellIndex i as specified in TS 38.331 [5]. The Cᵢ field set to 1 indicates that a PH field for the Serving Cell with ServCellIndex i is reported. The Cᵢ field set to 0 indicates that a PH field for the Serving Cell with ServCellIndex i is not reported;
R: Reserved bit, set to 0;
V: This field indicates if the PH value is based on a real transmission or a reference format. For Type 1 PH, the V field set to 0 indicates real transmission on PUSCH and the V field set to 1 indicates that a PUSCH reference format is used. For Type 2 PH, the V field set to 0 indicates real transmission on PUCCH and the V field set to 1 indicates that a PUCCH reference format is used. For Type 3 PH, the V field set to 0 indicates real transmission on SRS and the V field set to 1 indicates that an SRS reference format is used. Furthermore, for Type 1, Type 2, and Type 3 PH, the V field set to 0 indicates the presence of the octet containing the associated P_{CMAX,f,c} field and the MPE field, and the V field set to 1 indicates that the octet containing the associated P_{CMAX,f,c} field and the MPE field is omitted;
Power Headroom (PH): This field indicates the power headroom level. The length of the field is 6 bits. The reported PH and the corresponding power headroom levels are shown in Table 6.1.3.8-1 (the corresponding measured values in dB for the NR Serving Cell are specified in TS 38.133 [11] while the corresponding measured values in dB for the E-UTRA Serving Cell are specified in TS 36.133 [12]);
P: If mpe-Reporting-FR2 is configured and the Serving Cell operates on FR2, the MAC entity shall set this field to 0 if the applied P-MPR value, to meet MPE requirements, as specified in TS 38.101-2 [15], is less than P-MPR_00 as specified in TS 38.133 [11] and to 1 otherwise. If mpe-Reporting-FR2 is not configured or the Serving Cell operates on FR1, this field indicates whether power backoff is applied due to power management (as allowed by P-MPR_{c} as specified in TS 38.101-1 [14], TS 38.101-2 [15], and TS 38.101-3 [16]). The MAC entity shall set the P field to 1 if the corresponding P_{CMAX,f,c} field would have had a different value if no power backoff due to power management had been applied;
P_{CMAX,f,c}: If present, this field indicates the P_{CMAX,f,c} (as specified in TS 38.213 [6]) for the NR Serving Cell and the P_{CMAX,c} or \tilde{P}_{CMAX,c} (as specified in TS 36.213 [17]) for the E-UTRA Serving Cell used for calculation of the preceding PH field. The reported P_{CMAX,f,c} and the corresponding nominal UE transmit power levels are shown in Table 6.1.3.8-2 (the corresponding measured values in dBm for the NR Serving Cell are specified in TS 38.133 [11] while the corresponding measured values in dBm for the E-UTRA Serving Cell are specified in TS 36.133 [12]);
MPE: If mpe-Reporting-FR2 is configured, and the Serving Cell operates on FR2, and if the P field is set to 1, this field indicates the applied power backoff to meet MPE requirements, as specified in TS 38.101-2 [15]. This field indicates an index to Table 6.1.3.8-3 and the corresponding measured values of P-MPR levels in dB are specified in TS 38.133 [11]. The length of the field is 2 bits. If mpe-Reporting-FR2 is not configured, or if the Serving Cell operates on FR1, or if the P field is set to 0, R bits are present instead.

### FIG. 6.1.3.9-1: Multiple Entry PHR MAC CE with the Highest ServCellIndex of Serving Cell with Configured Uplink is Less than 8

### FIG. 6.1.3.9-2: Multiple Entry PHR MAC CE with the Highest ServCellIndex of Serving Cell with Configured Uplink is Equal to or Higher than 8

Many UEs (e.g., commercially deployed devices, personal devices, smartphones, tablets, etc.) support more than one Subscriber Identity Module (SIM) card (e.g., two SIM cards). For example, a user of a UE may have two subscriptions (e.g., both a personal telecommunication service subscription for personal use and a business telecommunication service subscription for work-related use) and may wish to use them both for the same device. The UE may, e.g., in RRC connected state, connect (e.g., perform connection) with a first network (NW) “NW-A” via a first SIM card and/or with a second network “NW-B” via a second SIM card. The UE may have (e.g., may be configured with) more than one transmitter (TX) chain. For example, the UE may have two TX chains. In an example, when the UE's first SIM card is in RRC connected state with NW-A, and the UE's second SIM card is in RRC idle or RRC inactive state with NW-B (or the second SIM is not connected to any network or is not used), the UE may use the two TX chains for communication with NW-A via the first SIM card. In Rel-18 (e.g., New Radio (NR) Release 18), enhancement of multiple SIM (MUSIM) is discussed, and/or the UE may operate in RRC connected state concurrently (e.g., simultaneously) in NW-A and NW-B (via the first SIM card and the second SIM card, respectively). In the example above, to operate in RRC connected state in NW-B while concurrently (e.g., simultaneously) operating in RRC connected state in NW-A, at least one of the TX chains needs to be switched to the second SIM card, which may lead to reduced capability of remaining TX chains (e.g., one remaining TX chain) of the UE used in association with NW-A. Accordingly, resources associated with NW-A (e.g., resources used by the UE to communicate with NW-A) may be affected (e.g., at least one of Secondary Cell (SCell), Secondary Cell Group (SCG), configured resources, etc. may be reduced and/or released).

If NW-A is unaware of the change in capability (e.g., the reduction in capability of remaining TX chains, used by the UE to communicate with NW-A, as a result of switching at least one TX chain to the second SIM card), there may be data loss and wasting radio resources in NW-A. Therefore, it may be beneficial for the UE to provide assistance information to NW-A.

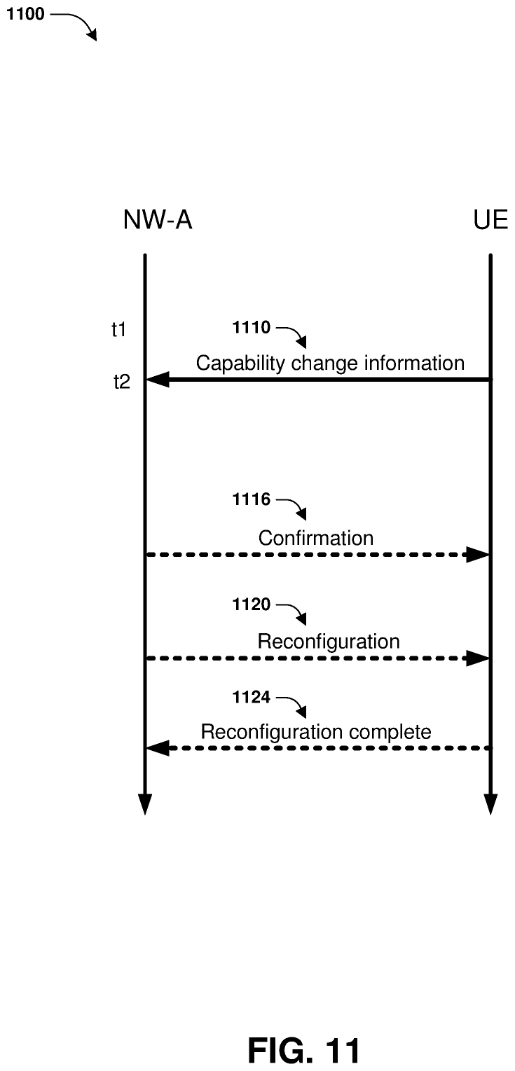

FIG. 11 illustrates an example scenario 1100 associated with a UE and/or a first network, NW-A. The UE may operate in RRC connected state with NW-A. The UE may communicate with NW-A via a first SIM card. At timing t2 or before timing t2 (e.g., at timing t1), the UE may determine to (e.g., decide to and/or be indicated to, such as instructed to) operate in RRC connected state with a network, NW-B. In the present disclosure, the term “timing” may refer to at least one of a point in time, a time unit (e.g., a slot, a symbol, etc.), a period of time, etc. The UE may provide a capability change information 1110, to the NW-A, indicating capability change (e.g., the capability change may correspond to release of one or more cells and/or one or more SCGs and/or deactivation of one or more configured resources).

The capability change information 1110 may be associated with (e.g., may be indicative of) capability restriction. For example, the capability change information 1110 may indicate release of one or more cells and/or one or more SCGs. Alternatively and/or additionally, the capability change information 1110 may indicate deactivation of one or more configured resources (e.g., one or more resources configured for use in communication between the UE and NW-A).

The NW-A may provide a confirmation message 1116 to the UE in response to the capability change information 1110. The confirmation message 1116 may indicate acknowledgment of the capability change information 1110. Alternatively, the NW-A may not provide a confirmation message (e.g., any confirmation message) to the UE in response to the capability change information 1110. Alternatively and/or additionally, the UE may determine (e.g., consider) that the NW-A does not allow the capability change if no confirmation message is received. In some examples, NW-A may provide a reconfiguration message 1120 to the UE in response to the capability change information 1110. The reconfiguration message 1120 may be a Radio Resource Control (RRC) message (e.g., RRCReconfiguration). The UE may perform (e.g., apply) a reconfiguration in response to the reconfiguration message 1120. The UE may perform the reconfiguration by applying and/or configure at least one of a TX chain, a resource, a cell, a SCG, etc. associated with NW-A. The UE may transmit a reconfiguration complete message 1124 to the NW-A in response to the reconfiguration (e.g., in response to applying the reconfiguration based on the reconfiguration complete message 1124).

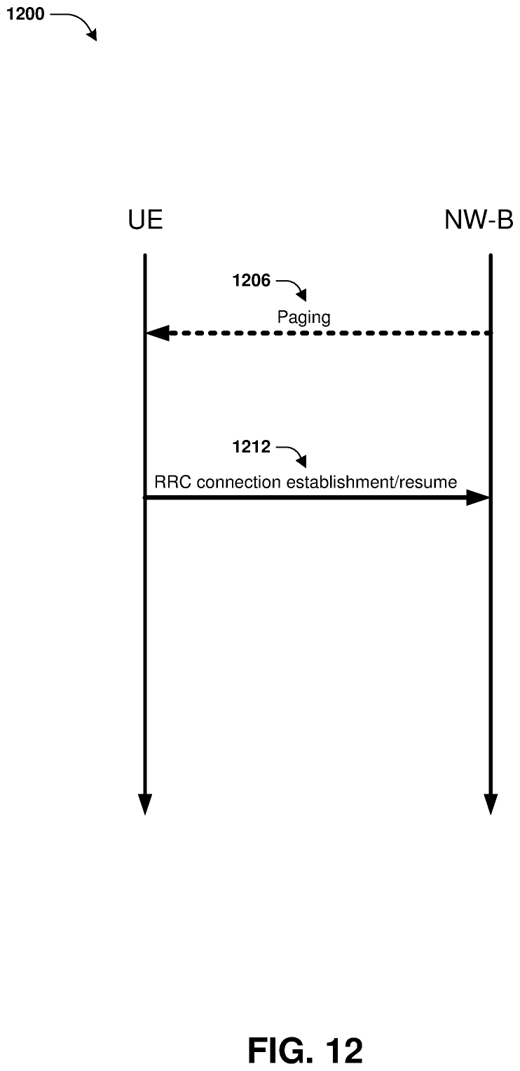

FIG. 12 illustrates an example scenario 1200 associated with the UE (introduced with respect to the example scenario 1100 of FIG. 11) and/or a second network, NW-B. In the example scenario 1220, the UE may be in coverage of NW-B. The UE may be in RRC idle or RRC inactive in NW-B (e.g., the UE may stay in RRC idle or RRC inactive in NW-B before performing a RRC connection establishment and/or a RRC connection resume). The UE may communicate with NW-B via a second SIM card. The UE may receive a paging message 1206 from the NW-B (e.g., the UE may receive the paging message 1206 when in RRC inactive or RRC idle state in NW-B). The UE may determine to (e.g., decide to and/or be indicated to, such as instructed to) operate in RRC connected state in NW-B. When the UE is in (e.g., operates in) RRC connected state in NW-B (e.g., after the UE enters RRC connected state in NW-B), the UE may be concurrently (e.g., simultaneously) operating in RRC connected state in both the NW-A and the NW-B. In some examples, the UE may transmit a RRC connection establishment and/or resume message 1212 to NW-B (e.g., the message 1212 may be transmitted to perform RRC connection establishment and/or RRC connection resume and/or to enter RRC connected state in NW-B).

In addition to transmission/reception resource change (e.g., TX/receiver (RX) chain change and/or Cell change) for the networks (e.g., NW-A and/or NW-B), power usage and power management may also change when the connection status changes in one of the two networks (e.g., when the UE switches from RRC inactive or RRC idle state in NW-B to RRC connected state in NW-B). A UE may trigger and/or report a Power Headroom Report (e.g., via a Power Headroom Reporting (PHR) Medium Access Control (MAC) Control Element (CE)) to report (e.g., indicate), to a network, information about the UE's current or changed Power headroom level and/or power backoff (for each serving cell, for example). In some systems, the UE may trigger and/or report the Power Headroom Report in response to (i) pathloss changes for at least one activated Serving Cell, (ii) expiration of a periodic timer or a prohibit timer, (iii) a configuration of power headroom reporting functionality, (iv) activation of an SCell, (v) addition of a Primary SCell, (vi) switching activated Bandwidth Part (BWP) of a SCell from dormant BWP to a non-dormant BWP, and/or (vii) a Maximum Power Reduction (MPR) of frequency range 2 (FR2) changing by over a threshold change and/or the MPR meeting (e.g., being equal to larger than) a threshold.

An issue may occur when a UE connects to a second network while continuing to operate in RRC connected state in a first network. The UE may not report the power change caused by multi-SIM operation or related resource change associated with the second network, and the first network may not be able to adjust power management leading to ill-performance on data transmission. In the present disclosure, techniques are provided for reporting power information associated with (e.g., in response to) multiple connections using multiple SIMs and/or multiple TX/RX chains.

A concept of the present disclosure is that a UE may trigger a power headroom reporting (PHR) associated with (e.g., for and/or to) a first network (NW) in response to (and/or when) establishing and/or resuming a connection (e.g., a RRC connection) to a second network. The UE may trigger a PHR associated with the first network in response to (and/or when) initiating, performing and/or completing a RRC connection establishment (e.g., a RRC connection establishment procedure) or RRC connection resume (e.g., a RRC connection resume procedure) with the second network. The UE may operate in RRC connected state in both the first network and the second network after establishing and/or resuming connection to the second network (e.g., after completion of the establishing and/or resuming connection to the second network). Alternatively and/or additionally, the UE may trigger a PHR associated with the first network in response to entering RRC connected state in the second network. Alternatively and/or additionally, the UE may trigger a PHR associated with (e.g., for and/or to) the second network in response to (and/or when) entering RRC connected state in the second network. For example, the UE may trigger the PHR associated with the second network based on (e.g., considering) a cell (e.g., a Primary Cell (PCell)), of the second network, where the RRC connection establishment (e.g., the RRC connection establishment procedure) or the RRC connection resume (e.g., the RRC connection resume procedure) is performed. The UE may (concurrently, such as simultaneously, for example) operate in RRC connected state in both the first network and the second network when the PHR is triggered. In some examples, in a scenario in which the UE leaves (and/or does not stay in) RRC connected state in the first network (e.g., the UE leaves RRC connected state in the first UE when entering RRC connected state in the second network), the UE may not trigger a PHR to the first network when entering RRC connected state in the second network.

The UE may cancel the triggered PHR to the first network in response to failure and/or rejection of the RRC connection establishment (e.g., the RRC connection establishment procedure) or the RRC connection resume (e.g., the RRC connection resume procedure) with the second network.

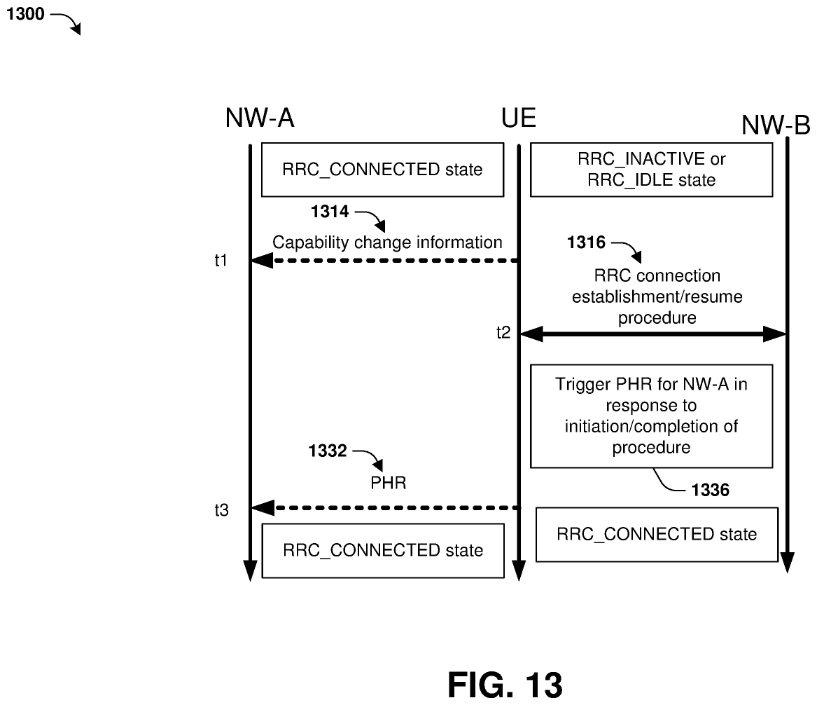

FIG. 13 illustrates an example scenario 1300 associated with a UE, a first network, NW-A, and/or a second network, NW-B. Before timing t1, the UE may operate in RRC connected state in NW-A (via a first SIM card, for example), and does not operate in RRC connected state (e.g., the UE operates in RRC inactive or RRC idle state) in NW-B (via a second SIM card, for example). The UE may determine to establish RRC connection with the NW-B. The UE may transmit a capability change information 1314 to the NW-A at timing t1. The capability change information 1314 may indicate a preference of change (e.g., release) of SCG, SCell, and/or configured resources associated with the NW-A (e.g., the capability change information 1314 may be indicative of a SCG, a SCell and/or one or more configured resources that the UE (i) currently uses for communication with the NW-A and/or (ii) plans and/or prefers to release, deactivate and/or cease using for communication with the NW-A). The UE may initiate and/or perform RRC connection procedure 1316 (e.g., RRC connection establishment procedure and/or RRC connection resume procedure) to the NW-B at timing t2 (e.g., timing t2 may be after or the same as timing t1). The UE may trigger 1336 a PHR for NW-A in response to the initiation and/or completion of the RRC connection procedure 1316 to the NW-B. Alternatively and/or additionally, the UE may trigger 1336 the PHR in response to a RRC connection state change (e.g., RRC connection state transition) associated with the NW-B (e.g., the RRC connection state change may correspond to the UE changing from operating in RRC inactive or RRC idle state to operating in RRC connected state in the NW-B). At timing t3, the UE may report (e.g., transmit) power information 1332 (e.g., a power headroom report) associated with the triggered PHR to the NW-A. The UE may operate in RRC connected state in both the NW-A and the NW-B at timing t3.

Alternatively and/or additionally, a PHR may be triggered in association with changing from two RRC connections to one RRC connection. In an example, the UE may trigger a PHR associated with (e.g., for and/or to) the first network in response to (and/or when) leaving an RRC connection (e.g., an established RRC connection) to a second network. The UE may trigger a PHR associated with the first network in response to (and/or when) initiating, performing and/or completing a RRC connection release (e.g., a RRC connection release procedure) with a second network. The UE may operate in RRC connected state in the first network and operate in RRC inactive or RRC idle state in the second network after RRC connection release (e.g., after completion of RRC connection release) with second network. Alternatively and/or additionally, the UE may trigger a PHR associated with the first network in response to (and/or when) entering RRC idle or RRC inactive state in the second network. Alternatively and/or additionally, the UE may trigger a PHR associated with the first network in response to the UE ceasing to perform communication with the second network (and/or when the UE stops performing communication with the second network). Alternatively and/or additionally, the UE may trigger a PHR associated with the first network in response to (and/or when) receiving a RRC connection release message (e.g., RRCRelease) from the second network. Alternatively and/or additionally, the UE may trigger a PHR associated with the first network in response to (and/or when) successfully acknowledging a reception of the RRC connection release message to the second network.

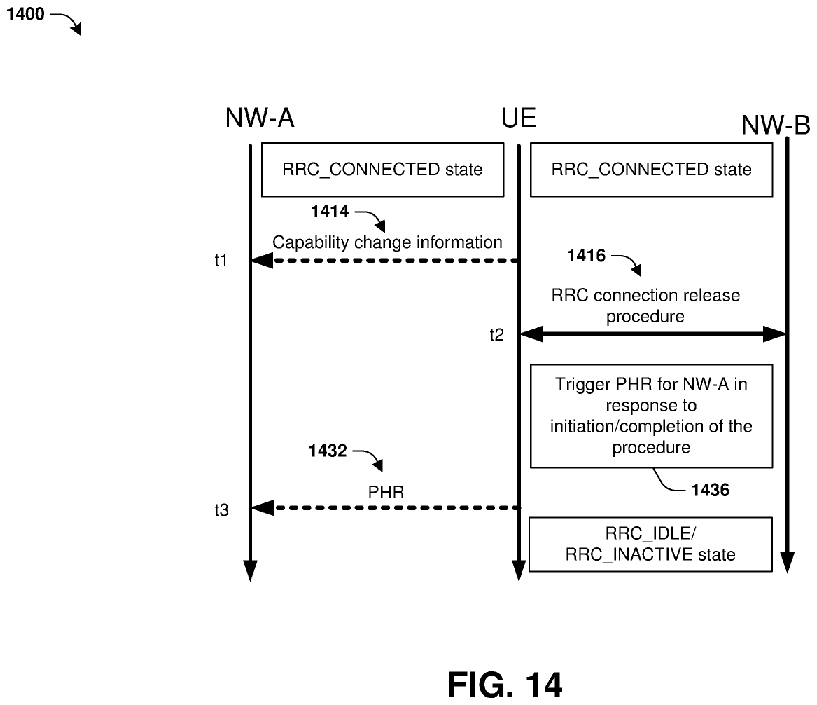

FIG. 14 illustrates an example scenario 1400 associated with a UE, a first network, NW-A, and/or a second network, NW-B. Before timing t1, the UE may operate in RRC connected state in both NW-A (via a first SIM card, for example) and NW-B (via a second SIM card, for example). The UE may determine to release a RRC connection with the NW-B. The UE may transmit a capability change information 1414 to the NW-A at timing t1. The capability change information may indicate a preference of change (e.g., release) of SCG, SCell, and/or configured resources associated with the NW-A or NW-B (e.g., the capability change information 1414 may be indicative of a SCG, a SCell and/or one or more configured resources that the UE (i) currently uses for communication with the NW-A or the NW-B and/or (ii) plans and/or prefers to release, deactivate and/or cease using for communication with the NW-A or the NW-B). The UE may initiate and/or perform RRC connection release procedure 1416 to the NW-B at timing t2 (e.g., timing t2 may be after or the same as timing t1). The UE may trigger 1436 a PHR for NW-A in response to the initiation and/or completion of the RRC connection release procedure 1416 to the NW-B. Alternatively and/or additionally, the UE may trigger 1436 the PHR in response to RRC connection state change (e.g., RRC connection state transition) associated with the NW-B (e.g., the RRC connection state change may correspond to the UE changing from operating in RRC connected state to operating in RRC inactive or RRC idle state in the NW-B). At timing t3, the UE may report (e.g., transmit) power information 1432 (e.g., a power headroom report) associated with the triggered PHR to the NW-A. The UE may operate in RRC connected state in the NW-A and operate in RRC idle or RRC inactive state in the NW-B at timing t3.

Alternatively and/or additionally, a PHR may be triggered when a maximum power change exceeds a threshold. In an example, the UE may trigger a PHR associated with (e.g., for and/or to) the first network in response to a maximum transmission power (e.g., maximum transmit power, such as P_{CMAX}) changing by over a threshold change (since a most recent PHR transmission to the first network) for a Serving Cell (e.g., an activated Serving Cell). For example, the UE may trigger the PHR associated with (e.g., for and/or to) the first network when the maximum transmission power changes by over the threshold change for the Serving Cell. The Serving Cell may be associated with the first network. The change of the maximum transmission power may be associated with (e.g., based on and/or due to) the UE changing its connection state associated with the second network (e.g., changing from RRC inactive or RRC idle state to RRC connected state or changing from RRC connected state to RRC inactive or RRC idle state). Alternatively and/or additionally, the UE may not trigger the PHR based on the change of the maximum transmit power if (and/or when) the change of the maximum transmit power is not associated with a connection state change associated with the second network.

Alternatively and/or additionally, a PHR may be triggered when a SCell and/or SCG is deactivated and/or one or more configured resources are released. In an example, the UE may trigger a PHR associated with (e.g., for and/or to) the first network in response to (and/or when) releasing, de-configuring, and/or deactivating a SCG associated with the first network. Alternatively and/or additionally, the UE may trigger a PHR to the first network (and/or when) releasing, de-configuring, and/or deactivating one or more SCells associated with the first network. The release, de-configuration, and/or deactivation of the SCG and/or the one or more SCells may be associated with the UE performing a RRC connection establishment and/or a RRC connection resume to the second network. The release, de-configuration, and/or deactivation of the SCG and/or the one or more SCells may be associated with the UE entering RRC connected state in the second network.

Alternatively and/or additionally, the UE may not trigger a PHR associated with (e.g., for and/or to) the first network in response to (and/or when) releasing, de-configuring, and/or deactivating the SCG and/or the one or more SCells if the release, de-configuration, and/or deactivation of the SCG and/or the one or more SCells is not associated with (e.g., is not based on and/or due to) the UE entering RRC connected state in the second network.

Alternatively and/or additionally, the UE may not trigger a PHR to the first network in response to (and/or when) releasing, de-configuring, and/or deactivating the SCG and/or the one or more SCells if the UE operates in RRC connected state in a single network (e.g., the first network only).

The SCG and/or the one or more SCells may be associated with (e.g., may be configured by) the first network.

Alternatively and/or additionally, the UE may trigger a PHR associated with (e.g., for and/or to) the first network in response to (and/or when) releasing, de-configuring, and/or deactivating one or more resources associated with the first network. The release, de-configuration, and/or deactivation of the one or more resources may be associated with the UE performing a RRC connection establishment and/or a RRC connection resume to the second network. The release, de-configuration, and/or deactivation of the one or more resources may be associated with the UE entering RRC connected state in the second network.

Alternatively and/or additionally, the UE may not trigger a PHR associated with (e.g., for and/or to) the first network in response to (and/or when) releasing, de-configuring, and/or deactivating the one or more resources if the release, de-configuration, and/or deactivation of the one or more resources is not associated with (e.g., is not based on and/or due to) the UE entering RRC connected state in the second network.

The one or more resources may comprise one or more uplink (UL) resources and/or one or more DL resources for UL transmission and/or DL reception. The one or more resources may comprise one or more configured UL grants and/or one or more DL assignments.

Alternatively and/or additionally, a PHR may be triggered when a TX/RX chain changes (e.g., switches). In the present disclosure, the term “TX/RX chain” may refer to a TX chain and/or a RX chain. For example, one or more TX/RX chains may comprise one or more TX chains and/or one or more RX chains. In an example, the UE may trigger a PHR associated with (e.g., for and/or to) the first network in response to change of (usage of) one or more TX/RX chains of the UE (and/or when the usage of one or more TX/RX chains changes). The change of (usage of) the one or more TX/RX chains may be associated with the UE performing a RRC connection establishment and/or a RRC connection resume to the second network. The change of (usage of) the one or more TX/RX chains may be associated with the UE entering RRC connected state in the second network.

Alternatively and/or additionally, the UE may not trigger a PHR for the first network in response to the change of (usage of) the one or more TX/RX chains (and/or when the usage of the one or more TX/RX chains changes) if the change of (usage of) the one or more TX/RX chains is not associated with (e.g., is not based on and/or due to) the UE entering RRC connected state in the second network.

The change of (usage of) the one or more TX/RX chains may correspond to one or more TX/RX chains being switched to a second SIM card associated with the second network and/or one or more TX/RX chains being switched to initiate and/or perform communication with the second network. Alternatively and/or additionally, the change of (usage of) the one or more TX/RX chains may correspond to one or more TX/RX chains being switched to a first SIM card associated with the first network and/or and/or one or more TX/RX chains being switched to initiate and/or perform communication with the first network.

Alternatively and/or additionally, a PHR may be triggered when a SCell and/or SCG is activated (in response to a change of the second network, for example). In an example, the UE may trigger a PHR associated with (e.g., for and/or to) the first network in response to an addition and/or configuration (e.g., reconfiguration) of a SCG associated with the first network (and/or the PHR may be triggered when the SCG is configured and/or added). The UE may trigger a PHR to the first network in response to activation, addition and/or configuration (e.g., reconfiguration) of one or more SCells associated with the first network (and/or when the one or more SCells are activated and/or reconfigured). The addition, activation and/or configuration (e.g., reconfiguration) of the SCG and/or the one or more SCells may be associated with the UE performing a RRC connection release to the second network. Alternatively and/or additionally, the UE may not trigger a PHR to the first network in response to addition, activation and/or configuration (e.g., reconfiguration) of a SCG and/or one or more SCells (and/or when SCG and/or one or more SCells are configured, activated and/or added) if (and/or when) the addition, the activation and/or the configuration (e.g., reconfiguration) of the SCG and/or the one or more SCells is not associated with RRC connection state change or TX/RX chain switch associated with the second network and/or a second SIM card (e.g., the second SIM card is different from a first SIM card associated with the first network).

Alternatively and/or additionally, the UE may trigger a PHR associated with (e.g., for and/or to) the first network in response to (and/or when) transmitting a capability change information to the first network. The capability change information may indicate a change (e.g., release, addition, de-configuration, activation and/or deactivation) of a SCG, one or more SCells, and/or one or more configured resources associated with the first network. The UE may transmit the capability change information in response to (and/or when) determining (and/or being indicated, such as instructed by a network) to establish or release a RRC connection with the second network.

Alternatively and/or additionally, the UE may trigger a PHR associated with (e.g., for and/or to) the first network in response to (and/or when) receiving a confirmation message from the first network. The confirmation message may be associated with the capability change information transmitted by the UE. The confirmation message may indicate reconfiguration, activation, deactivation, release, and/or addition of a SCG, one or more SCells, and/or one or more configured resources associated with the first network. Alternatively and/or additionally, the UE may determine whether to trigger the PHR based on content of the confirmation message. For example, the UE may trigger the PHR if (and/or when) the confirmation message indicates a positive acknowledgement (and/or agreement) of the capability change information. Alternatively and/or additionally, the UE may not trigger the PHR in response to receiving (and/or when receiving) the confirmation message if (and/or when) the confirmation message indicates a negative acknowledgment, disagreement, and/or unsuccessful reception of the capability change information.

Alternatively and/or additionally, the UE may trigger a PHR associated with (e.g., for and/or to) the first network in response to (and/or when) receiving a reconfiguration message. The reconfiguration message may be associated with (e.g., transmitted in response to) capability change information. The reconfiguration message may indicate reconfiguration, activation, deactivation, release, and/or addition of a SCG, one or more SCells and/or one or more configured resources associated with the first network. In some examples, the UE may not trigger a PHR in response to receiving (and/or when receiving) a reconfiguration message if (and/or when) the reconfiguration message is not associated with a change of TX/RX chains and/or RRC connection states associated with the second network.

Alternatively and/or additionally, the UE may trigger a PHR associated with (e.g., for and/or to) the first network in response to (and/or when) transmitting a reconfiguration complete message. The reconfiguration complete message may be associated with (e.g., transmitted in response to) the reconfiguration message. The reconfiguration complete message may indicate reconfiguration, activation, deactivation, release and/or addition of SCG, one or more SCells and/or one or more configured resources associated with the first network. Alternatively and/or additionally, the reconfiguration complete message may indicate an acknowledgement associated with the reconfiguration message. In some examples, the UE may not trigger a PHR in response to (and/or when) transmitting a reconfiguration complete message if (and/or when) the reconfiguration complete message is not associated with (e.g., is not transmitted based on and/or due to) a change of TX/RX chains and/or RRC connection states associated with the second network.

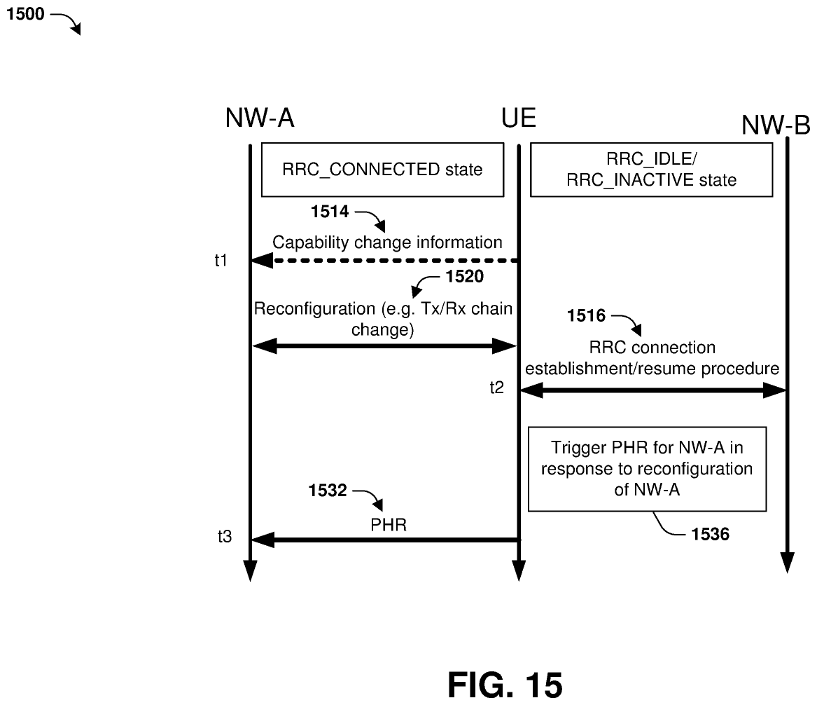

FIG. 15 illustrates an example scenario 1500 associated with a UE, a first network, NW-A, and/or a second network, NW-B. Before timing t1, the UE may operate in RRC connected state in NW-A (via a first SIM card, for example), and does not operate in RRC connected state (e.g., the UE operates in RRC inactive or RRC idle state) in NW-B (via a second SIM card, for example). The UE may determine to establish RRC connection with the NW-B. The UE may transmit a capability change information 1514 to the NW-A at timing t1. The capability change information 1514 may indicate a preference of change (e.g., release) of SCG, SCell, and/or configured resources associated with the NW-A (e.g., the capability change information 1514 may be indicative of a SCG, a SCell and/or one or more configured resources that the UE (i) currently uses for communication with the NW-A and/or (ii) plans and/or prefers to release, deactivate and/or cease using for communication with the NW-A). The NW-A, in response to the capability change information 1514, may transmit a reconfiguration message to the UE. The reconfiguration message may indicate a TX/RX chain change and/or resource deactivation (associated with RRC connection with the NW-B). Alternatively and/or additionally, the reconfiguration message may comprise a parameter and/or flag indicating a cause of the change in TX/RX chain and/or resources. In some examples, a reconfiguration 1520 may be performed based on the reconfiguration message. The reconfiguration may comprise changing (e.g., switching) a TX/RX chain (e.g., changing a TX chain and/or an RX chain) indicated by the reconfiguration message and/or deactivating one or more resources indicated by the reconfiguration message. The UE may initiate and/or perform RRC connection procedure 1516 (e.g., RRC connection establishment procedure and/or RRC connection resume procedure) to the NW-B in response to (and/or after) receiving the reconfiguration message and/or performing the reconfiguration 1520. The UE may trigger 1536 a PHR for NW-A in response to the reconfiguration message and/or performing the reconfiguration 1520. Alternatively and/or additionally, the triggering 1536 of the PHR and/or transmission of power information 1532 (e.g., a power headroom report) in response to the triggering 1536 of the PHR may be before or after initiation and/or completion of the RRC connection procedure to the NW-B.

Alternatively and/or additionally, the UE may trigger a PHR associated with (e.g., for and/or to) the first network in response to a pathloss associated with at least one Serving Cell (e.g., at least one activated Serving Cell) associated with the second network changing by over a first threshold (e.g., a first threshold pathloss change) since a most recent PHR transmission (e.g., a most recent PHR transmission to the first network). Alternatively and/or additionally, the UE may trigger the PHR associated with (e.g., for and/or to) the first network when a pathloss associated with at least one Serving Cell (e.g., at least one activated Serving Cell) associated with the second network changes by over the first threshold since a most recent PHR transmission (e.g., a most recent PHR transmission to the first network). In some examples, an active DL BWP of the at least one Serving Cell may not be a dormant BWP. In some examples, the UE may trigger the PHR when (and/or if) a timer (e.g., phr-ProhibitTimer) expires, is expired and/or is not running. In some examples, the UE may not trigger the PHR when (and/or if) the timer is running and/or is not expired

Alternatively and/or additionally, the UE may trigger a PHR associated with (e.g., for and/or to) the second network in response to a pathloss associated with at least one Serving Cell (e.g., at least one activated Serving Cell) associated with the first network changing by over a second threshold (e.g., a second threshold pathloss change) since a most recent PHR transmission (e.g., a most recent PHR transmission to the second network). Alternatively and/or additionally, the UE may trigger the PHR associated with (e.g., for and/or to) the second network when a pathloss associated with at least one Serving Cell (e.g., at least one activated Serving Cell) associated with the second network changes by over the second threshold since a most recent PHR transmission (e.g., a most recent PHR transmission to the second network). In some examples, an active DL BWP of the at least one Serving Cell may not be a dormant BWP. In some examples, the UE may trigger the PHR when (and/or if) a timer (e.g., phr-ProhibitTimer) expires, is expired and/or is not running. In some examples, the UE may not trigger the PHR when (and/or if) the timer is running and/or is not expired

The threshold (e.g., the first threshold and/or the second threshold) may be configured by the first network and/or the second network (e.g., the first threshold may be configured by the first network and/or the second threshold may be configured by the second network).

Alternatively and/or additionally, the UE may trigger a PHR associated with a first Cell Group (CG) of the first network in response to a pathloss associated with at least one Serving Cell (e.g., at least one activated Serving Cell) associated with a second CG of the first network changing by over a threshold (e.g., a threshold pathloss change) since a most recent PHR transmission (to the first network, for example). Alternatively and/or additionally, the UE may trigger a PHR associated with the first CG of the first network in response to a pathloss associated with at least one Serving Cell (e.g., at least one activated Serving Cell) associated with the second CG of the first network changing by over the threshold since the most recent PHR transmission (to the first network, for example). In some examples, an active DL BWP of the at least one Serving Cell may not be a dormant BWP. In some examples, the UE may trigger the PHR when (and/or if) a timer (e.g., phr-ProhibitTimer) expires, is expired and/or is not running. In some examples, the UE may not trigger the PHR when (and/or if) the timer is running and/or has not expired. The threshold may be configured by the first network and/or the second network.

Alternatively and/or additionally, the UE may trigger a PHR associated with a first CG of the second network in response to a pathloss associated with at least one Serving Cell (e.g., at least one activated Serving Cell) associated with a second CG of the second network changing by over a threshold change since a most recent PHR transmission (to the second network, for example). Alternatively and/or additionally, the UE may trigger a PHR associated with the first CG of the second network in response to a pathloss associated with at least one Serving Cell (e.g., at least one activated Serving Cell) associated with the second CG of the second network changing by over the threshold change since the most recent PHR transmission (to the second network, for example). In some examples, an active DL BWP of the at least one Serving Cell may not be a dormant BWP. In some examples, the UE may trigger the PHR when (and/or if) a timer (e.g., phr-ProhibitTimer) expires, is expired and/or is not running. In some examples, the UE may not trigger the PHR when (and/or if) the timer is running and/or has not expired. The threshold may be configured by the first network and/or the second network.

Alternatively and/or additionally, the UE may trigger a PHR associated with (e.g., for and/or to) the first network in response to an activation of a SCell associated with the second network (and/or when a SCell associated with the second network is activated). The SCell may be configured with uplink. In some examples, the UE may not trigger the PHR if the SCell is not configured with UL. A first active DL BWP of the SCell may not be a dormant BWP. In some examples, the UE may not trigger the PHR if the first active DL BWP of the SCell is set to dormant BWP.

The UE may trigger a PHR associated with (e.g., for and/or to) the second network in response to an activation of a SCell associated with the first network (and/or when a SCell associated with the first network is activated). The SCell may be configured with UL. In some examples, the UE may not trigger the PHR if the SCell is not configured with UL. A first active DL BWP of the SCell may not be a dormant BWP. In some examples, the UE may not trigger the PHR if the first active DL BWP of the SCell is set to dormant BWP.

Alternatively and/or additionally, the UE may trigger a PHR associated with a first CG of the first network in response to an activation of a SCell associated with a second CG of the first network (and/or when a SCell associated with the second CG of the first network is activated). The SCell associated with the second CG may be configured with uplink. In some examples, the UE may not trigger the PHR if the SCell associated with the second CG is not configured with UL. A first active DL BWP of the SCell associated with the second CG may not be a dormant BWP. In some examples, the UE may not trigger the PHR if the first active DL BWP of the SCell associated with the second CG is set to dormant BWP.

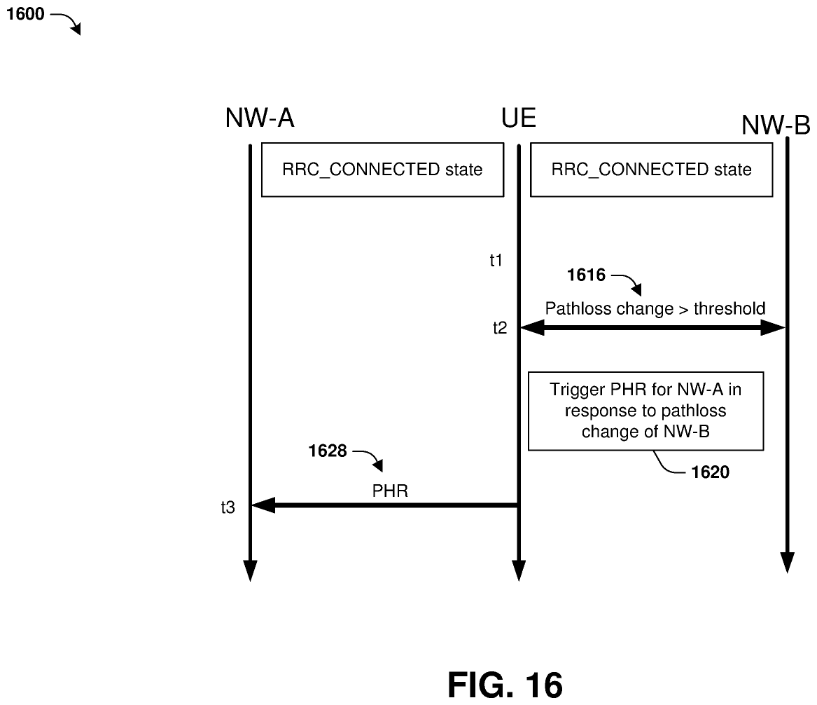

FIG. 16 illustrates an example scenario 1600 associated with a UE, a first network, NW-A, and/or a second network, NW-B. Before timing t1, the UE may operate in RRC connected state in both NW-A (via a first SIM card, for example) and NW-B (via a second SIM card, for example). At timing t2, a pathloss associated with a serving cell of the NW-B may have changed by over a threshold (since a most recent time that a PHR was reported). For example, the UE may determine 1616 that the pathloss change between a pathloss (associated with the serving cell) associated with a most recent time that a PHR was reported (to the NW-A, for example) and a current pathloss (associated with the serving cell) meets (e.g., exceeds) the threshold. The UE may trigger 1620 a PHR to NW-A in response to the pathloss change associated with the NW-B (e.g., the UE may trigger 1620 the PHR to NW-A in response to the determination 1616 that the pathloss change meets the threshold). The UE may report (e.g., transmit) power information 1628 in response to triggering 1620 the PHR.

Alternatively and/or additionally, the UE may trigger a PHR associated with (e.g., for and/or to) the first network in response to an activation of a SCG associated with the second network (and/or when a SCG associated with the second network is activated).

The UE may trigger a PHR associated with (e.g., for and/or to) the second network in response to an activation of a SCG associated with the first network (and/or when a SCG associated with the first network is activated).

Alternatively and/or additionally, the UE may trigger a PHR associated with a Master Cell Group (MCG) of the first network in response to an activation of a SCG of the first network (and/or when the SCG of the first network is activated).

Alternatively and/or additionally, the UE may trigger a PHR associated with (e.g., for and/or to) the first network when (i) the UE has a UL resource for a new transmission (e.g., an initial transmission and/or a transmission that is not a retransmission), and (ii) a required power backoff for an activated Serving Cell of the second network has changed by over than a first threshold (e.g., phr-Tx-PowerFactorChange) since a most recent PHR transmission (to the first network, for example). The activated Serving Cell may be allocated with UL resources for transmission and/or there may be a PUCCH transmission on the activated Serving Cell. In some examples, the UE may trigger the PHR when (and/or if) a timer (e.g., phr-ProhibitTimer) expires, is expired and/or is not running. In some examples, the UE may not trigger the PHR when (and/or if) the timer is running and/or has not expired.

The UE may trigger a PHR associated with (e.g., for and/or to) the second network when (i) the UE has a UL resource for a new transmission (e.g., an initial transmission and/or a transmission that is not a retransmission), and (ii) a required power backoff for an activated Serving Cell of the first network has changed by over a second threshold (e.g., phr-Tx-PowerFactorChange) since a most recent PHR transmission (to the second network, for example). The activated Serving Cell may be allocated with UL resources for transmission and/or there may be a PUCCH transmission on the activated Serving Cell. In some examples, the UE may trigger the PHR when (and/or if) a timer (e.g., phr-ProhibitTimer) expires, is expired and/or is not running. In some examples, the UE may not trigger the PHR when (and/or if) the timer is running and/or has not expired.

Alternatively and/or additionally, the UE may trigger a PHR associated with (e.g., for and/or to) a first CG of the first network when (i) the UE has a UL resource for a new transmission (e.g., an initial transmission and/or a transmission that is not a retransmission), and (ii) a required power backoff for an activated Serving Cell of a second CG of the first network has changed by over a first threshold (e.g., phr-Tx-PowerFactorChange) since a most recent PHR transmission (to the first network, for example). The activated Serving Cell of the second CG may be allocated with UL resources for transmission and/or there may be a PUCCH transmission on the activated Serving Cell. In some examples, the UE may trigger the PHR when (and/or if) a timer (e.g., phr-ProhibitTimer) expires, is expired and/or is not running. In some examples, the UE may not trigger the PHR when (and/or if) the timer is running and/or has not expired.

Alternatively and/or additionally, the UE may trigger a PHR associated with (e.g., for and/or to) the first network when (and/or upon) switching of an activated BWP from dormant BWP to non-dormant DL BWP of a SCell of the second network.

The UE may trigger a PHR associated with (e.g., for and/or to) the second network when (and/or upon) switching of an activated BWP from dormant BWP to non-dormant DL BWP of a SCell of the first network.

With respect to one or more of the embodiments provided in the foregoing description, the SCell may be configured with uplink. In some examples, the UE may not trigger the PHR if the SCell is not configured with uplink.

Alternatively and/or additionally, the UE may trigger a PHR associated with (e.g., for) a first CG of the first network when (and/or upon) switching of an activated BWP from dormant BWP to non-dormant DL BWP of a SCell of a second CG of the first network. The SCell of the second CG may be configured with uplink. In some examples, the UE may not trigger the PHR if the SCell of the second CG is not configured with uplink.

A UE may report power information associated with a second network to a first network. The power information may correspond to a power headroom report. The power information may comprise a power headroom (e.g., a power headroom level), a power backoff and/or a Power Management Maximum Power Reduction (P-MPR) (associated with the second network, for example).

Alternatively and/or additionally, the UE may report power information associated with the first network to the second network. The power information may correspond to a power headroom report. The power information may comprise a power headroom (e.g., a power headroom level), a power backoff and/or a P-MPR (associated with the second network, for example).

The UE may operate in RRC connected state in both the first network and the second network concurrently (e.g., simultaneously). For example, if a PHR procedure determines that (e.g., if the UE performing the PHR procedure determines that) at least one PHR has been triggered and not cancelled for the first network, the UE may determine (e.g., obtain) a power headroom associated with the second network. The UE may determine whether to report (to the first network, for example) power information associated with the second network based on a configuration (e.g., a RRC parameter configured by a network). The power information may correspond to a power headroom report. The power information may comprise a power headroom (e.g., a power headroom level), a power backoff and/or a P-MPR (associated with the second network, for example). Alternatively and/or additionally, the UE may determine whether to report (to the first network, for example) the power information associated with the second network based on a RRC connection state of the second network (e.g., the RRC connection state may correspond to whether the UE is in RRC connected state with the second network or is in RRC idle or RRC inactive state with the second network).

For example, the UE may not report (to the first network, for example) the power information associated with the second network if the UE is in RRC idle or RRC inactive state with the second network. Alternatively and/or additionally, the UE may report, to the first network, power information associated with a PCell of the second network (e.g., based on the UE being in RRC idle or RRC inactive state with the second network, the UE may report, to the first network, power information that is associated with only the PCell of the second network and/or that does not comprise information associated with one or more SCells of the second network). Alternatively and/or additionally, the UE may not report, to the first network, power information associated with one or more SCells of the second network (e.g., the UE may not report power information associated with one or more SCells of the second network based on the UE being in RRC idle or RRC inactive state with the second network). The power information associated with the second network may correspond to a type 4 PH (and/or may be different than type 1 PH, type 2 PH and/or type 3 PH).

Alternatively and/or additionally, the UE may determine whether to report, to the first network, power information associated with the second network (e.g., power information associated with Serving Cells associated with the second network) based on a network configuration (e.g., the network configuration may correspond to a RRC parameter configured by a network). The UE may report power information associated with a PCell of the second network to the first network and/or one, some and/or all Serving Cells of the second network to the first network.

The UE may report power information associated with the second network to the first network via a MAC CE. The power information may correspond to a power headroom report. The power information may comprise a power headroom (e.g., a power headroom level), a power backoff and/or a P-MPR (associated with the second network, for example). The MAC CE may be indicative of (e.g., may comprise) a power headroom (e.g., a power headroom level) of one or more Serving Cells associated with either the first network or the second network. The MAC CE may be indicative of (e.g., may comprise) a flag (e.g., a bit field) for a reported power headroom (e.g., a reported power headroom level) indicating a network associated with the reported power headroom (e.g., the network, to which the reported power headroom indicated by the MAC CE is applicable, may be determined based on the flag). Alternatively and/or additionally, the MAC CE may indicate (e.g., implicitly indicate) whether a reported power headroom is associated with the first network or the second network. For example, the UE may include, in the MAC CE, power information (e.g., at least one of a power headroom, a real format indication, a reference format indication, etc.) associated with the first network before and/or above power information associated with the second network (e.g., the power information associated with the first network may be included in first x rows of the MAC CE, wherein x may be smaller than or equal to number of serving cells associated with the first network, and/or the power information associated with the second network may be included in one or more rows after and/or below the first x rows).

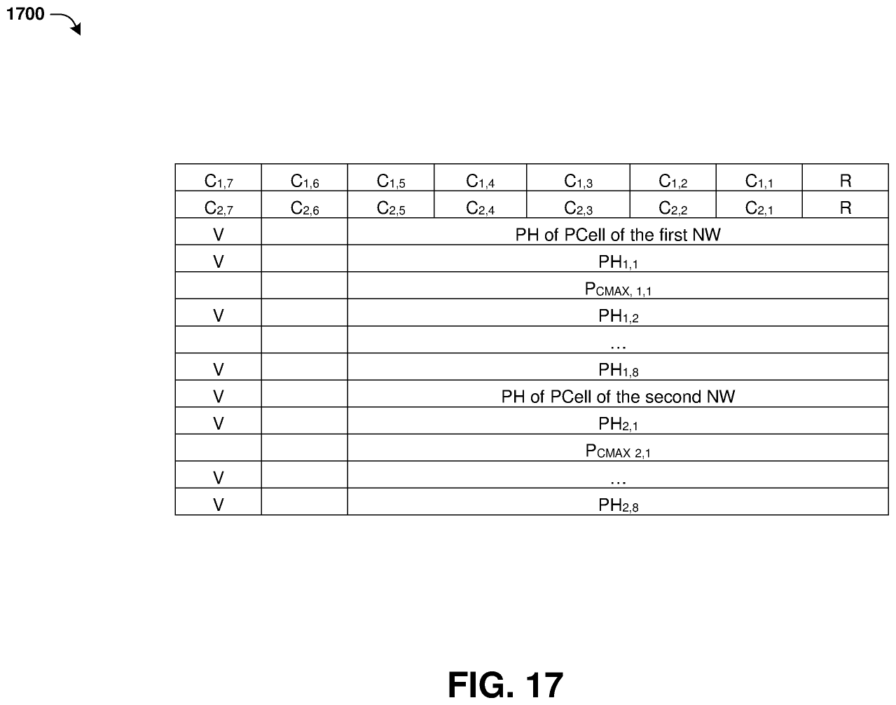

FIG. 17 illustrates a first example 1700 of a MAC CE (e.g., a PHR MAC CE) for reporting power information (e.g., power headroom) for the first network and/or the second network. The MAC CE may comprise multiple (e.g., two) sets of bit fields (e.g., a first set of bit fields C_{1,1}, C_{1,2} . . . C_{1,7} and a second set of bit fields C_{2,1}, C_{2,2}, . . . C_{2,7}). Each bit of the first set of bit fields may indicate presence of a PH field for a Serving Cell (e.g., a SCell) associated with the first network. For example, C_{1,1} being set to 1 may indicate that a PH field for Serving Cell, with ServingCellIndex 1, of the first network is reported (in the MAC CE, for example). For example, C_{1,4} being set to 0 may indicate that a PH field for a Serving Cell, with ServingCellIndex 4, of the first network is not reported (in the MAC CE, for example). Each bit of the second set of bit fields may indicate presence of a PH field for a Serving Cell associated with the second network. For example, C_{2,1} being set to 1 may indicate that a PH field for a Serving Cell, with ServingCellIndex 1, of the second network is reported (in the MAC CE, for example). For example, C_{2,4} being set to 0 may indicate that a PH field for a Serving Cell, with ServingCellIndex 4, of the second network is not reported (in the MAC CE, for example). A PH field may indicate a power headroom (e.g., a power headroom level) associated with a corresponding Serving Cell. For example, PH_{1,1} may indicate a power headroom (e.g., a power headroom level) associated with the Serving Cell, with ServingCellIndex 1, of the first network. For example, PH_{2,1} may indicate a power headroom (e.g., a power headroom level) associated with the Serving Cell, with ServingCellIndex 1, of the second network. The MAC CE may comprise a V field (e.g., shown as including the letter “V” in FIG. 17) for each PH field indicating whether a corresponding power headroom is calculated based on a real transmission or a reference transmission. The MAC CE may include (e.g., always include) a power headroom of a PCell of the first network. Alternatively and/or additionally, the MAC CE may include a power headroom of a PCell of the second network.

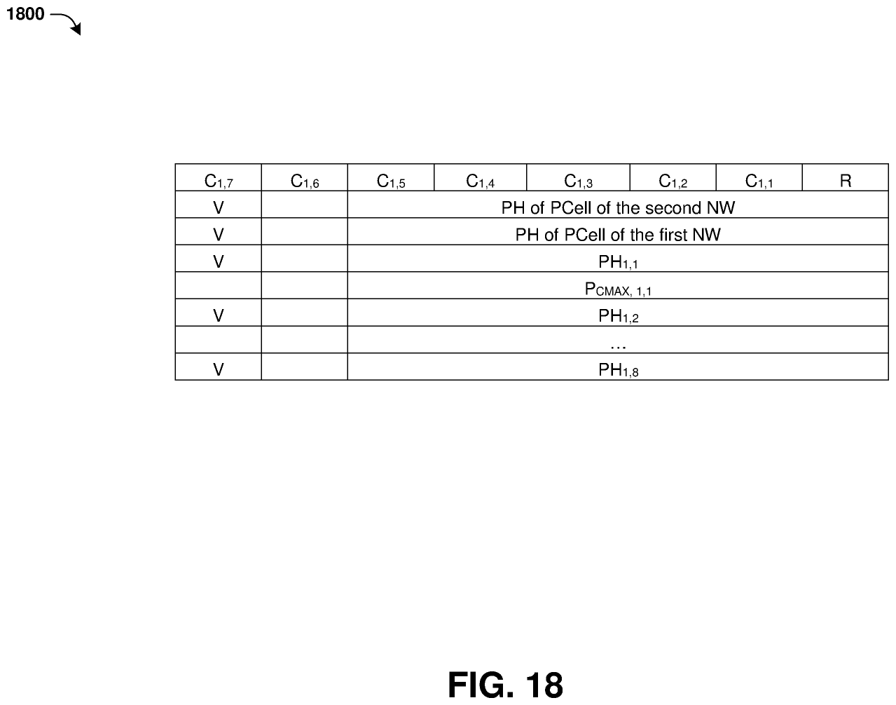

FIG. 18 illustrates a second example 1800 of a MAC CE (e.g., a PHR MAC CE) for reporting power information (e.g., power headroom) for the first network and/or the second network. The MAC CE shown in FIG. 18 may be used for reporting a power headroom to the first network. The UE may report a power headroom associated with the PCell of the second network (e.g., the power headroom associated with the PCell of the second network may be the only power headroom associated with the second network that is reported by the UE and/or the MAC CE). The UE may not report a power headroom associated with one or more other Serving Cells (e.g., one or more SCells) (other than the PCell) of the second network. The MAC CE may indicate (e.g., implicitly indicate) which power headroom is associated with the second network (e.g., the power headroom of the second network may be included and/or arranged in the MAC CE before other power headrooms).

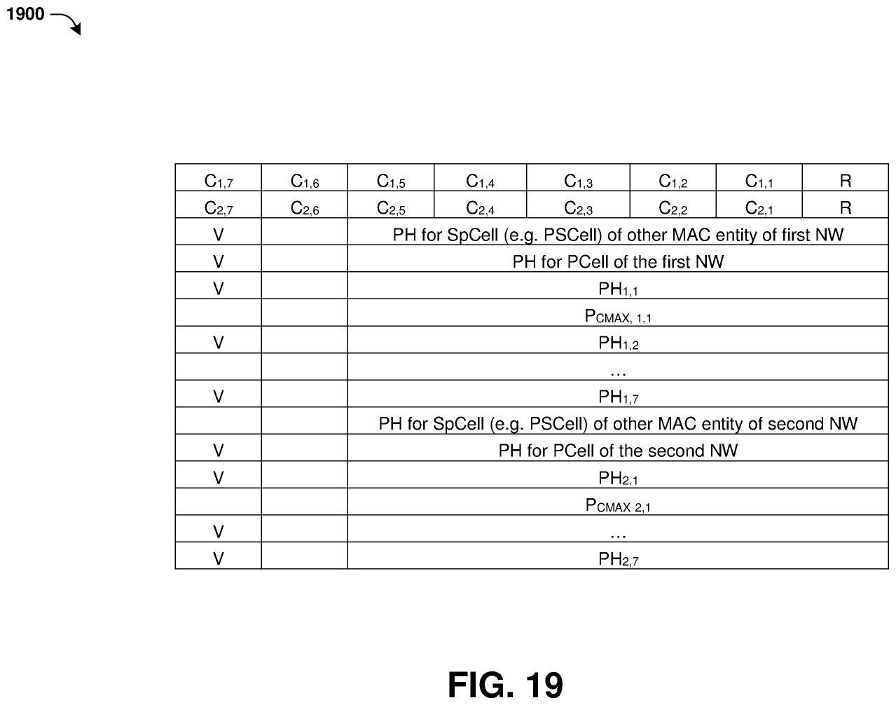

FIG. 19 illustrates a second example 1900 of a MAC CE (e.g., a PHR MAC CE) for reporting power information (e.g., power headroom) for the first network and/or the second network. The MAC CE may comprise a field indicating a first power headroom (e.g., a power headroom level) associated with a Special Cell (SpCell) (e.g., a Primary SCG Cell (PSCell)) of a first MAC entity of the first network. The MAC CE may comprise a field indicating a second power headroom (e.g., a power headroom level) associated with a PCell of the first network. A second MAC entity (of the first network) associated with the PCell of the first network may be different than the first MAC entity of the first network. The MAC CE may comprise (e.g., in addition to the field indicating the power headroom associated with the SpCell of the MAC entity) a field indicating a third power headroom (e.g., a power headroom level) associated with a SpCell (e.g., PSCell) of a first MAC entity of the second network. The MAC CE may comprise a field indicating a second power headroom (e.g., a power headroom level) associated with a PCell of the second network. A second MAC entity (of the second network) associated with the PCell of the second network may be different than the first MAC entity of the second network. The UE may determine, based on a network configuration (e.g., the network configuration may correspond to a RRC parameter configured by a network), whether to report (e.g., include in the MAC CE) the first power headroom (associated with the SpCell of the first MAC entity of the first network) and/or the second power headroom (associated with the SpCell of the first MAC entity of the second network) in the MAC CE.

In some examples, the UE may report power information associated with the first network and the second network in separate MAC CEs (e.g., the UE may report power information associated with the second network in a MAC CE separate from a MAC CE associated with power information of the first network). For example, the UE may generate two MAC CEs, each for a network, in response to a triggered PHR (e.g., the UE may generate the two MAC CEs when a PHR is triggered and not cancelled). A first MAC CE of the two MAC CEs may comprise power information associated with the first network and a second MAC CE of the two MAC CEs may comprise power information associated with the second network. The two MAC CEs may be associated with different logical channel IDs (LCIDs). Alternatively and/or additionally, the first MAC CE may comprise a flag (e.g., a bit field) indicating that a power headroom reported by the first MAC CE is associated with the first network, and/or the second MAC CE may comprise a flag (e.g., a bit field) indicating that a power headroom reported by the second MAC CE is associated with the second network. For example, the UE may set a bit field in the first MAC CE to ‘0’ indicating that the power information indicated in the first MAC CE is associated with the first network, and/or the UE may set a bit field in the second MAC CE to ‘1’ indicating that the power information indicated in the second MAC CE is associated with the second network. Each of the two MAC CEs may comprise a P_{CMAX} field of a serving cell indicating a nominal UE transmit power (e.g., a nominal UE maximum transmit power) associated with the corresponding serving cell. For example, PCMAX1,1 may indicate a transmit power level associated with a serving cell of ServingCellIndex 1 associated with the first network.

With respect to one or more embodiments herein, such as one or more techniques, devices, concepts, methods, example scenarios and/or alternatives described above, the PHR associated with (e.g., for and/or to) the first network may be triggered when the UE does not operate with Carrier Aggregation (CA) and/or Dual Connectivity (DC) for the first network. For example, one, some and/or all SCells of the first network may be deactivated and/or released (when the PHR associated with the first network is triggered). Alternatively and/or additionally, a SCG of the first network may be deactivated and/or released (when the PHR associated with the first network is triggered). In some examples, the UE does not operate with CA and/or DC for the first network due to the UE entering RRC connected state in the second network (e.g., the UE may cease operating with CA and/or DC for the first network in response to entering RRC connected state in the second network).

With respect to one or more embodiments herein, in some examples, the UE may operate in RRC connected state in the first network (via a first SIM card) and the second network (via a second SIM card) concurrently (e.g., simultaneously).

With respect to one or more embodiments herein, in some examples, the first network may be associated with a first Public Land Mobile Network (PLMN). The second network may be associated with a second PLMN.

With respect to one or more embodiments herein, in some examples, the threshold may be configured by a network (e.g., the first network or the second network). For example, the first threshold may be configured by the second network. The second threshold may be configured by the first network.

With respect to one or more embodiments herein, in some examples, the UE may cancel the triggered PHR in response to (and/or when) releasing an RRC connection with the second network. Alternatively and/or additionally, the UE may cancel the triggered PHR in response to (and/or when) releasing an RRC connection with the first network.

With respect to one or more embodiments herein, in some examples, the maximum transmit power may be indicated in a P_{CMAX} (e.g., P_{CMAX,f,c}) field in a PHR MAC CE.

With respect to one or more embodiments herein, in some examples, for a triggered PHR associated with (e.g., for and/or to) a network, the UE may transmit, in response to the triggered PHR, a PHR MAC CE to the network. For example, the UE may transmit the PHR MAC CE to the network in response to triggering the PHR associated with (e.g., for and/or to) the network. The PHR MAC CE may indicate one or more power headrooms of one or more Serving Cells associated with the network. Alternatively and/or additionally, a UE triggering a PHR associated with (e.g., for and/or to) the network may imply that the UE may generate a PHR MAC CE (and/or other message) and/or transmit, to the network, the PHR MAC CE (and/or the other message) indicating one or more PHs (e.g., one or more power headrooms and/or power headroom levels) associated with one or more Serving Cells of the network when (and/or if) the PHR is not cancelled. For example, in an embodiment in which the UE triggers a PHR associated with the network, when (and/or if) the PHR is not cancelled, the UE may generate a message (e.g., a PHR MAC CE and/or other type of message) indicating one or more PHs associated with one or more Serving Cells of the network, and/or the UE may transmit the message to the network.

With respect to one or more embodiments herein, in some examples, the power headroom (e.g., indicated by a PHR MAC CE and/or other type of message transmitted in response to triggering the PHR) may be Type 1 power headroom, Type 2 power headroom, Type 3 power headroom and/or Type 4 power headroom.

With respect to one or more embodiments herein, in some examples, the PHR may correspond to a PHR procedure and/or may indicate (e.g., report) power backoff to meet one or more Maximum Permissible Exposure (MPE) requirements for a Serving Cell (of the first network, for example).

With respect to one or more embodiments herein, in some examples, the UE may transmit power information (e.g., PHR information) in response to the triggered PHR (e.g., in response to triggering the PHR). The power information may indicate a change of transmit power (e.g., a change of nominal and/or maximum transmit power) associated with a Serving Cell or a network. The power information may indicate a P-MPR and/or a change of the P-MPR (e.g., the P-MPR may change in order to meet the requirements of MPE) associated with a Serving Cell and/or a network. The power information may be transmitted via a PHR MAC CE.

With respect to one or more embodiments herein, in some examples, the capability change information may comprise assistance information (e.g., UE assistance information). For example, the assistance information may be from the UE (e.g., transmitted by the UE) to a network.

With respect to one or more embodiments herein, in some examples, the capability change information may indicate a preference associated with a capability of the UE.

With respect to one or more embodiments herein, in some examples, the capability change information may indicate a reduced capability associated with a network, one or more resources associated with the network and/or one or more retuned TX/RX chains associated with the network.

With respect to one or more embodiments herein, in some examples, the UE may trigger transmission of the capability change information when (and/or if) the UE determines to perform concurrent (e.g., simultaneous) connection with two networks (e.g., enter RRC connected state in two networks concurrently).

With respect to one or more embodiments herein, in some examples, the capability change information (e.g., the capability change information 1110, the capability change information 1314, the capability change information 1414 and/or the capability change information 1514) may be transmitted via a MAC CE or a RRC message.

With respect to one or more embodiments herein, in some examples, the capability change information (e.g., the capability change information 1110, the capability change information 1314, the capability change information 1414 and/or the capability change information 1514) may be associated with (e.g., may indicate and/or may be based on) a capability restriction associated with the first network (e.g., NW-A). For example, the capability change information may indicate release of one or more serving cells and/or a SCG associated with the first network (e.g., NW-A). Alternatively and/or additionally, the capability change information may indicate deactivation of one or more serving cells, a SCG and/or one or more resources (e.g., one or more configured resources) associated with the first network (e.g., NW-A). The one or more resources may comprise a configured UL grant, a DL assignment and/or one or more DL and/or UL resources.

With respect to one or more embodiments herein, in some examples, the confirmation message (e.g., the confirmation message 1116) may indicate a positive acknowledgment or a negative acknowledgement (associated with the capability change information). The positive acknowledgement of the confirmation message may indicate (e.g., imply) that the network (e.g., the first network, such as NW-A) agrees (e.g., confirms) and/or acknowledges the capability change indicated by the capability change information. The negative acknowledgement of the confirmation message may indicate (e.g., imply) that the network (e.g., the first network, such as NW-A) does not agree (e.g., does not confirm and/or rejects) and/or does not acknowledge the capability change indicated in the capability change information. The UE may release and/or deactivate one or more serving cells, a SCG and/or one or more configured resources (indicated by the capability change information, for example) associated with the network (e.g., the first network, such as NW-A) in response to the confirmation message (e.g., the UE may release and/or deactivate one or more serving cells, a SCG and/or one or more configured resources if the confirmation message indicates a positive acknowledgement). The confirmation message may not indicate (e.g., may not include) the one or more serving cells, the SCG and/or the one or more configured resources (associated with the network) to be released and/or deactivated.

With respect to one or more embodiments herein, in some examples, the confirmation message (e.g., the confirmation message 1116) may be the reconfiguration message.

Alternatively and/or additionally, the confirmation message (e.g., the confirmation message 1116) may indicate successful reception associated with the capability change information (e.g., the confirmation message may indicate that the network successfully received the capability change information).

With respect to one or more embodiments herein, in some examples, the reconfiguration message may be a RRC reconfiguration message.

With respect to one or more embodiments herein, in some examples, the reconfiguration message may indicate release, de-configuration and/or reconfiguration of one or more of serving cells, a SCG and/or one or more resources (e.g., one or more configured resources) associated with the first network. The one or more serving cells, the SCG and/or the one or more resources may be associated with (e.g., indicated by) the capability change information. For example, the reconfiguration message may instruct the UE to release, de-configure and/or reconfigure the one or more serving cells, the SCG and/or the one or more resources indicated by the capability change information.

With respect to one or more embodiments herein, in some examples, the reconfiguration message may be a MAC CE.

With respect to one or more embodiments herein, in some examples, the reconfiguration message may indicate deactivation of one or more serving cells associated with the first network. The one or more serving cells may be associated with (e.g., indicated by) the capability change information. For example, the reconfiguration message may instruct the UE to deactivate the one or more serving cells indicated by the capability change information.

With respect to one or more embodiments herein, in some examples, the one or more cells (e.g., the one or more cells indicated by the capability change information, such as the capability change information 1110) may be one or more serving cells.

With respect to one or more embodiments herein, in some examples, the one or more serving cells may be one or more SCells.

With respect to one or more embodiments herein, in some examples, the CG may be SCG (e.g., the first CG may be a first SCG and/or the second CG may be a second SCG).

With respect to one or more embodiments herein, in some examples, the reconfiguration message may indicate a change of one or more TX/RX chains.

With respect to one or more embodiments herein, in some examples, the reconfiguration message may indicate deactivation of one or more resources associated with a network.

With respect to one or more embodiments herein, in some examples, the UE may perform communication with a first network (e.g., NW-A) via one or more TX chains and/or one or more RX chains. The UE may reduce the number of TX chains and/or the number of RX chains with the first network in response to performing concurrent (e.g., simultaneous) connection with a second network (via a second SIM card other than a first SIM card the UE uses to connect with the first network). The number of TX chains may correspond to a number of TX chains that the UE uses to communicate with (e.g., transmit UL signals to) the first network. The number of RX chains may correspond to a number of RX chains that the UE uses to communicate with (e.g., receive DL signals from) the first network. Once the UE enters into RRC connected state associated with the second network (e.g., NW-B), one or more TX chains (that the UE uses to communicate with the first network, for example) and/or one or more RX chains (that the UE uses to communicate with the first network, for example) may need to be switched to a different network (e.g., the second network, such as NW-B).

With respect to one or more embodiments herein, in some examples, the first network may be a LTE or NR network. The second network may be a LTE or NR network.

With respect to one or more embodiments herein, in some examples, the first network (e.g., NW-A) may be associated with the a first Universal Subscriber Identity Module (USIM) of the UE. The second network (e.g., NW-B) may be associated with the a second USIM of the UE. The UE may be equipped with multiple USIMs including the first USIM and the second USIM.

With respect to one or more embodiments herein, in some examples, the second network is associated with a second USIM (e.g., a second SIM card) different from a first USIM (e.g., a first SIM card) associated with the first network.

With respect to one or more embodiments herein, in some examples, the UE may perform UL and/or DL communication with one or more networks via one or more TX/RX chains. The one or more TX/RX chains may be associated with one or more USIMs (e.g., one or more SIM cards).

With respect to one or more embodiments herein, in some examples, the UE performing the RRC connection establishment may comprise the UE initiating the RRC connection establishment procedure (in the RRC layer, for example) and/or initiating a RRC connection establishment-related procedure (e.g., initiates a random access procedure in a MAC layer).

With respect to one or more embodiments herein, in some examples, the UE performing the RRC connection resume may comprise the UE initiating the RRC connection resume procedure (in the RRC layer, for example) and/or initiating a RRC connection resume-related procedure (e.g., initiates a random access procedure in a MAC layer).

With respect to one or more embodiments herein, in some examples, the UE performing the RRC connection release may comprise the UE initiating the RRC connection release procedure (in the RRC layer, for example) and/or initiating RRC connection release-related procedure.

With respect to one or more embodiments herein, in some examples, the second network is not associated with (e.g., does not comprise and/or is not) a SCG associated with the first network.

With respect to one or more embodiments herein, in some examples, the second network is associated with a first MCG and the first network is associated with a second MCG.

With respect to one or more embodiments herein, in some examples, the UE performs communication with a MCG associated with the first network and a SCG associated with the first network via a same USIM (e.g., SIM card) with the first network (e.g., the UE uses the same SIM card to perform communication with the MCG associated with the first network and to perform communication with the SCG associated with the first network). The UE may perform communication with the first network via a first MAC entity and a second MAC entity. The first MAC entity and the second MAC entity may be associated with a first USIM (e.g., both the first MAC entity and the second MAC entity are associated with the same first USIM, such as a first SIM card). The UE may perform communication with the second network via a third MAC entity and a fourth MAC entity. The third MAC entity and the fourth MAC entity may be associated with a second USIM (e.g., both the third MAC entity and the fourth MAC entity are associated with the same second USIM, such as a second SIM card).

With respect to one or more embodiments herein, in some examples, the first MAC entity and the third MAC entity may be associated with different protocol stacks (e.g., different protocol stacks of the UE).

With respect to one or more embodiments herein, in some examples, the first network may be associated with (e.g., may have) a first PCell. The second network may be associated with (e.g., may have) a second PCell (e.g., the second PCell may not be PSCell).

With respect to one or more embodiments herein, in some examples, the first MAC entity associated with the first network may be associated with (e.g., may include) the first PCell. The third MAC entity associated with the second network may be associated with (e.g., may include) the second PCell.

With respect to one or more embodiments herein, in some examples, the RRC connection establishment may be a RRC connection establishment procedure.

With respect to one or more embodiments herein, in some examples, the RRC connection resume may be a RRC connection resume procedure.

With respect to one or more embodiments herein, in some examples, a SIM (e.g., a SIM card) may be a USIM (e.g., a USIM card).

With respect to one or more embodiments herein, in some examples, RRC connected state may correspond to RRC_CONNECTED STATE.

With respect to one or more embodiments herein, in some examples, RRC inactive state may correspond to RRC_INACTIVE STATE.

With respect to one or more embodiments herein, in some examples, RRC idle state may correspond to RRC_IDLE STATE.

With respect to one or more embodiments herein, in some examples, the PHR transmission (e.g., the most recent PHR transmission) may correspond to a transmission of a power headroom report (e.g., power information, PHR information, etc.), such as a PHR MAC CE. For example, the most recent PHR transmission may correspond to a most recent transmission of a power headroom report by the UE. Alternatively and/or additionally, the most recent PHR transmission may correspond to a most recent transmission of a power headroom report (by the UE) to a particular network (e.g., the first network, the second network, etc.).

One, some and/or all of the foregoing examples, concepts, techniques and/or embodiments can be formed and/or combined to a new embodiment.

Various techniques, embodiments, methods and/or alternatives of the present disclosure may be performed independently and/or separately from one another. Alternatively and/or additionally, various techniques, embodiments, methods and/or alternatives of the present disclosure may be combined and/or implemented using a single system. Alternatively and/or additionally, various techniques, embodiments, methods and/or alternatives of the present disclosure may be implemented concurrently and/or simultaneously.

To enhance 3GPP specification for wireless communication in accordance with some embodiments herein, Enhancements 1-5 are provided herein. Enhancements 1-5 are reflective of implementation in accordance with some embodiments herein, and comprise modifications to various sections of 3GPP specifications. According to some embodiments, one, some and/or all of Enhancements 1-5 may be implemented and/or a portion of one, some and/or all of Enhancements 1-5 may be implemented. Enhancements 1-5 comprises modifications to Section 5.4.6 (entitled “Power Headroom Reporting”) of 3GPP 38.321 v16.6.0.

In Enhancement 1, addition 1 is made to Section 5.4.6 of 3GPP 38.321 v16.6.0. To distinguish addition 1 from what is originally included in Section 5.4.6 of 3GPP 38.321 v16.6.0, addition 1 is in bold, and is preceded by the term “ADDITION 1 STARTS:” and followed by the term “ADDITION 1 ENDS”.

Enhancement 1:
1> if the Power Headroom reporting procedure determines that at least one PHR has been triggered and not cancelled; and
   [ . . . ]
   Addition 1 Starts:
   3> if phr-Type4OtherCell with value true is configured:
      4> obtain the value of the (Type 4) power headroom for the SpCell of the other network;
      4> if phr-ModeOtherNW is set to real by upper layers:
         6> obtain the value for the corresponding P_{CMAX,f,c} field for the SpCell of the other network from the physical layer.
   Addition 1 Ends
      [ . . . ]

In Enhancement 2, addition 2 is made to Section 5.4.6 of 3GPP 38.321 v16.6.0. To distinguish addition 2 from what is originally included in Section 5.4.6 of 3GPP 38.321 v16.6.0, addition 2 is in bold, and is preceded by the term “ADDITION 2 STARTS:” and followed by the term “ADDITION 2 ENDS”.

Enhancement 2:

A Power Headroom Report (PHR) shall be triggered if any of the following events occur:
Addition 2 Starts:
phr-ProhibitTimer expires or has expired and the path loss has changed more than phr-Tx-PowerFactorChange dB for at least one activated Serving Cell of another NW of which the active DL BWP is not dormant BWP which is used as a pathloss reference since the most recent PHR transmission in this MAC entity when the MAC entity has UL resources for new transmission;
Addition 2 Ends
   [ . . . ]

In Enhancement 3, addition 3 is made to Section 5.4.6 of 3GPP 38.321 v16.6.0. To distinguish addition 3 from what is originally included in Section 5.4.6 of 3GPP 38.321 v16.6.0, addition 3 is in bold, and is preceded by the term “ADDITION 3 STARTS:” and followed by the term “ADDITION 3 ENDS”.

Enhancement 3:

A Power Headroom Report (PHR) shall be triggered if any of the following events occur:
[ . . . ]
activation of an SCell of any MAC entity ADDITION 3 STARTS: associated with this NW or another NW ADDITION 3 ENDS with configured uplink of which firstActiveDownlinkBWP-Id is not set to dormant BWP;

In Enhancement 4, addition 4 is made to Section 5.4.6 of 3GPP 38.321 v16.6.0. To distinguish addition 4 from what is originally included in Section 5.4.6 of 3GPP 38.321 v16.6.0, addition 4 is in bold, and is preceded by the term “ADDITION 4 STARTS:” and followed by the term “ADDITION 4 ENDS”.

Enhancement 4:

A Power Headroom Report (PHR) shall be triggered if any of the following events occur:
[ . . . ]
Upon switching of activated BWP from dormant BWP to non-dormant DL BWP of an SCell of any MAC entity ADDITION 4 STARTS: associated with this NW or another NW ADDITION 4 ENDS with configured uplink;

In Enhancement 5, addition 5 is made to Section 5.4.6 of 3GPP 38.321 v16.6.0. To distinguish addition 5 from what is originally included in Section 5.4.6 of 3GPP 38.321 v16.6.0, addition 5 is in bold, and is preceded by the term “ADDITION 5 STARTS:” and followed by the term “ADDITION 5 ENDS”.

Enhancement 5:

A Power Headroom Report (PHR) shall be triggered if any of the following events occur:

### Addition 5 Starts:

phr-ProhibitTimer expires or has expired and the path loss has changed more than phr-Tx-PowerFactorChange dB for at least one activated Serving Cell of another USIM of which the active DL BWP is not dormant BWP which is used as a pathloss reference since the most recent PHR transmission in this MAC entity when the MAC entity has UL resources for new transmission;

### Addition 5 Ends

[ . . . ]

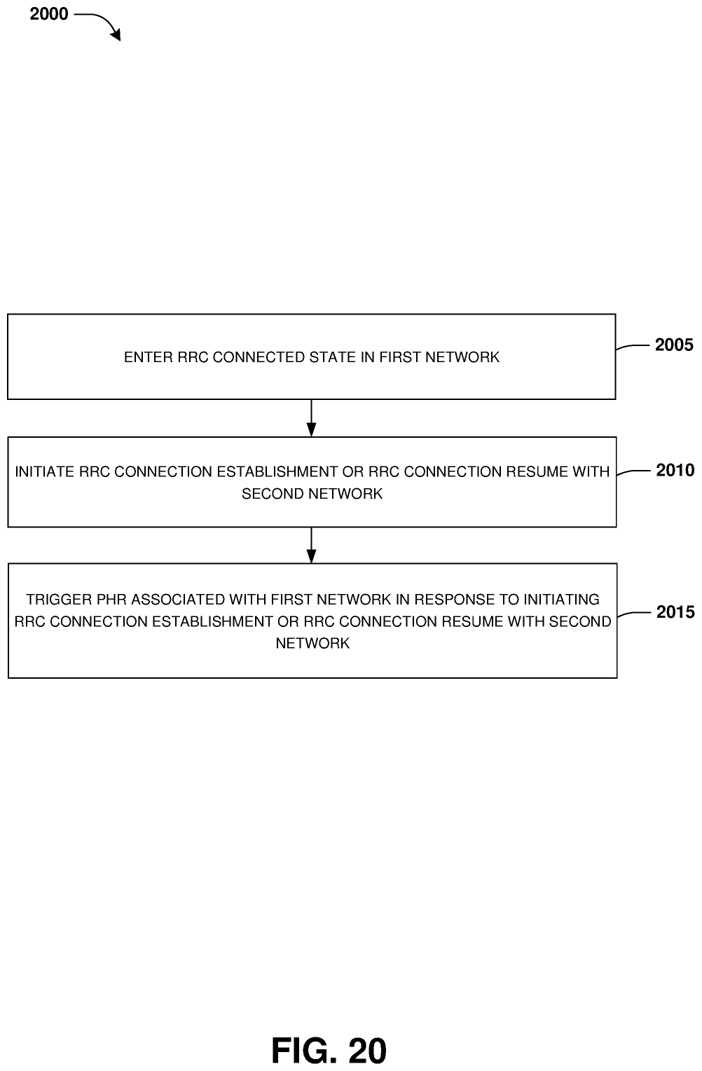

FIG. 20 is a flow chart 2000 according to one exemplary embodiment from the perspective of a UE. In step 2005, the UE enters RRC connected state (e.g., RRC_CONNECTED state) in a first network. In step 2010, the UE initiates a RRC connection establishment (e.g., a RRC connection establishment procedure) or a RRC connection resume (e.g., a RRC connection resume procedure) with a second network. In step 2015, the UE triggers a PHR associated with (e.g., for and/or to) the first network in response to the initiating the RRC connection establishment or the RRC connection resume with the second network.

Referring back to FIGS. 3 and 4, in one exemplary embodiment of a UE, the device 300 includes a program code 312 stored in the memory 310. The CPU 308 may execute program code 312 to enable the UE (i) to enter RRC connected state in a first network, (ii) to initiate a RRC connection establishment or a RRC connection resume with a second network, and (iii) to trigger a PHR associated with the first network in response to the initiating the RRC connection establishment or the RRC connection resume with the second network. Furthermore, the CPU 308 can execute the program code 312 to perform one, some and/or all of the above-described actions and steps and/or others described herein.

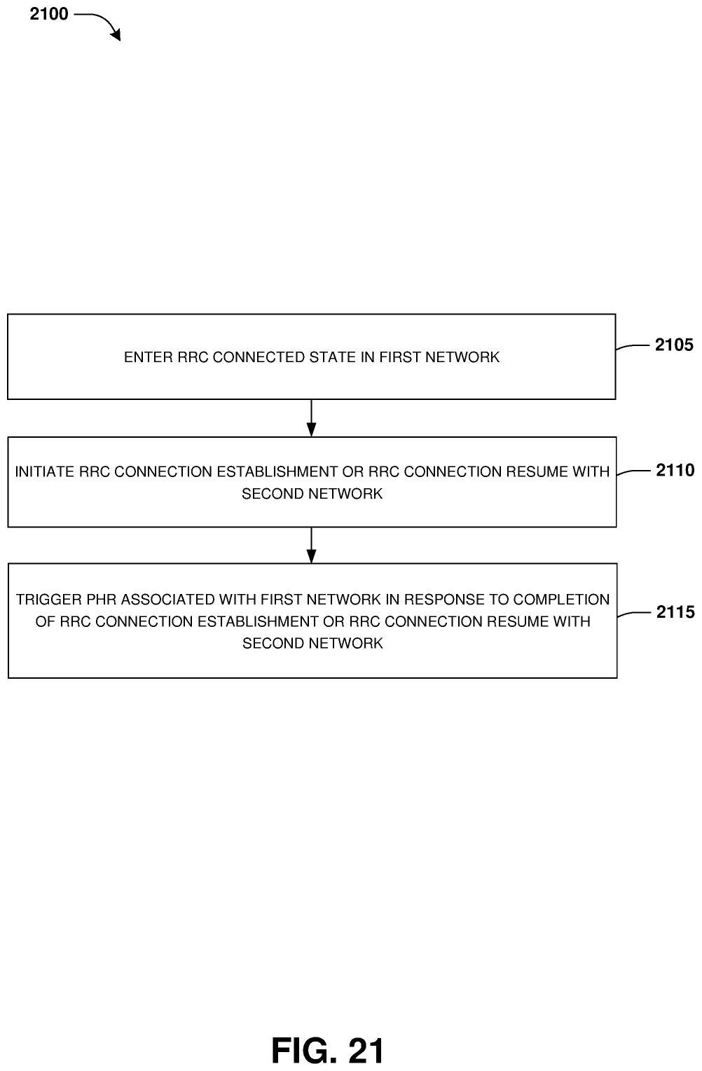

FIG. 21 is a flow chart 2100 according to one exemplary embodiment from the perspective of a UE. In step 2105, the UE enters RRC connected state (e.g., RRC_CONNECTED state) in a first network. In step 2110, the UE initiates a RRC connection establishment (e.g., a RRC connection establishment procedure) or a RRC connection resume (e.g., a RRC connection resume procedure) with a second network. In step 2115, the UE triggers a PHR associated with (e.g., for and/or to) the first network in response to completion of the RRC connection establishment or the RRC connection resume with the second network.

Referring back to FIGS. 3 and 4, in one exemplary embodiment of a UE, the device 300 includes a program code 312 stored in the memory 310. The CPU 308 may execute program code 312 to enable the UE (i) to enter RRC connected state in a first network, (ii) to initiate a RRC connection establishment or a RRC connection resume with a second network, and (iii) to trigger a PHR associated with the first network in response to completion of the RRC connection establishment or the RRC connection resume with the second network. Furthermore, the CPU 308 can execute the program code 312 to perform one, some and/or all of the above-described actions and steps and/or others described herein.

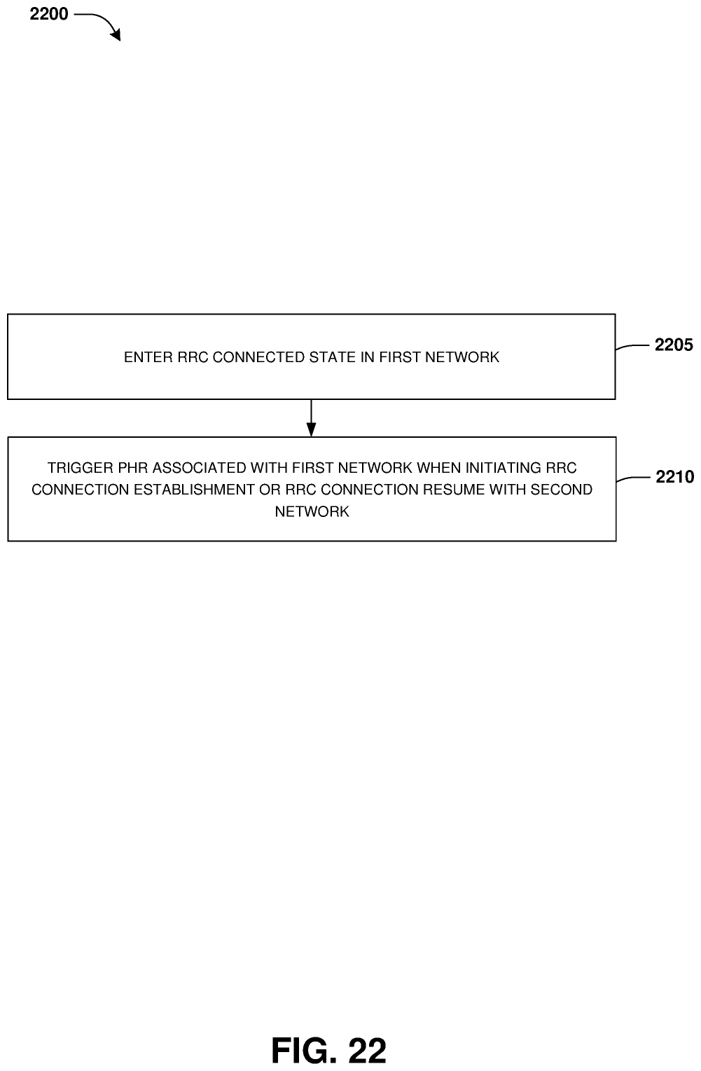

FIG. 22 is a flow chart 2200 according to one exemplary embodiment from the perspective of a UE. In step 2205, the UE enters RRC connected state (e.g., RRC_CONNECTED state) in a first network. In step 2210, the UE triggers a PHR associated with (e.g., for and/or to) the first network when initiating a RRC connection establishment (e.g., a RRC connection establishment procedure) or a RRC connection resume (e.g., a RRC connection resume procedure) with a second network.

Referring back to FIGS. 3 and 4, in one exemplary embodiment of a UE, the device 300 includes a program code 312 stored in the memory 310. The CPU 308 may execute program code 312 to enable the UE (i) to enter RRC connected state in a first network, and (ii) to trigger a PHR associated with the first network when initiating a RRC connection establishment or a RRC connection resume with a second network. Furthermore, the CPU 308 can execute the program code 312 to perform one, some and/or all of the above-described actions and steps and/or others described herein.

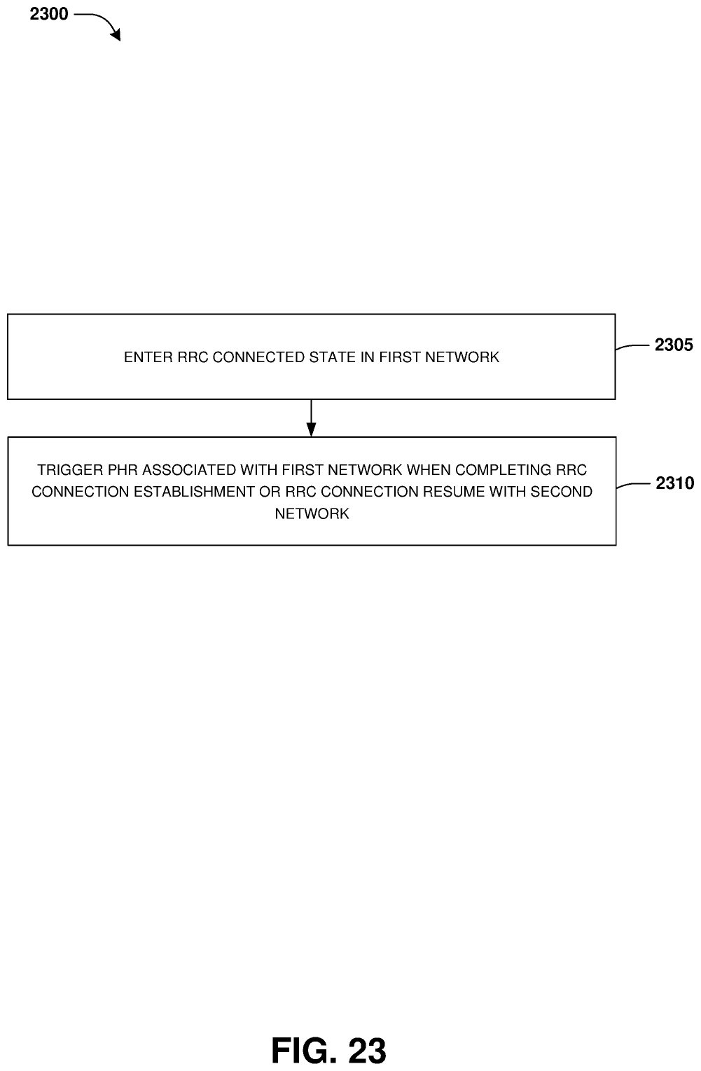

FIG. 23 is a flow chart 2300 according to one exemplary embodiment from the perspective of a UE. In step 2305, the UE enters RRC connected state (e.g., RRC_CONNECTED state) in a first network. In step 2310, the UE triggers a PHR associated with the first network when completing a RRC connection establishment (e.g., a RRC connection establishment procedure) or a RRC connection resume (e.g., a RRC connection resume procedure) with a second network.

Referring back to FIGS. 3 and 4, in one exemplary embodiment of a UE, the device 300 includes a program code 312 stored in the memory 310. The CPU 308 may execute program code 312 to enable the UE (i) to enter RRC connected state in a first network, and (ii) to trigger a PHR associated with the first network when completing a RRC connection establishment or a RRC connection resume with a second network. Furthermore, the CPU 308 can execute the program code 312 to perform one, some and/or all of the above-described actions and steps and/or others described herein.

With respect to FIGS. 20-23, in one embodiment, the UE operates (e.g., concurrently operates, such as simultaneously operates) in RRC connected state (e.g., RRC_CONNECTED state) in the first network and the second network after and/or in response to completion of the RRC connection establishment or the RRC connection resume with the second network.

In one embodiment, before completion of the RRC connection establishment or the RRC connection resume with the second network, the UE operates in RRC connected state (e.g., RRC_CONNECTED state) in the first network and operates in RRC idle or RRC inactive state (e.g., RRC_IDLE or RRC_INACTIVE state) in the second network.

In one embodiment, the UE cancels the PHR in response to a failure associated with the RRC connection establishment or the RRC connection resume with the second network.

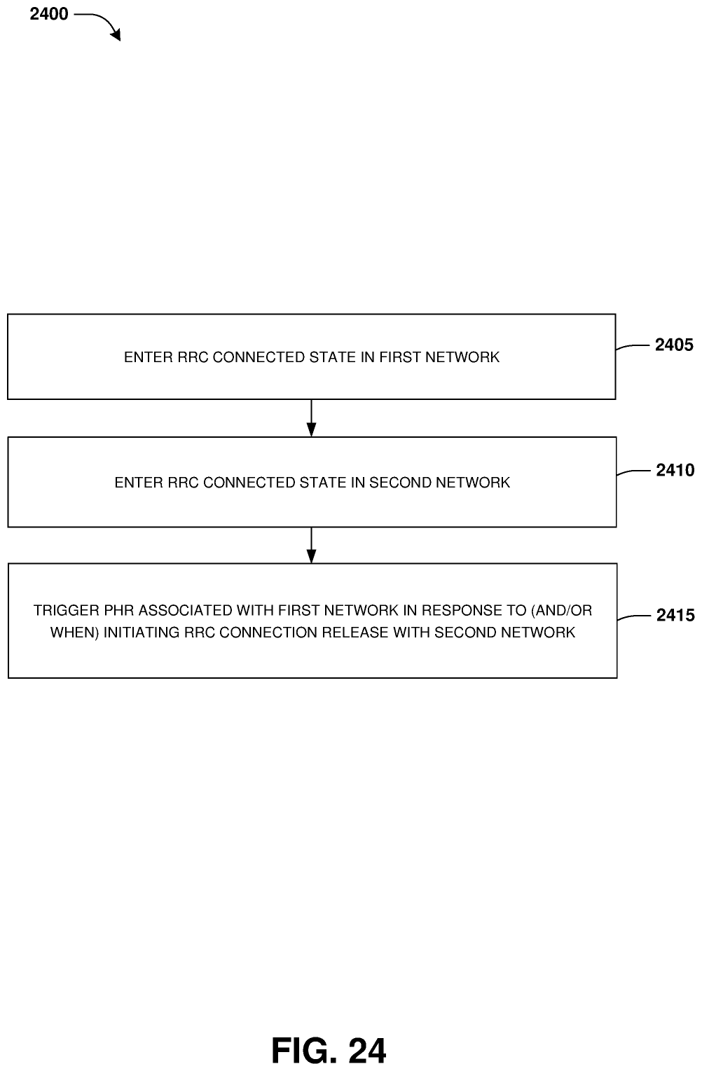

FIG. 24 is a flow chart 2400 according to one exemplary embodiment from the perspective of a UE. In step 2405, the UE enters RRC connected state (e.g., RRC_CONNECTED state) in a first network. In step 2410, the UE enters RRC connected state (e.g., RRC_CONNECTED state) in a second network. In step 2415, the UE triggers a PHR associated with the first network in response to (and/or when) initiating a RRC connection release (e.g., a RRC connection release procedure) with the second network.

Referring back to FIGS. 3 and 4, in one exemplary embodiment of a UE, the device 300 includes a program code 312 stored in the memory 310. The CPU 308 may execute program code 312 to enable the UE (i) to enter RRC connected state in a first network, (ii) to enter RRC connected state in a second network, and (iii) to trigger a PHR associated with the first network in response to (and/or when) initiating a RRC connection release with the second network. Furthermore, the CPU 308 can execute the program code 312 to perform one, some and/or all of the above-described actions and steps and/or others described herein.

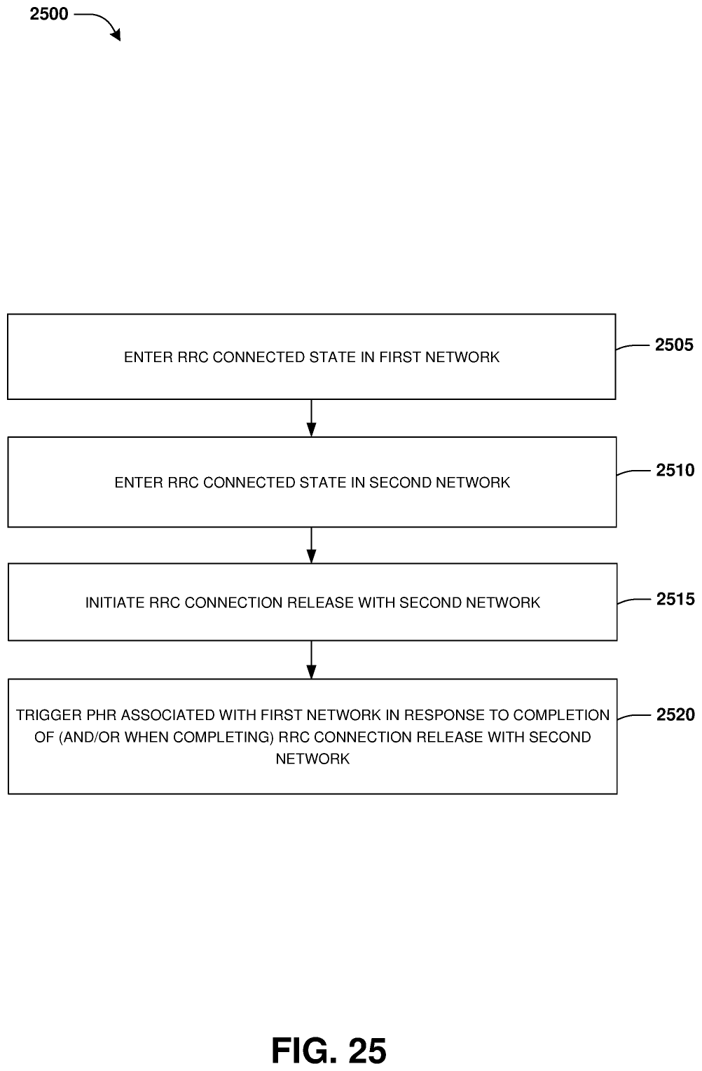

FIG. 25 is a flow chart 2500 according to one exemplary embodiment from the perspective of a UE. In step 2505, the UE enters RRC connected state (e.g., RRC_CONNECTED state) in a first network. In step 2510, the UE enters RRC connected state (e.g., RRC_CONNECTED state) in a second network. In step 2515, the UE initiates a RRC connection release (e.g., a RRC connection release procedure) with a second network. In step 2520, the UE triggers a PHR associated with the first network in response to completion of (and/or when completing) the RRC connection release with the second network.

Referring back to FIGS. 3 and 4, in one exemplary embodiment of a UE, the device 300 includes a program code 312 stored in the memory 310. The CPU 308 may execute program code 312 to enable the UE (i) to enter RRC connected state in a first network, (ii) to enter RRC connected state in a second network, (iii) to initiate a RRC connection release with a second network, and (iv) to trigger a PHR associated with the first network in response to completion of (and/or when completing) the RRC connection release with the second network. Furthermore, the CPU 308 can execute the program code 312 to perform one, some and/or all of the above-described actions and steps and/or others described herein.

With respect to FIGS. 24-25, in one embodiment, the UE operates in RRC connected state (e.g., RRC_CONNECTED state) in the first network and the second network concurrently (e.g., simultaneously) before initiating and/or completion of the RRC connection release (e.g., the RRC connection release procedure) with the second network.

In one embodiment, the UE cancels the PHR in response to a failure associated with the RRC connection release (e.g., the RRC connection release procedure) with the second network.

With respect to FIGS. 20-25, in one embodiment, the UE performs communication with a first network via a first SIM card and performs communication with the second network via a second SIM card.

In one embodiment, the UE transmits a PHR MAC CE to the first network in response to the triggered PHR.

In one embodiment, the UE triggers a second PHR associated with (e.g., for and/or to) the second network in response to completion of the RRC connection establishment or the RRC connection resume with the second network.

In one embodiment, the UE transmits a second PHR MAC CE to the second network in response to the triggered second PHR.

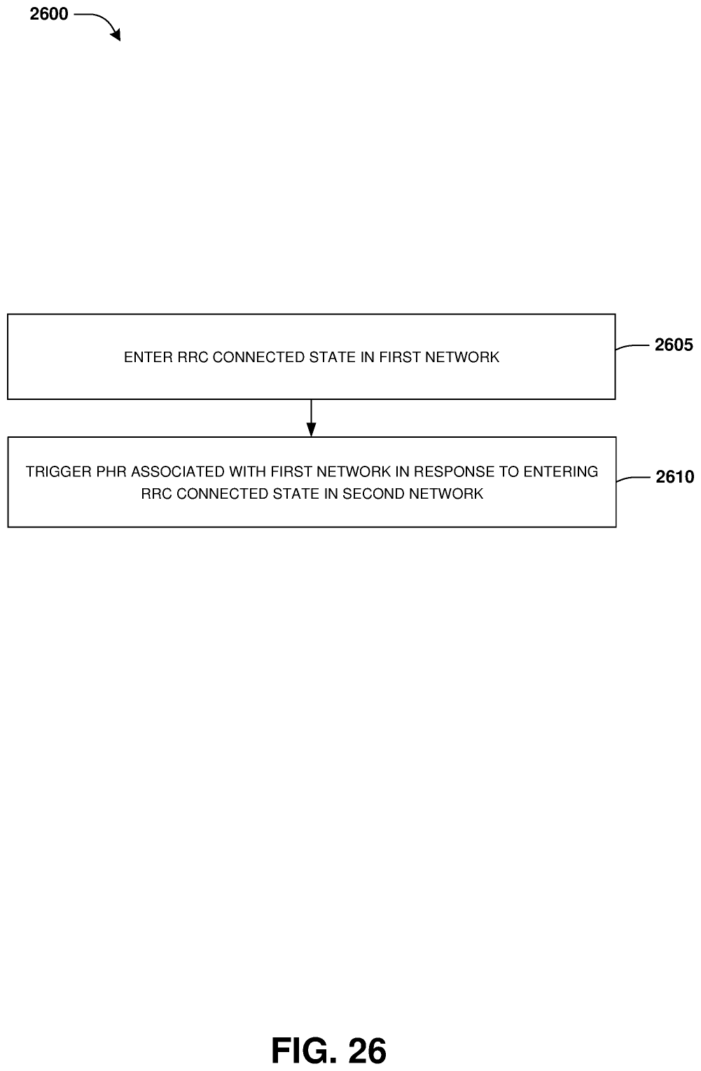

FIG. 26 is a flow chart 2600 according to one exemplary embodiment from the perspective of a UE. In step 2605, the UE enters RRC connected state (e.g., RRC_CONNECTED state) in a first network. In step 2610, the UE triggers a PHR associated with the first network in response to entering RRC connected state (e.g., RRC_CONNECTED state) in a second network.

In one embodiment, the UE operates in RRC connected state (e.g., RRC_CONNECTED state) concurrently (e.g., simultaneously) in the first network and the second network after the UE enters RRC connected state (e.g., RRC_CONNECTED state) in the second network.

Referring back to FIGS. 3 and 4, in one exemplary embodiment of a UE, the device 300 includes a program code 312 stored in the memory 310. The CPU 308 may execute program code 312 to enable the UE (i) to enter RRC connected state in a first network, and (ii) to trigger a PHR associated with the first network in response to entering RRC connected state in a second network. Furthermore, the CPU 308 can execute the program code 312 to perform one, some and/or all of the above-described actions and steps and/or others described herein.

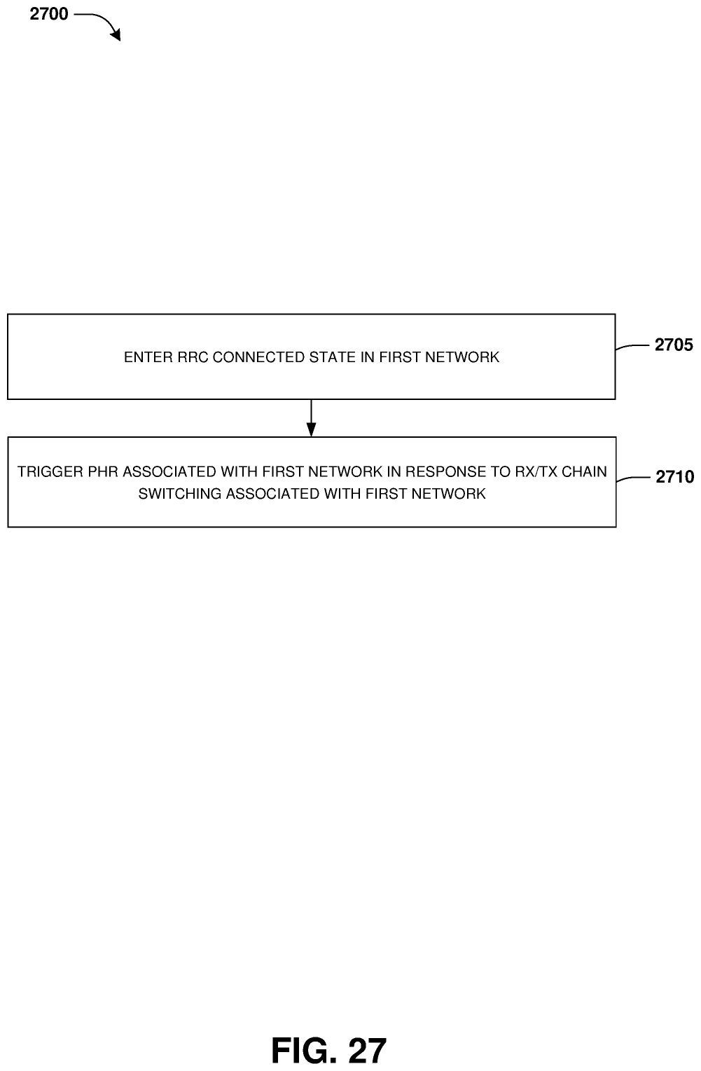

FIG. 27 is a flow chart 2700 according to one exemplary embodiment from the perspective of a UE. In step 2705, the UE enters RRC connected state (e.g., RRC_CONNECTED state) in a first network. In step 2710, the UE triggers a PHR associated with the first network in response to RX/TX chain switching associated with the first network.

In one embodiment, the RX/TX chain switching is associated with the UE entering RRC connected state (e.g., RRC_CONNECTED state) with a second network.

In one embodiment, the RX/TX chain switching is associated with the UE leaving RRC connected state (e.g., RRC_CONNECTED state) with a second network.

Referring back to FIGS. 3 and 4, in one exemplary embodiment of a UE, the device 300 includes a program code 312 stored in the memory 310. The CPU 308 may execute program code 312 to enable the UE (i) to enter RRC connected state in a first network, and (ii) to trigger a PHR associated with the first network in response to RX/TX chain switching associated with the first network. Furthermore, the CPU 308 can execute the program code 312 to perform one, some and/or all of the above-described actions and steps and/or others described herein.

With respect to FIGS. 20-27, in one embodiment, a PHR MAC CE may indicate a power headroom (e.g., a power headroom level) associated with one or more serving cells associated with the first network.

In one embodiment, a PHR MAC CE may indicate a power headroom (e.g., a power headroom level) associated with one or more serving cells associated with the second network.

In one embodiment, the RX/TX chain switching is associated with activation, deactivation, de-configuration, release, and/or addition of one or more SCGs and/or one or more SCells associated with the first network and/or the second network.

In one embodiment, the RX/TX chain switching is associated with switching from using a TX chain and/or an RX chain for communication with the first network to using the TX chain and/or the RX chain for communication with the second network.

In one embodiment, the RX/TX chain switching is associated with switching from using a TX chain and/or an RX chain for communication with the second network to using the TX chain and/or the RX chain for communication with the first network.

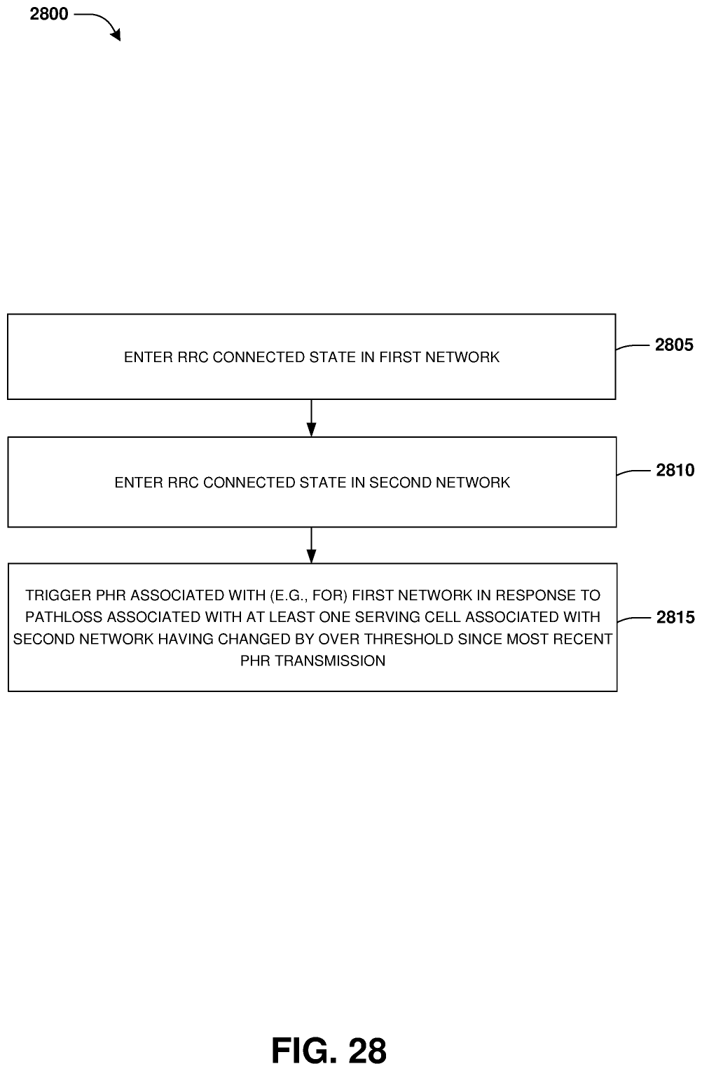

FIG. 28 is a flow chart 2800 according to one exemplary embodiment from the perspective of a UE. In step 2805, the UE enters RRC connected state (e.g., RRC_CONNECTED state) in a first network. In step 2810, the UE enters RRC connected state (e.g., RRC_CONNECTED state) in a second network. In step 2815, the UE triggers a PHR associated with (e.g., for and/or to) the first network in response to a pathloss associated with at least one Serving Cell associated with the second network having changed by over a threshold (e.g., a threshold pathloss change) since a most recent PHR transmission (e.g., a most recent transmission of a power headroom report, such as a PHR MAC CE, to the first network or a most recent transmission of a power headroom report, such as a PHR MAC CE, to the second network).

In one embodiment, the UE performs communication with the first network via a first MAC entity and a second MAC entity. The UE triggers a PHR, associated with the first MAC entity, for the first network in response to a pathloss associated with at least one Serving Cell associated with the second MAC entity having changed by over a threshold since a most recent PHR transmission (e.g., a most recent transmission of a power headroom report, such as a PHR MAC CE, to the first network). In response to triggering the PHR (associated with the first MAC entity) for the first network, the UE may transmit a power headroom report (e.g., a PHR MAC CE), associated with the first MAC entity, to the first network.

Referring back to FIGS. 3 and 4, in one exemplary embodiment of a UE, the device 300 includes a program code 312 stored in the memory 310. The CPU 308 may execute program code 312 to enable the UE (i) to enter RRC connected state in a first network, (ii) to enter RRC connected state in a second network, and (iii) to trigger a PHR associated with (e.g., for and/or to) the first network in response to a pathloss associated with at least one Serving Cell associated with the second network having changed by over a threshold since a most recent PHR transmission. Furthermore, the CPU 308 can execute the program code 312 to perform one, some and/or all of the above-described actions and steps and/or others described herein.

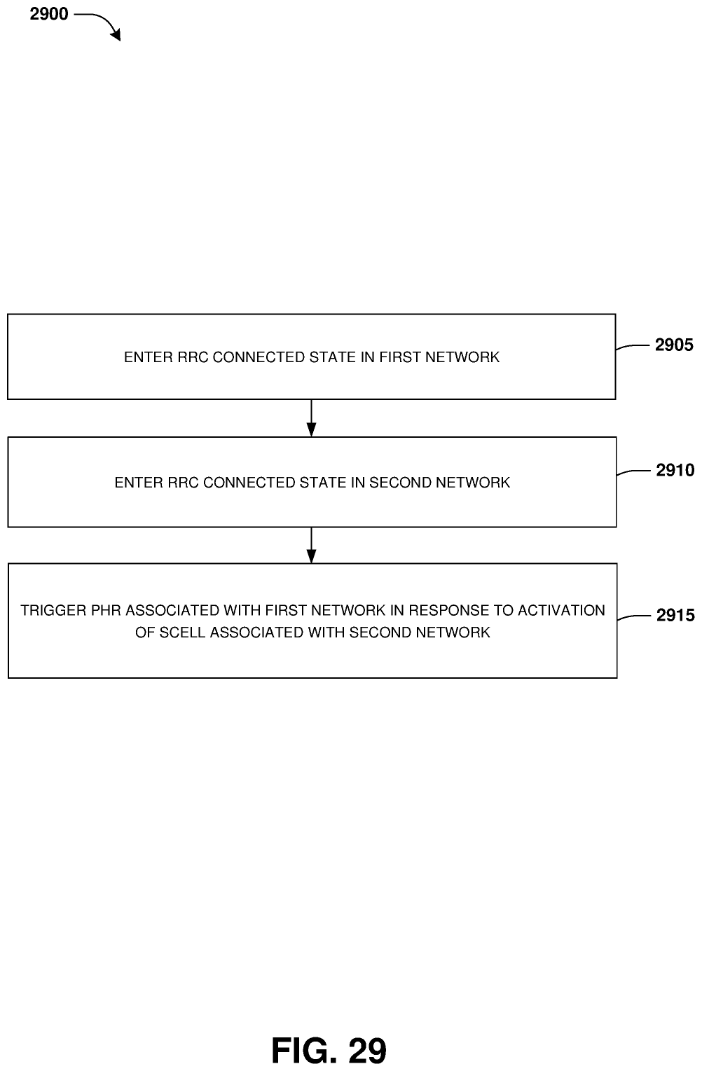

FIG. 29 is a flow chart 2900 according to one exemplary embodiment from the perspective of a UE. In step 2905, the UE enters RRC connected state (e.g., RRC_CONNECTED state) in a first network. In step 2910, the UE enters RRC connected state (e.g., RRC_CONNECTED state) in a second network. In step 2915, the UE triggers a PHR associated with (e.g., for and/or to) the first network in response to an activation of a SCell associated with the second network.

In one embodiment, the UE performs communication with the first network via a first MAC entity and a second MAC entity. The UE triggers a PHR, associated with the first MAC, entity for the first network in response to activation of a SCell associated with the second MAC entity. In response to triggering the PHR (associated with the first MAC entity) for the first network, the UE may transmit a power headroom report (e.g., a PHR MAC CE), associated with the first MAC entity, to the first network.

Referring back to FIGS. 3 and 4, in one exemplary embodiment of a UE, the device 300 includes a program code 312 stored in the memory 310. The CPU 308 may execute program code 312 to enable the UE (i) to enter RRC connected state in a first network, (ii) to enter RRC connected state in a second network, and (iii) to trigger a PHR associated with the first network in response to an activation of a SCell associated with the second network. Furthermore, the CPU 308 can execute the program code 312 to perform one, some and/or all of the above-described actions and steps and/or others described herein.

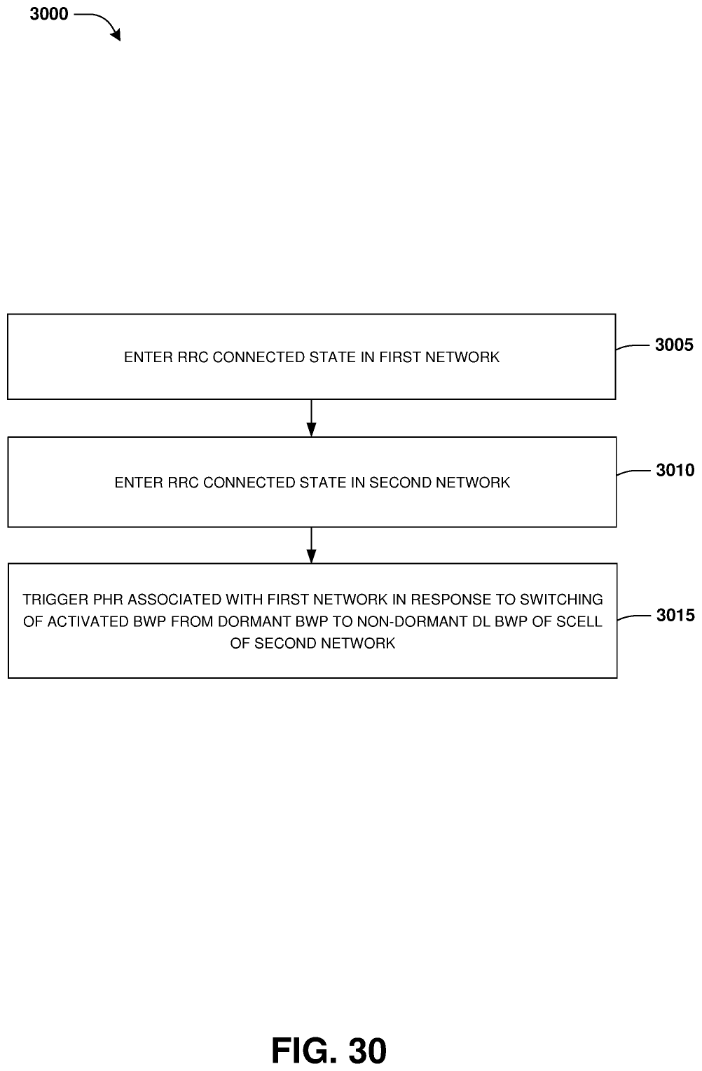

FIG. 30 is a flow chart 3000 according to one exemplary embodiment from the perspective of a UE. In step 3005, the UE enters RRC connected state (e.g., RRC_CONNECTED state) in a first network. In step 3010, the UE enters RRC connected state (e.g., RRC_CONNECTED state) in a second network. In step 3015, the UE triggers a PHR associated with (e.g., for and/or to) the first network in response to a switching of an activated BWP from a dormant BWP to a non-dormant DL BWP of a SCell of the second network.

The activated BWP may be switched from being a dormant BWP to being a non-dormant DL BWP for DL use by the UE to communicate with the second network via the SCell of the second network, wherein after switching the activated BWP to being the non-dormant DL BWP, the UE may use the activated BWP as the non-dormant DL BWP to receive one or more signals from the second network via the SCell of the second network.

In one embodiment, the UE performs communication with the first network via a first MAC entity and a second MAC entity. The UE triggers a PHR, associated with the first MAC entity, for the first network in response to switching of an activated BWP from dormant BWP to non-dormant DL BWP of a SCell associated with the second MAC entity. The activated BWP may be switched from being a dormant BWP to being a non-dormant DL BWP for DL use by the UE to communicate with the second network via the SCell associated with the second MAC entity, wherein after switching the activated BWP to being the non-dormant DL BWP, the UE may use the activated BWP as the non-dormant DL BWP to receive one or more signals from the second network via the SCell associated with the second MAC entity. In response to triggering the PHR (associated with the first MAC entity) for the first network, the UE may transmit a power headroom report (e.g., a PHR MAC CE), associated with the first MAC entity, to the first network.

Referring back to FIGS. 3 and 4, in one exemplary embodiment of a UE, the device 300 includes a program code 312 stored in the memory 310. The CPU 308 may execute program code 312 to enable the UE (i) to enter RRC connected state in a first network, (ii) to enter RRC connected state in a second network, and (iii) to trigger a PHR associated with the first network in response to a switching of an activated BWP from a dormant BWP to a non-dormant DL BWP of a SCell of the second network. Furthermore, the CPU 308 can execute the program code 312 to perform one, some and/or all of the above-described actions and steps and/or others described herein.

With respect to FIGS. 28-30, in one embodiment, the UE operates (e.g., concurrently operates, such as simultaneously operates) in RRC connected state (e.g., RRC_CONNECTED state) in the first network and the second network after (and/or in response to) the entering RRC connected state in the second network.

In one embodiment, the first MAC entity and the second MAC entity are not associated with the second network.

In one embodiment, the UE performs communication with the second network via one or more MAC entities comprising a third MAC entity.

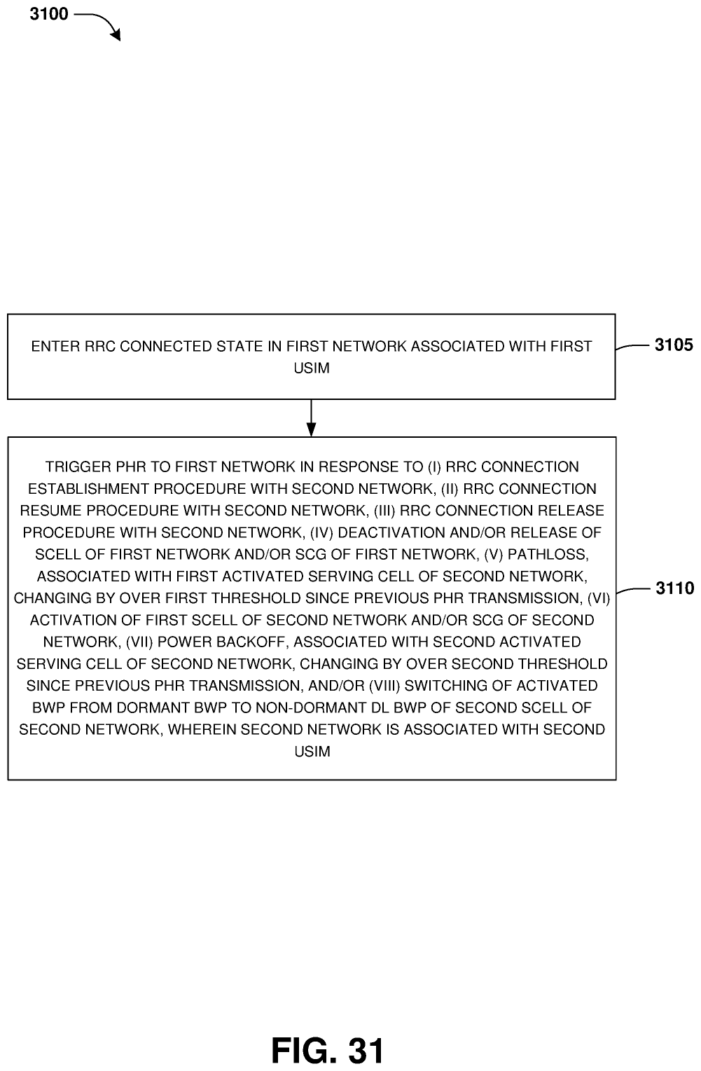

FIG. 31 is a flow chart 3100 according to one exemplary embodiment from the perspective of a UE with a first USIM and a second USIM. In step 3105, the UE enters RRC connected state (e.g., RRC_CONNECTED state) in a first network associated with the first USIM. For example, the first UE may communicate with the first network using the first USIM. In step 3110, the UE triggers a PHR to the first network in response to (i) a RRC connection establishment procedure with a second network (e.g., the RRC connection establishment procedure may be performed by the UE and/or the second network), (ii) a RRC connection resume procedure with the second network (e.g., the RRC connection resume procedure may be performed by the UE and/or the second network), (iii) a RRC connection release procedure with the second network (e.g., the RRC connection release procedure may be performed by the UE and/or the second network), (iv) deactivation and/or release of a SCell of the first network and/or a SCG of the first network (e.g., the UE may deactivate and/or release the SCell and/or the SCG of the first network), (v) a pathloss, associated with a first activated Serving Cell of the second network, changing by over a first threshold (e.g., a threshold pathloss change) since a previous PHR transmission, (vi) activation of a first SCell of the second network and/or a SCG of the second network (e.g., the UE may activate the first SCell of the second network and/or the SCG of the second network), (vii) a power backoff (e.g., a required power backoff), associated with a second activated Serving Cell of the second network, changing by over a second threshold (e.g., a threshold power backoff change) since the previous PHR transmission, and/or (viii) switching of an activated BWP from a dormant BWP to a non-dormant DL BWP of a second SCell of the second network (e.g., the activated BWP may be switched from being a dormant BWP to being a non-dormant DL BWP for DL use by the UE to communicate with the second network via the second SCell, wherein after switching the activated BWP to being the non-dormant DL BWP, the UE may use the activated BWP as the non-dormant DL BWP to receive one or more signals from the second network via the second SCell). The second network is associated with the second USIM. For example, the UE may communicate with the second network using the second USIM. The second SCell may be the same as or different than the first SCell.

The previous PHR transmission may correspond to a most recent PHR transmission. For example, the previous PHR transmission may correspond to a most recent transmission of a power headroom report (e.g., power information), such as a PHR MAC CE, to the first network. Alternatively and/or additionally, the previous PHR transmission may correspond to a most recent transmission of a power headroom report (e.g., power information), such as a PHR MAC CE, to the second network.

In an example, the first USIM may be associated with a first subscription (e.g., a first telecommunication service subscription) with a first telecommunication service provider associated with the first network. The second USIM may be associated with a second subscription (e.g., a second telecommunication service subscription) with a second telecommunication service provider associated with the second network. The UE may be provided with one or more telecommunication services of the first subscription by communicating with the first network using the first USIM. The UE may be provided with one or more telecommunication services of the second subscription by communicating with the second network using the second USIM.

In one embodiment, the UE triggers the PHR to the first network when (i) initiating and/or completing the RRC connection establishment procedure (e.g., which may be performed to establish a RRC connection of the UE with the second network), (ii) initiating and/or completing the RRC connection resume procedure (e.g., which may be performed to resume a RRC connection of the UE with the second network), and/or (iii) initiating and/or completing the RRC connection release procedure (e.g., which may be performed to release a RRC connection of the UE with the second network).

In one embodiment, the UE triggers the PHR to the first network when considering a cell of the second network to be a PCell (e.g., a PCell of the UE).

In one embodiment, the UE triggers the PHR to the first network when entering RRC connected state (e.g., RRC_CONNECTED state) in the second network.

In one embodiment, the UE triggers the PHR to the first network when entering RRC idle state (e.g., RRC_IDLE state) in the second network or RRC inactive state (e.g., RRC_INACTIVE state) in the second network.

In one embodiment, a MAC CE (e.g., a PHR MAC CE) for the PHR to the first network indicates power information associated with the second network.

In one embodiment, in response to the triggering the PHR to the first network, the UE transmits the MAC CE (indicative of the power information associated with the second network) to the first network. For example, the PHR may comprise the transmission of the MAC CE to the first network. The power information (indicated by the MAC CE) may comprise a power headroom (e.g., a power headroom level) associated with the second network, a power backoff associated with the second network, and/or a P-MPR associated with the second network.

In one embodiment, the UE determines whether to report, to the first network, power information associated with the second network based on a network configuration. The power information may comprise a power headroom (e.g., a power headroom level) associated with the second network, a power backoff associated with the second network, and/or a P-MPR associated with the second network. The network configuration may correspond to a RRC parameter configured by a network (e.g., the first network, the second network, or a third network may provide the UE with the RRC parameter).

In one embodiment, the UE determines whether to trigger the PHR to the first network based on a network configuration. The network configuration may correspond to a RRC parameter configured by a network (e.g., the first network, the second network, or a third network may provide the UE with the RRC parameter).

In one embodiment, based on a network configuration, the UE determines whether to transmit, to the first network, power information associated with the second network in response to triggering the PHR. For example, the UE may determine whether to include the power information associated with the second network in a transmission performed for the PHR to the first network. The power information may comprise a power headroom (e.g., a power headroom level) associated with the second network, a power backoff associated with the second network, and/or a P-MPR associated with the second network. The network configuration may correspond to a RRC parameter configured by a network (e.g., the first network, the second network, or a third network may provide the UE with the RRC parameter).

In one embodiment, the UE enters RRC connected state in the second network and/or transmits a capability change information to the first network. The capability change information may be indicative of one or more SCGs (e.g., the SCG of the first network), one or more SCells (e.g., the SCell of the first network) and/or one or more configured resources that the UE (i) currently uses for communication with the first network and/or (ii) plans and/or prefers to release, deactivate and/or cease using for communication with the first network. The UE may transmit the capability information in association with (e.g., in response to and/or when) entering the RRC connected state in the second network. The deactivation and/or the release (of the SCell of the first network and/or the SCG of the first network) is associated with (e.g., is based on and/or due to) (i) the UE entering RRC connected state (e.g., RRC_CONNECTED state) in the second network and/or (ii) the capability change information. For example, the deactivation and/or the release (of the SCell of the first network and/or the SCG of the first network) may be performed in association with (e.g., in response to and/or when) entering the RRC connected state in the second network and/or deactivating and/or releasing the SCell of the first network and/or the SCG of the first network.

In one embodiment, the UE does not trigger the PHR to the first network if the deactivation and/or the release (of the SCell of the first network and/or the SCG of the first network) is not associated with (e.g., is not based on and/or due to) the UE entering RRC connected state (e.g., RRC_CONNECTED state) in the second network.

In one embodiment, the UE enters RRC connected state (e.g., RRC_CONNECTED state) in the second network. The UE triggers the PHR to the first network based on the deactivation and/or the release (of the SCell of the first network and/or the SCG of the first network) being associated with (e.g., being based on and/or due to) the UE entering the RRC connected state in the second network.

In one embodiment, the UE enters RRC connected state (e.g., RRC_CONNECTED state) in the second network. After entering RRC connected state in the second network, the UE concurrently (e.g., simultaneously) operates in the RRC connected state in the first network and in the RRC connected state in the second network.

In one embodiment, when the UE triggers the PHR to the first network, the UE concurrently (e.g., simultaneously) operates in the RRC connected state in the first network and in RRC connected state in the second network.

In some examples, it may be determined that the pathloss, associated with the first activated Serving Cell of the second network, changed by over the first threshold (e.g., the threshold pathloss change) since the previous PHR transmission based on a determination that (i) the pathloss (associated with the first activated Serving Cell) was equal to a first value when the previous PHR transmission was performed (and/or a power headroom report transmitted via the previous PHR transmission indicated the pathloss as being equal to the first value), (ii) the pathloss (associated with the first activated Serving Cell) is currently equal to a second value, and/or (iii) a difference between the first value and the second value exceeds the first threshold.

In some examples, it may be determined that the power backoff, associated with the second activated Serving Cell of the second network, changed by over the second threshold (e.g., the threshold power backoff change) since the previous PHR transmission based on a determination that (i) the power backoff (associated with the second activated Serving Cell) was equal to a first value when the previous PHR transmission was performed (and/or a power headroom report transmitted via the previous PHR transmission indicated the power backoff as being equal to the first value), (ii) the power backoff (associated with the second activated Serving Cell) is currently equal to a second value, and/or (iii) a difference between the first value and the second value exceeds the second threshold. In some examples, the power backoff (e.g., the required power backoff) may change via power management and/or P-MPR for the second activated Serving Cell.

In some examples, when the UE is operating in RRC connected state in a network (e.g., the first network, the second network, etc.), radio resources of the network are allocated to the UE and/or active communication takes place between the UE and the network.

Referring back to FIGS. 3 and 4, in one exemplary embodiment of a UE, the device 300 includes a program code 312 stored in the memory 310. The CPU 308 may execute program code 312 to enable the UE (A) to enter RRC connected state in a first network associated with the first USIM, and (B) to trigger a PHR to the first network in response to (i) a RRC connection establishment procedure with a second network, (ii) a RRC connection resume procedure with the second network, (iii) a RRC connection release procedure with the second network, (iv) deactivation and/or release of a SCell of the first network and/or a SCG of the first network, (v) a pathloss, associated with a first activated Serving Cell of the second network, changing by over a first threshold since a previous PHR transmission, (vi) activation of a first SCell of the second network and/or a SCG of the second network, (vii) a power backoff, associated with a second activated Serving Cell of the second network, changing by over a second threshold since the previous PHR transmission, and/or (viii) switching of an activated BWP from a dormant BWP to a non-dormant DL BWP of a second SCell of the second network, wherein the second network is associated with the second USIM. Furthermore, the CPU 308 can execute the program code 312 to perform one, some and/or all of the above-described actions and steps and/or others described herein.

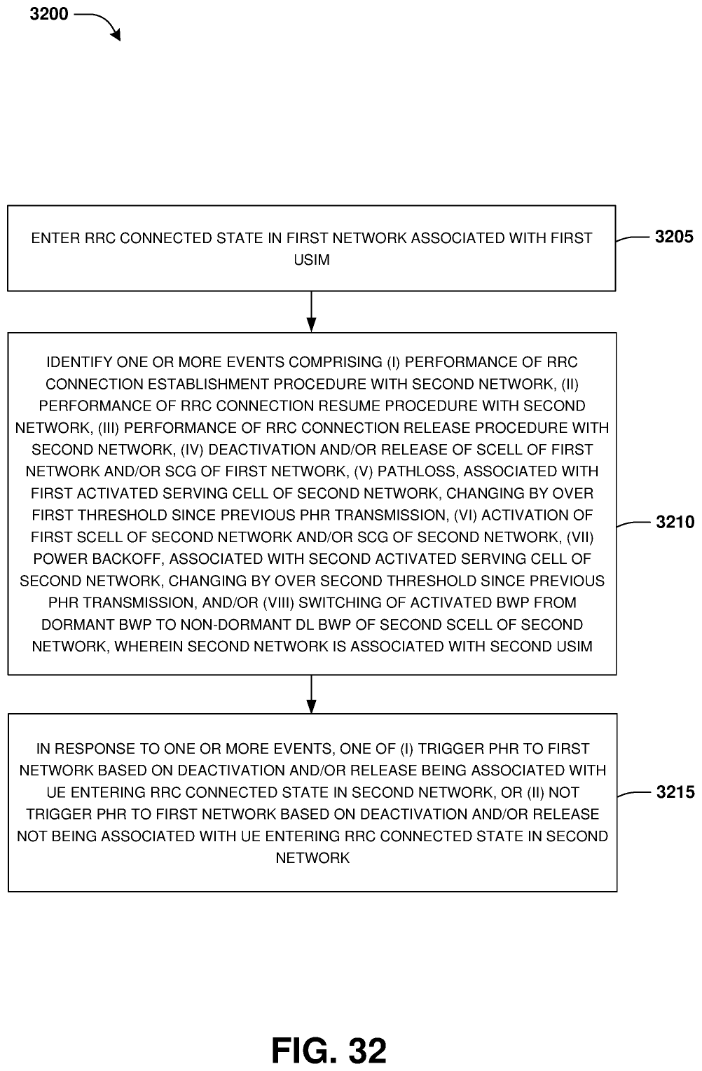

FIG. 32 is a flow chart 3200 according to one exemplary embodiment from the perspective of a UE with a first USIM and a second USIM. In step 3205, the UE enters RRC connected state in a first network associated with the first USIM. In step 3210, the UE identifies one or more events comprising (i) performance of (e.g., initiation of, completion of, etc.) a RRC connection establishment procedure with a second network (e.g., the RRC connection establishment procedure may be performed by the UE and/or the second network), (ii) performance of (e.g., initiation of, completion of, etc.) a RRC connection resume procedure with the second network (e.g., the RRC connection resume procedure may be performed by the UE and/or the second network), (iii) performance of (e.g., initiation of, completion of, etc.) a RRC connection release procedure with the second network (e.g., the RRC connection release procedure may be performed by the UE and/or the second network), (iv) deactivation and/or release of a SCell of the first network and/or a SCG of the first network (e.g., the UE may deactivate and/or release the SCell and/or the SCG of the first network), (v) a pathloss, associated with a first activated Serving Cell of the second network, changing by over a first threshold (e.g., a threshold pathloss change) since a previous PHR transmission, (vi) activation of a first SCell of the second network and/or a SCG of the second network (e.g., the UE may activate the first SCell of the second network and/or the SCG of the second network), (vii) a power backoff (e.g., a required power backoff), associated with a second activated Serving Cell of the second network, changing by over a second threshold (e.g., a threshold power backoff change) since the previous PHR transmission, and/or (viii) switching of an activated BWP from a dormant BWP to a non-dormant DL BWP of a second S Cell of the second network (e.g., the activated BWP may be switched from being a dormant BWP to being a non-dormant DL BWP for DL use by the UE to communicate with the second network via the second SCell, wherein after switching the activated BWP to being the non-dormant DL BWP, the UE may use the activated BWP as the non-dormant DL BWP to receive one or more signals from the second network via the second SCell). The second network is associated with the second USIM. In step 3215, in response to the one or more events, the UE one of (i) triggers a PHR to the first network based on the deactivation and/or the release (of the SCell of the first network and/or the SCG of the first network) being associated with the UE entering the RRC connected state in the second network, or (ii) does not trigger the PHR to the first network based on the deactivation and/or the release (of the SCell of the first network and/or the SCG of the first network) not being associated with the UE entering the RRC connected state in the second network.

For example, if the deactivation and/or the release (of the SCell of the first network and/or the SCG of the first network) is associated with (e.g., is based on and/or due to) the UE entering the RRC connected state in the second network, the UE may trigger the PHR to the first network in response to the one or more events. In an example, the deactivation and/or the release (of the SCell of the first network and/or the SCG of the first network) may be performed in association with the UE entering the RRC connected state in the second network. Upon the deactivation and/or the release (of the SCell of the first network and/or the SCG of the first network), the UE may cease using the SCell of the first network and/or the SCG of the first network for communication with the first network.

Alternatively and/or additionally, if the deactivation and/or the release (of the SCell of the first network and/or the SCG of the first network) is not associated with (e.g., is not based on and/or not due to) the UE entering the RRC connected state in the second network, the UE may not trigger the PHR to the first network in response to the one or more events. In an example, the deactivation and/or the release (of the SCell of the first network and/or the SCG of the first network) may be performed by the UE without the UE entering RRC connected state in the second network. Alternatively and/or additionally, the deactivation and/or the release (of the SCell of the first network and/or the SCG of the first network) may be performed by the UE based on an event that is different than the UE entering RRC connected state in the second network.

The previous PHR transmission may correspond to a most recent PHR transmission. For example, the previous PHR transmission may correspond to a most recent transmission of a power headroom report (e.g., power information), such as a PHR MAC CE, to the first network. Alternatively and/or additionally, the previous PHR transmission may correspond to a most recent transmission of a power headroom report (e.g., power information), such as a PHR MAC CE, to the second network.

In some examples, one, some and/or all of the techniques, operations, etc. described with respect to the flow chart 3100 of FIG. 31 may be applicable to and/or implemented in accordance with the flow chart 3200 of FIG. 32.

Referring back to FIGS. 3 and 4, in one exemplary embodiment of a UE, the device 300 includes a program code 312 stored in the memory 310. The CPU 308 may execute program code 312 to enable the UE (A) to enter RRC connected state in a first network associated with the first USIM, (B) to identify one or more events comprising (i) performance of a RRC connection establishment procedure with a second network, (ii) performance of a RRC connection resume procedure with the second network, (iii) performance of a RRC connection release procedure with the second network, (iv) deactivation and/or release of a SCell of the first network and/or a SCG of the first network, (v) a pathloss, associated with a first activated Serving Cell of the second network, changing by over a first threshold since a previous PHR transmission, (vi) activation of a first SCell of the second network and/or a SCG of the second network, (vii) a power backoff, associated with a second activated Serving Cell of the second network, changing by over a second threshold since the previous PHR transmission, and/or (viii) switching of an activated BWP from a dormant BWP to a non-dormant DL BWP of a second SCell of the second network, wherein the second network is associated with the second USIM, and (C) in response to the one or more events, one of (i) to trigger a PHR to the first network based on the deactivation and/or the release being associated with the UE entering the RRC connected state in the second network, or (ii) to not trigger the PHR to the first network based on the deactivation and/or the release not being associated with the UE entering the RRC connected state in the second network. Furthermore, the CPU 308 can execute the program code 312 to perform one, some and/or all of the above-described actions and steps and/or others described herein.

A communication device (e.g., a UE, a base station, a network node, etc.) may be provided, wherein the communication device may comprise a control circuit, a processor installed in the control circuit and/or a memory installed in the control circuit and coupled to the processor. The processor may be configured to execute a program code stored in the memory to perform method steps illustrated in FIGS. 20-32. Furthermore, the processor may execute the program code to perform one, some and/or all of the above-described actions and steps and/or others described herein.

A computer-readable medium may be provided. The computer-readable medium may be a non-transitory computer-readable medium. The computer-readable medium may comprise a flash memory device, a hard disk drive, a disc (e.g., a magnetic disc and/or an optical disc, such as at least one of a digital versatile disc (DVD), a compact disc (CD), etc.), and/or a memory semiconductor, such as at least one of static random access memory (SRAM), dynamic random access memory (DRAM), synchronous dynamic random access memory (SDRAM), etc. The computer-readable medium may comprise processor-executable instructions, that when executed cause performance of one, some and/or all method steps illustrated in FIGS. 20-32, and/or one, some and/or all of the above-described actions and steps and/or others described herein.

It may be appreciated that applying one or more of the techniques presented herein may result in one or more benefits including, but not limited to, increased efficiency of communication between devices (e.g., a UE and/or a network), such as where a UE has multiple USIMs. The increased efficiency may be a result of enabling the UE to perform PHR to a network (e.g., when the UE enters RRC connected state with another network) and/or enabling the UE to concurrently (e.g., simultaneously) operate in RRC connected state with multiple networks.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based on design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Alternatively and/or additionally, in some aspects any suitable computer-program product may comprise a computer-readable medium comprising codes relating to one or more of the aspects of the disclosure. In some aspects a computer program product may comprise packaging materials.

While the disclosed subject matter has been described in connection with various aspects, it will be understood that the disclosed subject matter is capable of further modifications. This application is intended to cover any variations, uses or adaptation of the disclosed subject matter following, in general, the principles of the disclosed subject matter, and including such departures from the present disclosure as come within the known and customary practice within the art to which the disclosed subject matter pertains.

1. A method of a User Equipment (UE) with a first Universal Subscriber Identity Module (USIM) and a second USIM, the method comprising:
entering Radio Resource Control (RRC) connected state in a first network associated with the first USIM; and
triggering a power headroom reporting (PHR) to the first network in response to at least one of:
a RRC connection establishment procedure with a second network;
a RRC connection resume procedure with the second network;
a RRC connection release procedure with the second network;
at least one of deactivation or release of at least one of a Secondary Cell (SCell) of the first network or a Secondary Cell Group (SCG) of the first network;
a pathloss, associated with a first activated Serving Cell of the second network, changing by over a first threshold since a previous PHR transmission;
activation of at least one of a first SCell of the second network or a SCG of the second network;
a power backoff, associated with a second activated Serving Cell of the second network, changing by over a second threshold since the previous PHR transmission; or
switching of an activated Bandwidth Part (BWP) from a dormant BWP to a non-dormant downlink (DL) BWP of a second SCell of the second network,
wherein the second network is associated with the second USIM.

2. The method of claim 1, wherein:
the triggering the PHR to the first network is performed when the UE at least one of initiates or completes at least one of:
the RRC connection establishment procedure;
the RRC connection resume procedure; or
the RRC connection release procedure.

3. The method of claim 1, wherein:
the triggering the PHR to the first network is performed when the UE considers a cell of the second network to be a Primary Cell (PCell).

4. The method of claim 1, wherein:
the triggering the PHR to the first network is performed when the UE enters RRC connected state in the second network.

5. The method of claim 1, wherein:
the triggering the PHR to the first network is performed when the UE enters RRC idle state in the second network or RRC inactive state in the second network.

6. The method of claim 1, comprising:
in response to the triggering the PHR to the first network, transmitting, to the first network, a Medium Access Control (MAC) Control Element (CE) indicative of power information associated with the second network.

7. The method of claim 1, comprising:
based on a network configuration, determining whether to at least one of:
trigger the PHR; or
transmit, to the first network, power information associated with the second network in response to triggering the PHR.

8. The method of claim 1, comprising at least one of:
entering RRC connected state in the second network; or
transmitting a capability change information to the first network,
wherein at least one of the deactivation or the release is associated with at least one of:
the entering the RRC connected state in the second network; or
the capability change information.

9. The method of claim 1, comprising:
entering RRC connected state in the second network, wherein the triggering the PHR to the first network is performed based on at least one of the deactivation or the release being associated with the entering the RRC connected state in the second network.

10. The method of claim 1, comprising:
entering RRC connected state in the second network; and
after the entering the RRC connected state in the second network, concurrently operating in the RRC connected state in the first network and in the RRC connected state in the second network.

11. The method of claim 1, comprising:
when the UE triggers the PHR to the first network, concurrently operating in the RRC connected state in the first network and in RRC connected state in the second network.

12. A User Equipment (UE) with a first Universal Subscriber Identity Module (USIM) and a second USIM, the UE comprising:
a control circuit;
a processor installed in the control circuit; and
a memory installed in the control circuit and operatively coupled to the processor, wherein the processor is configured to execute a program code stored in the memory to perform operations, the operations comprising:
entering Radio Resource Control (RRC) connected state in a first network associated with the first USIM; and
triggering a power headroom reporting (PHR) to the first network in response to at least one of:
a RRC connection establishment procedure with a second network;
a RRC connection resume procedure with the second network;
a RRC connection release procedure with the second network;
at least one of deactivation or release of at least one of a Secondary Cell (SCell) of the first network or a Secondary Cell Group (SCG) of the first network;
a pathloss, associated with a first activated Serving Cell of the second network, changing by over a first threshold since a previous PHR transmission;
activation of at least one of a first SCell of the second network or a SCG of the second network;
a power backoff, associated with a second activated Serving Cell of the second network, changing by over a second threshold since the previous PHR transmission; or
switching of an activated Bandwidth Part (BWP) from a dormant BWP to a non-dormant downlink (DL) BWP of a second SCell of the second network,
wherein the second network is associated with the second USIM.

13. The UE of claim 12, wherein:
the triggering the PHR to the first network is performed when the UE at least one of initiates or completes at least one of:
the RRC connection establishment procedure;
the RRC connection resume procedure; or
the RRC connection release procedure.

14. The UE of claim 12, wherein:
the triggering the PHR to the first network is performed when the UE considers a cell of the second network to be a Primary Cell (PCell).

15. The UE of claim 12, wherein:
the triggering the PHR to the first network is performed when the UE enters RRC connected state in the second network.

16. The UE of claim 12, wherein:
the triggering the PHR to the first network is performed when the UE enters RRC idle state in the second network or RRC inactive state in the second network.

17. The UE of claim 12, the operations comprising:
in response to the triggering the PHR to the first network, transmitting, to the first network, a Medium Access Control (MAC) Control Element (CE) indicative of power information associated with the second network.

18. The UE of claim 12, the operations comprising:
based on a network configuration, determining whether to at least one of:
trigger the PHR; or
transmit, to the first network, power information associated with the second network in response to triggering the PHR.

19. A method of a User Equipment (UE) with a first Universal Subscriber Identity Module (USIM) and a second USIM, the method comprising:
entering Radio Resource Control (RRC) connected state in a first network associated with the first USIM;
identifying one or more events comprising at least one of:
performance of a RRC connection establishment procedure with a second network;
performance of a RRC connection resume procedure with the second network;
performance of a RRC connection release procedure with the second network;
at least one of deactivation or release of at least one of a Secondary Cell (SCell) of the first network or a Secondary Cell Group (SCG) of the first network;
a pathloss, associated with a first activated Serving Cell of the second network, changing by over a first threshold since a previous power headroom reporting (PHR) transmission;
activation of at least one of a first SCell of the second network or a SCG of the second network;
a power backoff, associated with a second activated Serving Cell of the second network, changing by over a second threshold since the previous PHR transmission; or
switching of an activated Bandwidth Part (BWP) from a dormant BWP to a non-dormant downlink (DL) BWP of a second SCell of the second network; and
in response to the one or more events, one of:
triggering a PHR to the first network based on at least one of the deactivation or the release being associated with the UE entering RRC connected state in the second network; or
not triggering the PHR to the first network based on at least one of the deactivation or the release not being associated with the UE entering the RRC connected state in the second network,
wherein the second network is associated with the second USIM.

20. The method of claim 19, wherein:
the triggering the PHR to the first network is performed when the UE at least one of initiates or completes at least one of:
the RRC connection establishment procedure;
the RRC connection resume procedure; or
the RRC connection release procedure.
